(19) United States
(12) Patent Application Publication
(10) Pub. No.: US 2025/0358301 A1
(43) Pub. Date: Nov. 20, 2025

(54) SYSTEMS AND METHODS FOR ANOMALY DETECTION

(71) Applicants: Battelle Energy Alliance, LLC, Idaho Falls, ID (US); Virginia Commonwealth University, Richmond, VA (US); UNIVERSITY OF IDAHO, Moscow, ID (US)

(72) Inventors: Craig G. Rieger, Pocatello, ID (US); Dylan W. Reen, Idaho Falls, ID (US); John C. Bell, Idaho Falls, ID (US); Jake P. Gentle, Idaho Falls, ID (US); Brian Johnson, Moscow, ID (US); Yacine Chakhchoukh, Moscow, ID (US); Mataz Alanzi, Moscow, ID (US); Hussain Beleed, Moscow, ID (US); Pierce L. Russell, Idaho Falls, ID (US); Daniel L. Marino Lizarazo, Richmond, VA (US); Chathurika S. Wickramasinghe, Richmond, VA (US); Milos Manic, Richmond, VA (US); Vivek Kumar Singh, Idaho Falls, ID (US)

(73) Assignees: Battelle Energy Alliance, LLC, Idaho Falls, ID (US); Virginia Commonwealth University, Richmond, VA (US); UNIVERSITY OF IDAHO, Moscow, ID (US)

(21) Appl. No.: 18/871,301

(22) PCT Filed: Jun. 9, 2023
(86) PCT No.: PCT/US23/68259

§ 371 Date: Dec. 3, 2024

Related U.S. Application Data
(60) Provisional application No. 63/350,724, filed on Jun. 9, 2022.

(51) Int. Cl. H04L 9/40; G01R 19/25

(52) U.S. Cl. CPC H04L 63/1425; G01R 19/2513

(57) ABSTRACT

Disclosed herein are systems and methods for anomaly detection. A distributed physical state estimation system determines low-level state estimates covering respective sections of a cyber-physical system based on raw, high-performance measurement data. Low-level state estimates may be determined for a plurality of sections (substations) concurrently. An upper-level state estimate may be derived from the low-level state estimates. Anomalies pertaining to the system may be detected through analysis of the low-level and upper-level state estimates. The anomalies may be analyzed to determined whether the system is exhibiting behavior indicative of a fault, cyber-attack, and/or compromise.

### CROSS-REFERENCE TO RELATED APPLICATIONS

This application claims priority to PCT Application No. PCT/US23/68259 filed Jun. 9, 2023, which claims priority to United States Provisional Patent No. Application No. 63/350,724, filed Jun. 9, 2022, each of which is hereby incorporated by reference.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### BACKGROUND

Unless otherwise indicated herein, the approaches described in this section are not prior art to the claims in this disclosure and are not admitted to be prior art by inclusion in this section.

A control system may be configured to monitor and/or control a number of complex, inter-related, and potentially dangerous processes. Unauthorized or malicious access to the control system may have serious consequences, including harm to personnel, release of potentially dangerous materials, damage to the system itself, and so on. Many control systems lack security perimeter protections needed to defend against inadvertent access and/or cyberattack. Conventional anomaly detection means that are based primarily on cyber behavior can be exploited by attackers (e.g., by conforming cyber-attacks to known or learned patterns). Although it may be possible to model the state of the control system for anomaly detection, the development of such models can require extensive engineering efforts, are not scalable, and are not suitable for integration with other cyber-based anomaly detection means.

For example, state estimation systems are often used to monitor and/or control electrical power systems. These systems use measurement data acquired from the power system to estimate the current operating point or “state” of the system, e.g., power flows, generation, load, voltages, and so on. The resulting state estimates may be used in numerous high-level functions, such as system monitoring, economic system operation, control of generation, load control, and so on. The measurement data may be acquired by use of a supervisory control and data acquisition (SCADA) system, e.g., may be captured by use of SCADA devices installed within the power system.

State estimation often requires evaluation of complex, computationally intensive load flow equations. As such, state estimation systems are often only capable of providing periodic “snap shots” of the power system state. For example, static state estimation (SSE) systems may generate state estimates periodically and/or at designated times (t); the state estimate for each time (ti) may be based on voltage and power measurements acquired at each time (ti). Although these types of state estimates may be sufficient for many high-level control functions, they may be unsuitable for detection of anomalies resulting from cyber-physical attack. What is needed, therefore, are systems and methods for state-estimation based anomaly detection or, more specifically, anomaly detection systems configured to detect anomalies based, at least in part, on real-time, dynamic state estimates.

### BRIEF DESCRIPTION OF THE DRAWINGS

Examples of systems, methods, devices, and computer-readable storage media comprising instructions configured to implement aspects of state-estimation based anomaly detection are set forth in the accompanying figures and detailed description:

FIG. 1A is a schematic block diagram illustrating an example operating environment in which aspects of state-estimation based anomaly detection may be implemented.

FIG. 1B is a schematic block diagram illustrating aspects of the distributed, multi-tier physical state monitoring system disclosed herein.

FIG. 1C is a schematic block diagram illustrating an example of a system for training an artificial intelligence/machine-learned model for anomaly detection.

FIG. 1D is a schematic block diagram illustrating an example of an anomaly detection system comprising a trained artificial intelligence/machine-learned model.

FIG. 2A is a schematic block diagram illustrating an example of a distributed, multi-level physical state monitoring system.

FIG. 2B is a schematic block diagram illustrating an example of a power system comprising a plurality of interconnected sections (e.g., substations).

FIG. 2C is a schematic block diagram illustrating another example of a distributed, multi-level physical state monitoring system.

FIG. 3A is a schematic block diagram illustrating an example of a substation level state estimator.

FIG. 3B is a schematic block diagram illustrating an example of a network topology.

FIG. 3C is a schematic block diagram illustrating an example of a high-performance network topology.

FIG. 3D is a flow diagram illustrating an example of a method for monitoring a section of a cyber-physical system.

FIG. 3E is a flow diagram illustrating another example of a method for monitoring a section of a cyber-physical system.

FIG. 4A is a schematic block diagram illustrating another example of a multi-tier anomaly monitoring and detection system.

FIG. 4B is a flow diagram illustrating an example of a method for determining an upper-level state estimate for a cyber-physical system in a distributed, multi-tier architecture.

FIG. 4C is a flow diagram illustrating another example of method for determining an upper-level state estimate for a cyber-physical system in a distributed, multi-tier architecture.

FIG. 5A is a schematic block diagram illustrating an example of an anomaly detection module.

FIG. 5B is a schematic block diagram illustrating an example of a rule-based anomaly detection module.

FIG. 5C is a schematic block diagram illustrating another example of an anomaly detection module.

FIG. 6A is a schematic block diagram illustrating an example of physical state monitoring system configured to distribute implementation of aspects of an anomaly detection function across sections of a cyber-physical system.

FIG. 6B is a flow diagram illustrating another example of a method for monitoring a section of a cyber-physical system, as disclosed herein.

FIG. 7A is a functional block diagram illustrating another example of a distributed, multi-level physical state monitoring system, as disclosed herein.

FIG. 7B illustrates an example of a visualization of physical anomaly data.

FIG. 8 is a flow diagram illustrating an example of a method for implementing a power-system level monitoring function.

FIG. 9 is a schematic block diagram illustrating an example of a monitoring system configured to monitor a cyber and physical state of a cyber-physical system.

FIG. 10 is a schematic block diagram illustrating an example of a physical anomaly detection system.

FIG. 11A is a schematic block diagram illustrating an example of a cyber anomaly detection system.

FIG. 11B is a schematic block diagram illustrating an example of a cyber data acquisition module.

FIG. 12 illustrates an example of a visualization of cyber physical anomaly data.

### DETAILED DESCRIPTION

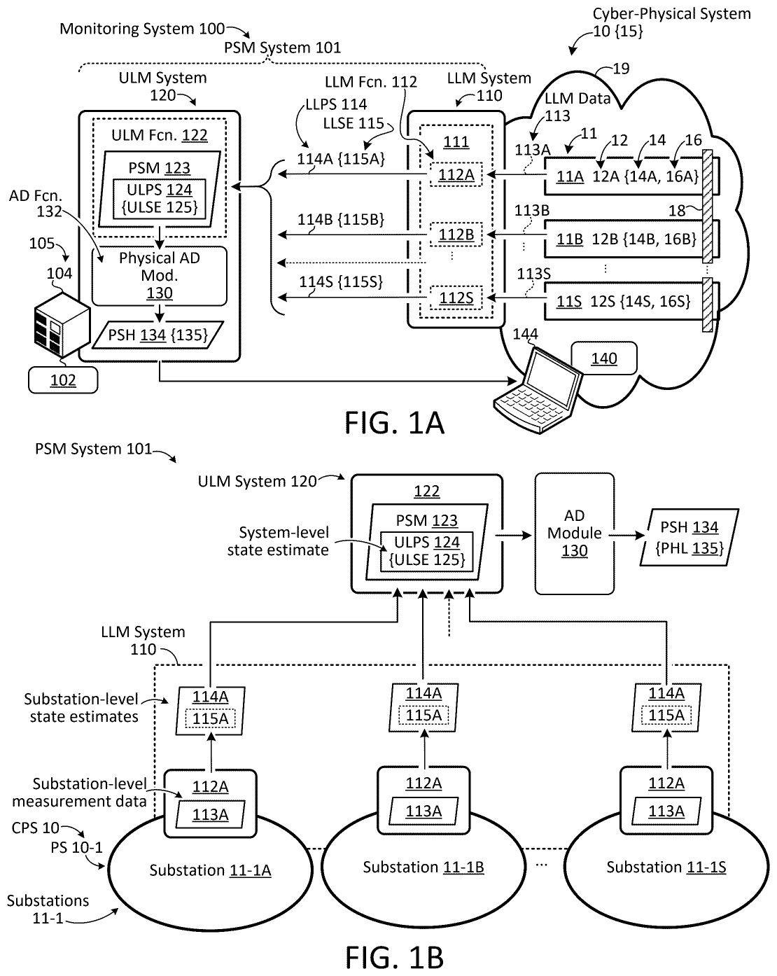

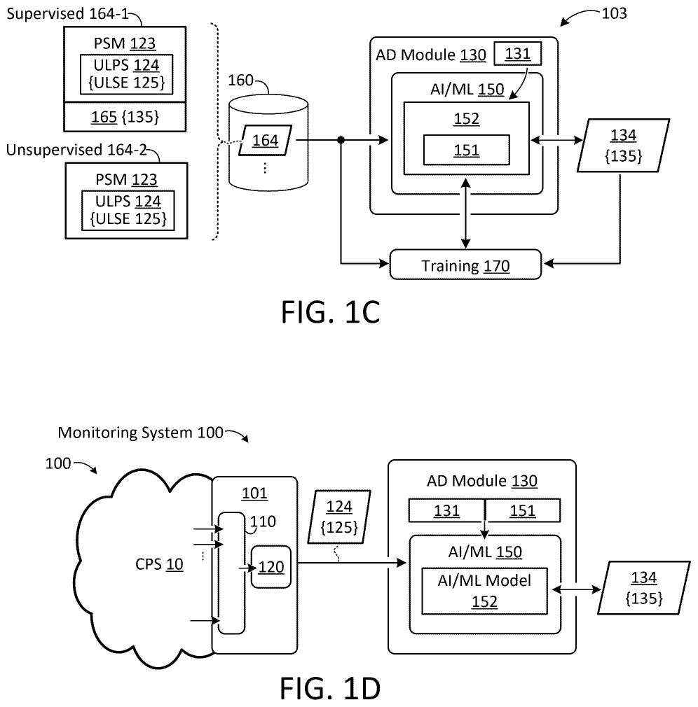

FIG. 1A is a schematic block diagram illustrating an example operating environment comprising in which aspects of cyber-physical anomaly detection may be implemented. Aspects of the disclosed technology may be configured to monitor operation of a cyber-physical system 10. As used herein, a cyber-physical system (CPS) 10 may comprise and/or refer to a collection of interconnected physical and computing resources configured to accomplish a specific task.

As illustrated in FIG. 1A, the CPS 10 may comprise a collection of interconnected components 12 (e.g., CPS components 12). The CPS components 12 may include, but are not limited to physical components, computational components, cyber components, cyber-physical components, cyber components, and so on. As used herein, a physical component may comprise and/or refer to any suitable means for implementing physical and/or computational aspects of the CPS 10. By way of non-limiting example, physical components may include, but are not limited to switches, relays, actuators, sensors, measurement devices, pumps, valves, motors, terminals, and/or the like. A computational component may comprise and/or refer to any suitable means for implementing command, control, monitoring, visualization, and/or other computational functionality of the CPS 10. By way of non-limiting example, the computational components of a CPS 10 may include controllers, control modules, intelligent electronic devices (IED), relays, protective relays, terminals, human machine interface (HMI) components, and/or the like. As used herein, a cyber component 14 may comprise and/or refer to any suitable means for communicatively and/or operatively coupling components 12 of the CPS 10. Cyber components 14 may, for example, comprise and/or implement aspects of an electronic communication network, such the network 19, as disclosed in further detail herein. By way of non-limiting example, cyber components may include, but are not limited to: network hardware, network software, network concentrators, network switches, network hubs, network interconnects, network interfaces, network infrastructure, network security components, network communication media (e.g., network cable), and/or the like. As used herein, a cyber-physical component may comprise and/or refer to a component configured to implement cyber functionality of the CPS 10 in combination with physical and/or computational functionality. By way of non-limiting example, a cyber-physical component may comprise a control module or protective relay having an integrated network interface or the like. A cyber-physical component may, therefore, be referred to as a cyber component herein. The cyber and components of the CPS 10 may implement aspects of an electronic communication network 19 of the CPS 10. The network 19 may be configured to communicatively couple components 12 of the CPS 10, couple the CPS 10 to other communication networks, and/or the like.

As illustrated in FIG. 1A, the CPS 10 may be organized, divided, and/or comprise a plurality of sections 11 (or CPS sections 11), each comprising a respective set of CPS components 12. As used herein, a section 11 of a CPS 10 may comprise and/or refer to any suitable portion, region, subsection, and/or subset of the CPS 10. In the FIG. 1A example, the components 12 of the CPS 10 may be organized into S sections 11A-11-1S, each section 11 comprising a respective collection or subset of the components 12 of the CPS 10. In some implementations, CPS 10 may be divided into sections 11 corresponding to respective aspects of the task(s) implemented by the CPS 10. By way of non-limiting example, the CPS 10 may be configured to implement tasks pertaining to the generation and/or distribution of electrical power resources and the sections 11 of the CPS 10 may comprise respective substations.

As illustrated in the FIG. 1A example, sections 11 of the CPS 10 may be interconnected; components 12 of section 11A may be coupled to components 12 of one or more other sections 11 (e.g., one or more of sections 11B-S), section 11B may be coupled one or more other sections 11, section 11S may be coupled to one or more other sections 11, and so on. Alternatively, or in addition, components 12 of the sections 11A-11-1S may be coupled to one or more external systems, such as an external power system, a power system load, or the like (not shown in FIG. 1A to avoid obscuring details of the illustrated examples). Connections between CPS sections 11 and/or external systems may be implemented by use of interconnections 18 and/or interconnection components 18 of the CPS 10, as disclosed in further detail herein.

The components 12 of the CPS 10 may further comprise monitoring and/or control components 16. As used herein, a monitoring and/or control (MC) component 16 may refer to any suitable means for implementing monitoring, command, and/or control functionality of the CPS 10. An MC component 16 may comprise one or more cyber-physical component(s) 12 of the CPS 10, as disclosed herein. An MC component 16 may include, but is not limited to: a measurement device, an acquisition device, a sensor, a meter, a measurement device, a measurement transformer, a voltage transformer (VT), a potential transformer, a current transformer (CT), a transducer, a meter, a metering device, a volt meter, a current meter, a power meter, a wattmeter, a three-phase wattmeter, a merging unit, a data communication device, a data concentration and storage device, a SCADA system, a SCADA device, an IED, a protection IED, a phasor measurement device, a synchrophasor measurement device, a phasor measurement unit (PMU) device, a phase data concentrator (PDC), a field device, a HMI device (e.g., a terminal, a remote terminal unit (RTU), or the like), a network device (e.g., a cyber device and/or cyber-physical device), and/or the like.

In some implementations, the MC components 16 may be configured to monitor and/or control respective sections 11 of the CPS 10. The MC components 16 of the CPS 10 may be organized and/or divided into S sets of MC components 16 (e.g., 16A-16S); MC components 16A may be configured to monitor and/or control section 11A, MC components 16B may be configured to monitor and/or control section 11B, MC components 16S may be configured to monitor and/or control section 11S, and so on.

In some implementations, one or more of the MC components 16 of the CPS 10 may be configured to implement and/or embody aspects of an electronic communication network, such as the network 19 disclosed herein. An MC component 16 configured to implement aspects of the network 19 may include, but is not limited to: a network device, a network infrastructure device, a switch, a switch port analyzer, a router, a hub, a concentrator, a firewall, a proxy device, a cyber-security device, a PDC, an IED, an aggregation services router (ASR), a line outstation, and/or the like.

The CPS 10 may comprise and/or be coupled to a monitoring system 100. The monitoring system 100 may be configured to monitor the CPS 10, detect anomalies pertaining to the CPS 10 (and/or respective CPS sections 11 and/or components 12), and so on. The monitoring system 100 may implement such monitoring by use of, inter alia, MC components 16 of the CPS 10.

In some implementations, the monitoring system 100 may comprise and/or be coupled to a physical state monitoring (PSM) system 101. As disclosed in further detail herein, the PSM system 101 may be configured to monitor aspects of the physical state, operating point, and/or other characteristics pertaining to the physical state of the CPS 10. The PSM system 101 may comprise a distributed, hierarchical, and/or multi-tiered anomaly detection system. In the FIG. 1A example, the PSM system 100 may comprise a first, low, or lower-level monitoring (LLM) system 110 and a second, top, or upper-level monitoring (ULM) system 120. As disclosed in further detail herein, the LLM system 110 may be configured to implement one or more lower-level monitoring (LLM) functions 112, each covering a respective portion of the CPS 10, and an upper-level monitoring function 122 configured to cover the CPS 10. In the example illustrated in FIG. 1A, the LLM system 110 may be configured implement S LLM functions 112, each pertaining to a respective one of the S sections 11 of the CPS 10, e.g., implement LLM functions 112A-112S covering CPS sections 11A-11-1S, respectively. The ULM system 120 may leverage outputs of the LLM functions 112 to, inter alia, implement an upper-level monitoring function 122. The upper-level monitoring function 122 may be configured to cover the CPS 10, e.g., cover CPS sections 11A-11-1S in the FIG. 1A example), interconnection components 18, and so on. In some implementations, the LLM functions 112 may comprise determining physical state estimates for respective sections 11 of the CPS 10 and the upper-level monitoring function 122 may comprise determining a physical state estimate for the CPS 10 based, at least in part, on the state estimates determined for the respective sections 11 of the CPS 10 by the LLM system 110.

Aspects of the PSM system 100 may comprise, be embodied by, and/or be implemented by computing resources 102. As disclosed in further detail herein, the computing resources 102 may comprise any suitable computing means including, but not limited to: processing means, memory means, non-transitory computer-readable storage means, HMI means, data interface means, and so on. The computing resources 102 may be implemented and/or embodied by one or more devices, such as the computing device 104 illustrated in FIG. 1A. The computing device 104 may comprise any suitable means for implementing computing resources 102 including, but not limited to: an electronic device, a computer, a portable computing device, a tablet computer, a smart phone, a personal digital assistant, a terminal, and/or the like. In some implementations, the electronic device 104 may comprise and/or correspond to one or more component(s) 102 of the CPS 10, e.g., an MC component 16, such as an IED, a relay, a protective relay, an RTU, and/or the like.

Implementing an LLM function 112 on a section 11 of the CPS 10 may comprise acquiring lower-level monitoring (LLM) data 113 pertaining to the CPS section 11. In the FIG. 1A example, implementing the LLM functions 112A-112S comprises acquiring LLM data 113A-113S pertaining to CPS sections 11A-11-1S, respectively. As disclosed in further detail herein, the LLM data 113 may comprise high-performance measurements of physical quantities indicative of the physical state of the CPS section 11, such as voltage measurements, current measurement, pressure measurements, flow measurements, and/or the like.

The LLM function 112 may further comprise generating lower-level physical state (LLPS) data 114 for the CPS section 11 based, at least in part, on the LLM data 113 acquired from the CPS section 11. The LLPS data 114 determined for a CPS section 11 may comprise any suitable information pertaining to physical characteristics of the CPS section 11 (and/or components 12 thereof), which may include, but is not limited to, data pertaining to the operating point, configuration, status, topology, physical state and/or other physical characteristics of the section 10 (and/or respective CPS components 12 thereof). In some implementations, the LLPS data 114 may comprise a state estimate determined for the CPS section 11. The LLM system 110 may be configured to determine a plurality of lower-level state estimates (LLSE) 115, each corresponding to a respective section 11. The LLSE 115 determined for a CPS section 11 may comprise an estimate of a topology of the section 11, as disclosed in further detail herein. The ULSE 125 may comprise an estimate of a topology of the CPS 10 (e.g., may comprise an estimate of a physical configuration of respective sections 11 of the CPS 10, respective components 12 of the CPS sections 11, interconnections 18, and so on). In the FIG. 1A example, the LLPS data 114 determined by the LLM system 110 may comprise LLSE 115A-115S configured to characterize the current operating point and/or state of CPS sections 11A-11-1S, respectively.

The ULM system 120 may be configured to leverage the LLPS data 114 generated for respective sections 11 of the CPS 10 to, inter alia, implement an upper-level monitoring (ULM) function 122 configured to cover the CPS 10 (e.g., cover CPS sections 11A-11-1S). As disclosed in further detail herein, the ULM function 122 may comprise acquiring and/or determining physical state monitoring (PSM) data 123 pertaining to the CPS 10. The PSM data 123 may comprise and/or be derived from the LLPS data 114 generated by the LLM system 110. The PSM data 123 may comprise and/or be derived from physical state data covering respective sections 11 of the CPS 10. In the FIG. 1A example, the PSM data 123 may comprise and/or be derived from LLPS data 114A-114S produced by LLM functions 112A-112S.

The ULM function 122 may further comprise determining ULPS data 124. The ULPS data 124 may comprise any suitable information pertaining to physical characteristics of the CPS 10 (and/or sections 10 thereof), which may include, but is not limited to, data pertaining to the operating point, configuration, status, topology, physical state and/or other physical characteristics of the CPS 10. In some implementations, the ULPS data 124 may comprise a state estimate determined for the CPS 10. The state estimate determined for the CPS 10 may be referred to as a system- or upper-level physical state estimate (ULSE) 125. As disclosed in further detail herein, the ULSE 125 may comprise an estimate of the physical state of the CPS 10. The ULSE 125 may comprise an estimate of a topology of the CPS 10 (e.g., may comprise an estimate of a physical configuration of respective sections 11 of the CPS 10, respective components 12 of the CPS sections 11, interconnections 18, and so on).

FIG. 1B is a functional block diagram illustrating aspects of the distributed, multi-tier PSM system 101 disclosed herein. In the FIG. 1B example, the CPS 10 may comprise a power system 10-1. The disclosure is not limited in this regard, however, and could be adapted to monitor any suitable CPS 10 having any suitable configuration and comprising any suitable cyber-physical components. The power system (PS) 10-1 may comprise any suitable means for generating, transmitting, distributing, delivering, consuming, and/or otherwise managing power resources. The PS 10-1 may comprise a plurality of interconnection sections 11 or substations 11-1.

As disclosed above, the PSM system 101 may comprise a first, lower-level tier (LLM system 110) and a second, upper-level tier (ULM system 120). The first tier of the PSM system 101 (the LLM system 110) may be configured to acquire raw, substation-level measurement data from respective substations 11-1A-11-1S and determine substation-level state estimates, e.g., LLSE 115A-115S. As disclosed in further detail herein, the LLSE 115 may comprise high performance measurement data, such as phasor measurements. The LLSE 115 may further comprise high-resolution topology models of respective substations 11-1 (e.g., node-breaker topology models as opposed to less detailed bus-branch models). Generating the LLSE 115 may comprise detecting and/or correcting error in the raw measurement data (and/or topology).

The second tier of the PSM system 101 may be configured to leverage the concentrated LLPS data 114 generated at the first tier LLM system 110 to determine an upper-level state estimate (ULSE 125) configured to cover the PS 10-1 (e.g., span the interconnected substations 11-1A through 11-1S).

Distribution of the first-tier analysis across multiple LLM functions 112A through 112S allows for recognition of failures and other anomaly conditions without knowledge of the entire network (and/or the need for complex centralized analysis). The LLM functions 112A-112S may, for example, be implemented on multiple distributed compute nodes. The concentrated data generated by the LLM functions 112 may reduce overhead on network infrastructure of the CPS 10, e.g., network 19. Moreover, since the second-tier analysis leverages results determined at the first tier, the overhead and computational complexity of the ULM function 122 is significantly reduced.

Referring back to FIG. 1A, the PSM system 120 may further comprise a physical anomaly detection (AD) module 130. The physical AD module may be configured to assess the physical behavior and/or state of the CPS 10. The physical AD module may be configured, for example, to determine a likelihood that the physical state of the CPS 10 (e.g., the ULSE 125) corresponds to anomalous behavior due to, inter alia, a failure or attack condition. The physical AD module may be configured to implement aspects of an anomaly detection (AD) function 132. As disclosed in further detail herein, the AD function 132 may comprise analyzing information pertaining to anomaly conditions identified within the CPS 10 and generate physical state health (PSH) data 134 configured to quantify the physical health of the CPS 10. The PSH data 134 may be configured to identify anomalies identified within the ULSE 125 (and/or LLSE 115 generated for respective sections 11 of the CPS 10).

In some implementations, the PSH data 134 may comprise a physical-state health (PSH) label 135. The PSH label 135 may comprise a semantic label or tag configured to, inter alia, classify the health of the CPS 10. In other words, the PSH label 135 determined for the CPS 10 may comprise a semantic label configured to characterize the health of the operating state and/or behavior of the CPS 10 indicated by the corresponding PSM data 123 (and/or LLPS data 114). The PSH label 135 may be selected from a plurality of semantic labels, each configured to describe a respective class or type of operating behavior. The PSH labels 135 may be configured to represent any suitable behavior class, including, but not limited to: a “nominal” or “normal” PSH label 135 configured to represent normal, non-anomalous behavior of the CPS 10 (and/or respective section(s) 11 thereof), an “anomalous” or “anomaly” PSH label 135 configured to represent abnormal, anomalous behavior of the CPS 10, an “attack” PSH label 135 configured to represent operating states and/or behavior indicative of attack and/or compromise of the CPS (and/or PSH labels 135 indicative of respective types of attacks), a “failure” PSH label 135 configured to represent operation of the CPS 10 under component failure conditions, and so on.

The physical AD module may comprise any suitable means for assigning PSH labels 135 to PSM data 123. In some implementations, the physical AD module comprises and/or is coupled to an AD configuration (CFG) 131. The AD CFG 131 may comprise any suitable information pertaining to the detection of anomalies within the CPS 10. The AD CFG 131 may comprise and/or define a cyber-physical health (CPH) vocabulary. The CPH vocabulary may comprise a plurality of semantic physical state health (PSH) labels 135, each configured to characterize a respective class of physical behavior of the CPS 10, as disclosed herein, e.g., “nominal,” “anomalous,” and so on. The AD CFG 131 may further comprise means for assigning PSH labels 135 of the CPH vocabulary, such as computer-readable instructions, heuristics, rules, functions, machine-learned information, a machine-learned function, a machine-learned model, and/or the like. In other words, the AD CFG 131 may comprise means for distinguishing nominal, non-anomalous behavior of the CPS 10 from anomalous behavior. The distinguishing means may comprise means for mapping, converting, deriving, correlating assigning, and/or otherwise translating USL data 124 determined for the CPS 10 to PSH labels 135 of the CPH vocabulary.

In a first non-limiting example, the PA module 130 may comprise logic configured to implement a function f_{P}, as follows:

$${f}_{P} ( SBM ) = {PSH}_{P} \qquad Eq . 1$$

In Eq. 1, f_{P} represents the function implemented by logic of the physical AD module (e.g., as defined by the AD CFG 131), ULS represents the PSM data 123 determined for the CPS 10 (e.g., the ULSE 125), and CPS_H_{P} represents the PSH label 135 assigned to the USL data 124. The PSM data 123 may comprise a plurality of components or parameters, each corresponding to a respective aspect of the ULSE 125 determined for the CPS 10. For example, the PSM data 123 may comprise a plurality of physical quantities, each corresponding to a respective aspect and/or component 12 of the CPS 10, e.g., voltage measurements, current measurements, power measurements, pressure measurements, flow measurements, and/or the like. The PSH_{P} value may indicate the PSH label 135 assigned to the USL data 124. Alternatively, or in addition, the PSH_{P} value may quantify a degree to which the USL data 124 confirms to the “nominal” PS health label 135, e.g., may comprise a value between 0 and 1, where 0 corresponds to the “normal” PSH label 135 (and/or 1 corresponds to the “anomaly” PSH label 135).

Alternatively, or in addition, in a second non-limiting example, the physical AD module may comprise logic configured to evaluate the health of the CPS 10 based, at least in part, on baseline state data (USL_{B}) determined for the CPS 10. The USL_{B} may be maintained within non-transitory storage, such as the AD CFG 131 or the like. The USL_{B} may comprise, incorporate, and/or be derived from PSM data 123 that is characteristic of normal, non-anomalous operation of the CPS 10. For example, the USL_{B} may correspond to PSM data 123 derived from LLM data 113 acquired during various “normal” or “non-anomalous” operating conditions of the CPS 10 (e.g., at different times, under different load conditions, under different use cases, and so on). In some implementations, the physical AD module may maintain a plurality of sets or collections of baseline state data (USL_{B}), each corresponding to respective “normal” operating conditions, e.g., may comprise T sets of baseline state data (USL_{B_1}, . . . , USL_{B_T}). Logic of the physical AD module may quantify a degree to which PSM data 123 determined for the CPS 10 is indicative of a “nominal” CPS health label 135 based, at least in part, on a degree to which the PSM data 123 conforms to the baseline state data (USL_{B}). The physical AD module may be configured to quantify an error or distance between USL data 124 and baseline state data (USL_{B}) by any suitable technique, such as a difference, mean absolute error (MAE), deviation, root-mean-square deviation (RMSD), root mean square error (RMSE), and/or the like. For example, the physical AD module may assign a “nominal” CPS health label 135 to USL data 124 that is within a threshold error or distance from the baseline state data (USL_{B}) and/or a particular set of baseline state data (USL_{B_t}). Alternatively, or in addition, the PSH data 134 may indicate a degree to which the USL data 124 corresponds to the “nominal” baseline state data (USL_{B}), e.g., may comprise a value between 0 and 1, where 0 corresponds to the “nominal” PS health label 135, as disclosed herein.

Alternatively, or in addition, in a third non-limiting example, the physical AD module may be configured to detect anomalous behavior through analysis of physical constraints 15 of the CPS 10, e.g., physical constraint analysis (PCA). As disclosed in further detail herein, PSC analysis may comprise analyzing the ULSE 125 determined for the CPS 10 (and/or respective LLSE 114) in view of physical constraints 15 of the CPS 10 (and/or the physical processes controlled by the CPS 10). The ULSE 125 determined for the CPS 10 may comprise measurements and/or estimates determined for physical quantities at or within respective sections 11 of the CPS 10. The physical quantities may be subject to physical constraints 15. For example, two buses of an electrical power system may be separated by a component 12, such as a circuit breaker. If the status of the circuit breaker is closed, the buses should be at a same voltage level. The physical AD module may identify a potential anomaly in response to determining that the ULSE 125 (and/or corresponding LLSE 114) determined for the CPS 10 indicates that the status of the circuit breaker is “closed,” but voltage measurements at the nodes differ by more than a threshold. Similarly, the ULSE 125 may comprise pressure measurements at two pipes that are separated by a valve. The PSC analysis may comprise verifying that the pressure measurements correspond to a physical relationship defined within the AD CFG 131 (e.g., a pressure ratio per the status of the valve, or the like).

Although particular examples of techniques for deriving PSH data 134 from PSM data 123 are described herein, the disclosure is not limited in this regard. The physical AD module may be configured to determine PSH data 134 and/or assign PS health labels 135 to PSM data 123 using any suitable technique. Alternatively, or in addition to the non-limiting examples described above, the physical AD module may be configured to detect anomalous behavior of the CPS 10 by use of artificial intelligence and/or machine-learning, as illustrated in FIGS. 1C and 1D.

FIG. 1C is a schematic block diagram illustrating an example of a system 103 configured to train an artificial intelligence, machine-learning and/or machine-learned (AI/ML) module 150 for anomaly detection. In the FIG. 1C example, the physical AD module may comprise and/or be coupled to an AI/ML module 150. The AI/ML module 150 may be configured to detect anomalies pertaining to operation of the CPS 10 based, at least in part, on the ULM data 124 (and/or LLM data 114) generated by the PSM system 101. The AI/ML module 150 may be configured to implement any suitable AI/ML means, including, but not limited to a supervised learning AI/ML architecture, an unsupervised AI/ML architecture, a reinforcement AI/ML architecture, a deep learning AI/ML architecture, an artificial neural network (ANN), a convolutional neural network (CNN), a recurrent or recursive neural network (RNN), an AI/ML sorting architecture, an AI/ML clustering architecture, a generative model, and/or the like. The AI/ML module 150 may be trained to identify PSM data 123 that are indicative of benign, nominal operation of the CPS 10 PSM data 123 that are indicative of faults, cyber-attack, and/or compromise. The AI/ML module 150 may learn such distinctions through AI/ML techniques, such as supervised learning, unsupervised learning, reinforcement learning, and/or the like, as disclosed in further detail herein.

In some implementations, the AI/ML module 150 may comprise and/or be coupled to an AI/ML model 152. The AI/ML model 152 may be trained to distinguish anomalous physical behavior (and/or physical states) of the CPS 10 from nominal, non-anomalous behavior. The AI/ML module 150 may be configured to determine and/or predict PSH labels 135 for PSM data 123 determined for the CPS 10. In other words, the AI/ML module 150 may be configured to assign PS health labels 135 to ULPS data 124 determined for the CPS 10 (e.g., translate ULPS data 124 to the CPH vocabulary, as disclosed herein).

In some implementations, the AI/ML module 150 may be configured and/or trained to extract AI/ML features from the PSM data 123 generated by the distributed, multi-tier PSM system 101 disclosed herein. The AI/ML features may comprise aspects of the PSM data 123 determined to distinguish nominal physical states of the CPS 10 from anomalous physical states. In some implementations, suitable AI/ML features may be identified during training of the AI/ML module 150. The AI/ML module 150 may be configured to implement aspects of a supervised and/or unsupervised learning. The AI/ML module 150 may be configured to identify distinguishing characteristics of the PSM data 123, e.g., aspects of the PSM data 123 that distinguish anomalous physical states of the CPS 10 from other, nominal physical states. The AI/ML features may comprise aspects of the ULSE 125 determined for the CPS 10. For example, the ULSE 125 may comprise topology data, measurement data, and/or the like. The ULSE 125 may be specific to the CPS 10 (and/or PS 10-1) and, as such, it may be difficult or impossible for an attacker to identify and/or spoof relevant features used by the AI/MI module 150 to detect anomalous physical behavior.

In some implementations, the AI/ML features may comprise metadata associated with the ULSE 125. For example, the AI/ML features may comprise residuals of the ULSE 125, as disclosed in further detail herein. The AI/ML features may further comprise anomaly data identified during generation of the ULSE 125, e.g., aspects of upper-level anomaly detection data (ULAD data 425), as disclosed in further detail herein.

The AI/ML features may be extracted from the LLPS data 114 used to derive the ULSE 125. The AI/ML features may comprise aspects of LLSE 115 determined for one or more sections 11 of the CPS 10 (LLSE 115 determined for one or more substations 11-1 of the PS 10-1). The AI/ML features may include metadata pertaining to the LLSE 115, such as lower-level anomaly detection data (LLAD data 325), as disclosed in further detail herein.

In some embodiments, the AI/ML module 150 may comprise and/or be coupled to a training module 170. The training module 170 may be configured to implement an AI/ML training procedure adapted to learn and/or refine an AI/ML configuration (CFG) 151 for the AI/ML model 152. The AI/ML CFG 151 may be adapted to configure the AI/ML model 152 to accurately assign PS health labels 135 to PSM data 123, as disclosed herein. The AI/ML CFG 151 may comprise any suitable information pertaining to the architecture, implementation, configuration, settings, and/or other aspects of the AI/ML model 152 (and/or components thereof). By way of non-limiting example, the AI/ML model 152 may comprise an artificial neural network (ANN) and the AI/ML CFG 151 may configure the ANN to include an input layer comprising nodes configured to receive PSM data 123 determined for the CPS 10 (and/or selected features of the USL data 124), zero or more intermediate layers, an output layer comprising output nodes corresponding to respective PS health labels 135 of the CPH vocabulary, and so on. Aspects of the AI/ML CFG 151 may be learned through AI/ML training procedures, as disclosed in further detail herein. The AI/ML training procedures may, for example, comprise learning hyperparameters and/or other aspects of the AI/ML CFG 151. The AI/ML training procedures may be implemented and/or embodied by the training module 170.

The AI/ML CFG 151 for the AI/ML model 152 may be learned by use of a training dataset 160 comprising a plurality of entries, each comprising respective training data 164. Entries of the training dataset 160 may include “real world” training data 164 comprising PSM data 123 determined for the CPS 10 based on LLM data 113 acquired during operation of the CPS 10, e.g., operation of the CPS 10 at designated times and/or under designated conditions. The disclosure is not limited in this regard, however, and could be adapted to generate and/or utilize any suitable type of training data 164 acquired by any suitable means. For example, the training dataset 160 may include training data 164 comprising simulated data (e.g., training data 164 determined through simulation of the CPS 10), synthetic data, derived data (e.g., training data 164 derived from other real-world training data 164), and/or the like.

The AI/ML CFG 151 learned for the CPS 10 may be maintained in non-transitory storage resources. During operation, the physical AD module may be configured to instantiate the AI/ML module 150 and/or AI/ML model 152 by use of the stored AI/ML CFG 151. Alternatively, or in addition, aspects of the AI/ML CFG 151 learned for the CPS 10 through the AI/ML training procedures disclosed herein may be encoded, embedded, and/or otherwise incorporated into the hardware and/or non-transitory, computer-readable software implementation of the physical AD module, AI/ML module, AI/ML model 152, and/or the like.

In some implementations, the AI/ML model 152 may be trained through supervised training, e.g., may comprise an “unsupervised” AI/ML model 152. The supervised AI/ML training procedure may comprise providing the AI/ML model 152 with “labeled” training data 164-1. As used herein, “labeled” training data 164-1 refers to training data 164 that comprises and/or is associated with respective training labels 165. The training labels 165 may be configured to characterize known or predetermined physical health characteristics and/or behavior associated with the training data 164. More specifically, the training labels 165 may comprise known or predetermined PS health labels 135, as disclosed herein. The supervised AI/ML model 152 may be trained to accurately reproduce the AI/ML training labels 165 in response to labeled training data 164-1.

The AI/ML training module 170 may be configured to implement any suitable supervised AI/ML algorithm, including, but not limited to: regression, linear regression, polynomial regression, exponential regression, logarithmic regression, classification, k-nearest neighbor, decision tree, random forest, support vector machine (SVG), naïve bayes, clustering, k-means, DBSCAN, mean shift, hierarchical clustering, association, apriori association, and/or the like. In some implementations, the AI/ML model 152 may comprise an artificial neural network (ANN), which may be trained through a supervised ANN algorithm, such as gradient descent, the Newton method, conjugate gradient, the quasi-Newton method, the Levenberg-Marquardt algorithm, and/or the like. The supervised training procedure may comprise iteratively modifying and/or refining the AI/ML model 152 (and/or AI/ML CFG 151 thereof). Iterations of the supervised training procedure may comprise providing labeled training data 164-1 to the AI/ML model 152, configuring the AI/ML model 152 to generate health data 134 in response to the labeled training data 164-1, and modifying the AI/ML model 152 (and/or AI/ML CFG 151) based on error between PS health labels 135 determined for the labeled training data 164-1 and the training labels 165 associated with the labeled training data 164-1.

In some situations, it may be difficult to acquire accurate, unbiased labeled training data 164-1. Although large amounts of unlabeled data pertaining to operation of the CPS 10 may be available, manually, or even programmatically, applying training labels 165 (e.g., PS health labels 135) to such data may be time-consuming, expensive, and require highly specialized expertise. For example, interpreting PSM data 123 may require experts familiar with the specific, real-world operation and settings of the CPS 10. Moreover, attempts to label such data may be biased, which may produce inaccuracies in the resulting AI/ML model 152.

In view of the foregoing, in some implementations, the AI/ML model 152 may comprise and/or be configured to be trained through an unsupervised AI/ML algorithm. In these embodiments, the AI/ML module 150 may comprise an “unsupervised” AI/ML model 152 configured for any suitable unsupervised AI/ML training means, including, but not limited to: unsupervised clustering, K-means clustering, hierarchical clustering, probabilistic clustering, a Gaussian Mixture Model (GMM), Principal Component Analysis (PCA), Singular Value Decomposition (SVD), a One-class Support Vector Machine (OCSVM), a Local Outlier Factor (LOF), an autoencoder, and/or the like.

The unsupervised AI/ML model 152 may be trained using unlabeled training data 164-2. As used herein, “unlabeled” training data 164-2 refers to data that does not include (or require) a known or predetermined training label 165 (e.g., does not require “supervision” to assign PSH labels 135 a priori).

In a first non-limiting example, the unsupervised AI/ML model 152 may comprise an OCSVM. The training module 170 may utilize unlabeled training data 164-2 to configure the PCSVM to learn a decision boundary for a single class (hence the “one-class” designation). More specifically, the training module 170 may cause the OCSVM to learn a decision boundary for “nominal” or “non-anomalous” operation of the CPS 10, e.g., learn a decision boundary for the “nominal” PSH label 135. As illustrated in the FIG. 1C example, the unlabeled training data 164-2 may comprise ULSE 125 determined by the PSM system 101. The training module 170 may treat the unlabeled training data 164-2 as being indicative of “nominal” operation of the CPS 10 (e.g., the “normal” PS health label 135). The decision boundary learned during training may, therefore, be capable of distinguishing PSM data 123 corresponding to “nominal” operation of the CPS 10 from other PSM data 123, e.g., PSM data 123 corresponding to anomalous operation of the CPS 10 (or an “anomalous” PSH label 135). More specifically, during operation, the trained OCSVM of the AI/ML model 152 may classify “unseen” behavior that falls outside of the learned decision boundary as “anomalous” (or “non-normal”), which may be indicative of attack or failure.

Alternatively, or in addition, in a second non-limiting example, the AI/ML model 152 may comprise and/or be configured for learning through an LOF algorithm. The LOF algorithm is a clustering-based, unsupervised anomaly detection method that computes the local density deviation of a given data point with respect to its neighbors. The data points correspond to respective sets of PSM data 123 (or ULSE 125) and/or features thereof. For example, the data points may correspond to an N dimensional space, where N is the number of parameters or features extracted from USL data 124 determined for the CPS 10. The LOF cluster points learned by the AI/ML model 152 may correspond to “nominal” operation of the CPS 10 (or the “nominal” PSH label 135), as disclosed herein. The AI/ML model 152 may be trained to identify outliers or anomalies as PSM data 123 based on point density quantities determined per the LOF algorithm. For example, PSM data 123 (e.g., ULSE 125) having a density that is within a threshold of its neighbor data points may be assigned the “nominal” PSH label 135 and/or USL data 124 having a density that is lower than its neighbor data points by more than a threshold may be excluded from the “nominal” PHS label 135 (and/or assigned an “anomalous”” PSH label 135). In other implementations, the LOF implementation of the AI/ML model 152 may be configured to produce CPH values configured to quantify a degree to which PSM data 123 conforms to the “nominal” PSH label 135, where the CPH value is based, at least in part, on a comparison between the density of the data point corresponding to the PSM data 123 and densities of neighboring data points, as disclosed herein.

Alternatively, or in addition, in a third non-limiting example, the AI/ML model 152 may comprise an autoencoder. The autoencoder of the AI/ML model 152 may comprise an ANN architecture configured to learn an encoding for input data (e.g., PSM data 123). The autoencoder may comprise an encoder and a decoder. The encoder may be configured to convert USL data 124 determined for the CPS 10 to an abstract representation and the decoder may be configured to reconstruct the abstract representation (e.g., reconstruct the USL data 124 from the abstract representation). In other words, the autoencoder of the AI/ML model 152 may be configured to a) encode USL data 124 (USL_{ORIG}) into an abstract representation (USL_{ABS}), b) generate a reconstruction (USL_{RECONST}) of the USL data 124 (USL_{ORIG}) from the abstract representation (USL_{ABS}), and c) compare the original USL data 124 (USL_{ORIG}) to the reconstruction (USL_{RECONST}). The AI/ML model 152 may be further configured to predict a PSH label 135 for the USL data 124 based, at least in part, on a difference between the original, input PSM data 123 (USL_{ORIG}) and the reconstruction (USL_{RECONST}).

FIG. 1D illustrates another example of an physical AD module. In the FIG. 1D example, the physical AD module comprises and/or is coupled to an AI/ML module 150 having a trained AI/ML model 152. As disclosed herein, the training may comprise developing an AI/ML CFG 151 adapted to configure the AI/ML model 152 to classify physical behavior of the CPS 10 (and/or PS 10-1) per the PSM data 123 acquired by the distributed, multi-tier PSM system 101. The physical AD module may, therefore, omit the training module 170 illustrated in FIG. 1C. During initialization, the physical AD module may instantiate the AI/ML module 150 and/or AI/ML model 152 by use of an AI/ML CFG 151 maintained within non-transitory storage, as disclosed herein. Alternatively, or in addition, aspects of the AI/ML CFG 151 learned for the CPS 10 through the AI/ML training procedures disclosed herein may be encoded, embedded, and/or otherwise incorporated into the hardware and/or non-transitory, computer-readable software implementation of the physical AD module, AI/ML module, AI/ML model 152, and/or the like.

During operation, the physical AD module may receive PSM data 123 determined for the CPS 10 from the PSM system 101. In some implementations, the PSM system 101 may comprise a multi-level, distributed monitoring system 101 including an LLM system 110 and ULM system 120, as disclosed herein. The LLM system 110 may be configured to acquire LLPS data 114 covering respective sections 11 of the CPS 10 and the ULM system 120 may be configured to generate PSM data 123 for the CPS 10 by use of the LLPS data 114, the PSM data 123 comprising an ULSE 125 configured to characterize the physical state of the CPS 10.

The physical AD module may receive the PSM data 123 and, in response, configure the AI/ML module 150 to generate health data 134 for the CPS 10, the health data 134 comprising one or more PSH label(s) 135. The physical AD module may be configured to instantiate and/or configure the AI/ML module 150 in accordance with the AI/ML CFG 151. Alternatively, or in addition, the AD CFG 151 may be incorporated into aspects of the hardware and/or software implementation of the AI/ML module 150 and/or AI/ML model 152, as disclosed herein. The physical AD module may couple the PSM data 123 to the AI/ML module 150. For example, the physical AD module may provide PSM data 123 to an input layer of an ANN of the AI/ML model 152. In some implementations, the physical AD module and/or AI/ML module 150 may be configured to extract AI/ML features from the PSM data 123. As disclosed herein, the AI/ML features may comprise aspects of the PSM data 123 determined (or learned) to distinguish anomalous physical states of the PS 10-1 from other, nominal physical states. The AI/ML features may comprise aspects of the ULSE 125 determined for the PS 10-1, ULAD data 425 flagged during generation of the ULSE 125, LLPS data 114 used to derive the ULSE 125, e.g., aspects of the LLSE 115 determined for one or more substations 11-1, LLAD data 215 flagged during generation of the LLSE 115, and/or the like.

The physical AD module may be further adapted to configure the AI/ML module 150 to produce health data 134 at an output of the AI/ML model 152. The physical AD module may, for example, configure to AI/ML module 150 to propagate the PSM data 123 and/or AI/ML features thereof through an input layer, zero or more intermediate layers, and an output layer of an ANN of the AI/ML model 152.

Referring back to FIG. 1A, in some implementations, the PSM system 101 may be further configured to provide information pertaining to the physical health of the CPS 10 to other components of the CPS 10 (and/or monitoring system 100), such as a terminal, an RTU, an HMI, and/or the like. In the FIG. 1A, the monitoring system 100 may further comprise and/or be coupled to a mitigation module 140. The mitigation module 140 may be configured to receive PSH data 134 from the PSM system 101 and, in response, implement one or more mitigation actions pertaining to the CPS 10 based, at least in part, on the PSH data 134. For example, the mitigation module 140 may be configured to display information pertaining to the health of the CPS 10 on an HMI of a computing device, such as a terminal 144. Alternatively, or in addition, the mitigation module 140 may be configured to implement mitigation actions configured to, inter alia, mitigate the impact of anomalies detected by the PSM system 101 (and indicated in the PSH data 134). The mitigation actions may include, but are not limited to: recording information pertaining to detected anomalies, alerting personnel of anomalies pertaining to the operation and/or state of the CPS 10, reconfiguring the CPS 10 (e.g., configuring the CPS 10 to operate in a “safe” or “failsafe” mode), and/or the like.

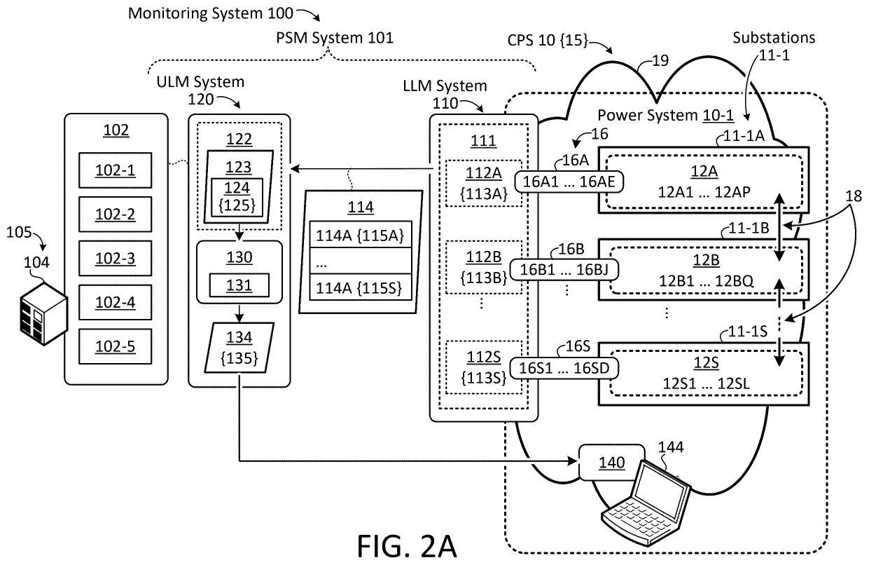

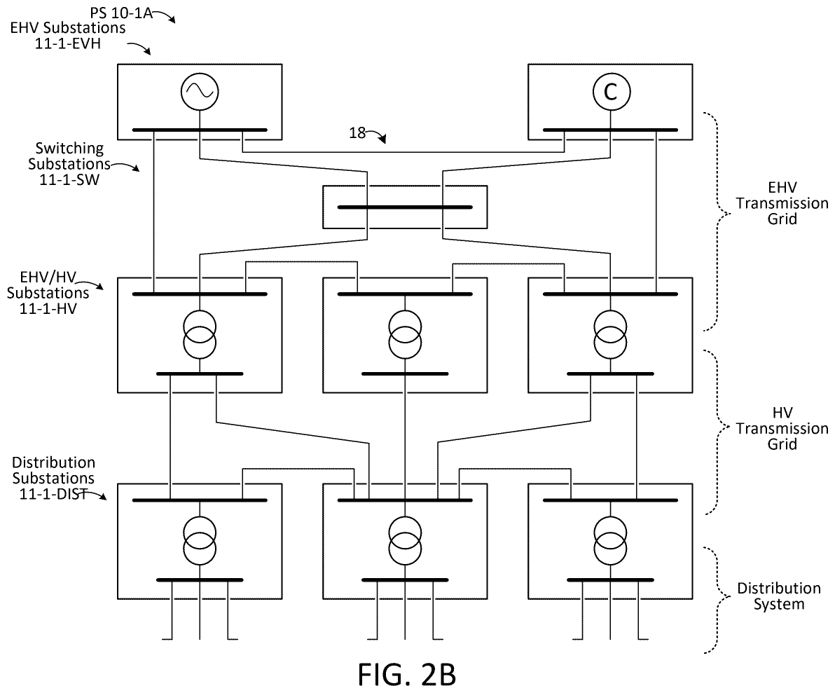

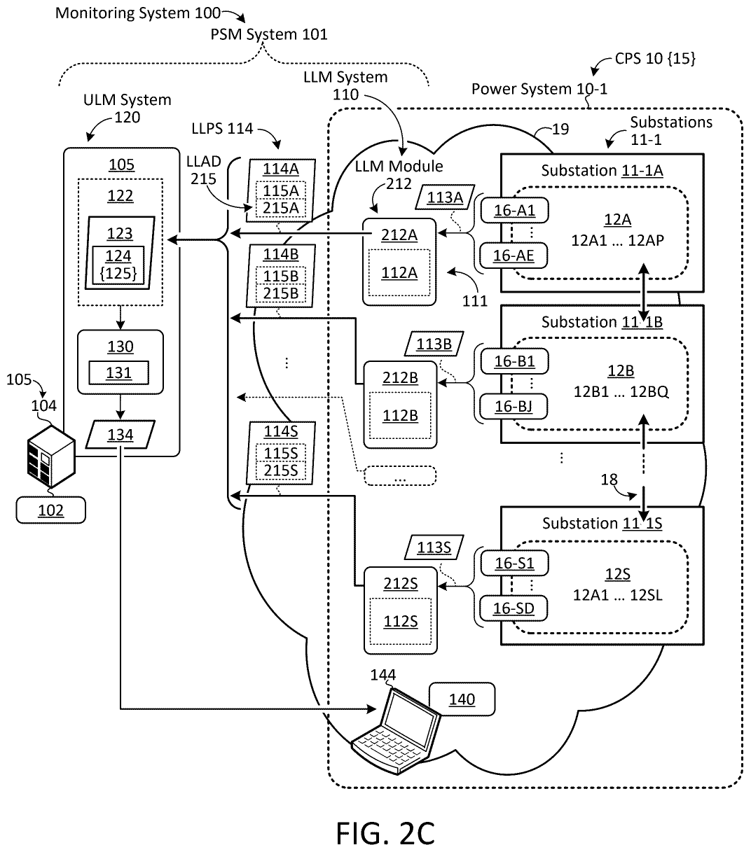

FIG. 2A is a schematic block diagram illustrating another example of a monitoring system 100 configured to implement aspects of cyber-physical anomaly detection, as disclosed herein. The monitoring system 100 comprises a PSM system 101 configured to monitor a CPS 10. In the FIG. 2A example, the CPS 10 comprises a power system (PS) 10-1. The PS 10-1 may comprise any suitable means for generating, transmitting, distributing, delivering, consuming, and/or otherwise managing power resources. The PS 10-1 illustrated in FIG. 2A may include but is not limited to: an electrical power system, a generator, a power distribution system, a power transmission system, a power grid, a power transmission grid, an electrical power grid, a power network, an electrical power network, a power utility, and/or the like.

The PS 10-1 may comprise a plurality of CPS components 12, such as cyber components, physical components, cyber-physical components, and so on, as disclosed herein. The physical components of the PS 10-1 may comprise any suitable means for generating, distributing, controlling, consuming, and/or otherwise managing electrical power resources, which may include but are not limited to a: node, bus, bus-bar, bus coupler, branch, breaker, circuit breaker (CB), disconnector, lightning arrestor, isolator, relay, shunt capacitor, protection relay, protection device, protection IED, Power Grid Protection (PGP) device, switch, grounding switch, interconnect, power source, generator, load, transmission grid, extra high voltage (EHV) transmission grid, high voltage (HV) transmission grid (HV), transformer, power transformer, EHV/HV transformer, HV/MV transformer, distribution system, feeder, radial feeder, computational components, MC components 16, and/or the like. The PS 10-1 may further comprise cyber components 14. As disclosed herein, the cyber components 14 may be configured to implement aspects of an electronic communication network of the CPS 10 (e.g., implement aspects of a network 19 of the CPS 10) and/or couple the PS 10-1 to one or more electronic communication networks, as disclosed herein.

In some implementations, the PS 10-1 may be organized, divided, and/or comprise a plurality of CPS sections 11. The sections 11 may correspond to an architecture of the PS 10-1. The sections 11 may, for example, comprise and/or correspond to respective substations 11-1 of the PS 10-1. Therefore, as used herein, sections 11 of the PS 10-1 may be referred to as substations 11-1 or the like. The substations 11-1 may comprise CPS components 12 configured to implement designated functionality of the PS 10-1. In the FIG. 1A example, the PS 10-1 comprises S substations, each comprising a respective subset of the CPS components 12 of the PS 10-1; the PS 10-1 may comprise substations 11-1A-11-1S, each comprising a respective set of CPS components 12A-12S, substation 11-1A may comprise CPS components 12A1-12AP, substation 11-1B may comprise CPS components 12B1-12BQ, substation 11-1S may comprise CPS components 12S1-12SL, and so on. As illustrated in FIG. 2A, substations 11-1A-11-1S of the PS 10-1 (and/or components 12 thereof) may be operably and/or electrically coupled by one or more interconnections 18.

As disclosed above, the substations 11-1 may be configured to implement a structure or architecture of the PS 10-1. The PS 10-1 may comprise any suitable substations 11-1 configured to implement any suitable functionality such as power transmission, switching, conditioning, transformer, distribution, and so on.

FIG. 2B illustrates an example of a PS 10-1A comprising an EHV transmission grid, sub-transmission or HV transmission grid, and medium voltage (MV) distribution system. The EHV transmission grid of the PS 10-1A may comprise EHV substations 11-1-EVH, which may comprise and/or be coupled to power sources (e.g., generators) and/or the like. The EHV transmission grid may be coupled to EHV/HV substations 11-1-HV of the HV transmission grid through, inter alia, switching substations 11-1-SW, which may be configured to control power flow with the PS 10-1A. The EH/VH substations 11-1-HV may be coupled to distribution substations 11-1-DIST of the distribution system. The distribution substations 11-1-DIST may comprise transformers configured to couple HV transmission lines to loads, such as MV distribution systems, distribution feeder(s), radial distribution feeder(s), and/or the like.

Referring back to FIG. 2A, the PS 10-1 may further include MC components 16. As disclosed herein, an MC component 16 may comprise any suitable means for monitoring and/or controlling physical aspects of the PS 10-1 (e.g., physical processes, physical components, cyber-physical components, or the like); an MC component 16 may include but is not limited to: a measurement device, an acquisition device, a sensor, a meter, a measurement device, a measurement transformer, a VT, a potential transformer, a CT, a transducer, a meter, a metering device, a volt meter, a current meter, a power meter, a wattmeter, a three-phase wattmeter, a merging unit, a data communication device, a data concentration and storage device, a SCADA system, a SCADA device, a computing device, an IED, a protection IED, a phasor measurement device, a synchrophasor measurement device, a PMU device, a PDC, a terminal, an RTU, and/or the like. In the FIG. 2A example, the PS 10-1 comprises S sets of MC components 16A-16S, each configured to monitor a respective substation 11-1A-11S; MC components 16A1-16AE may be configured to acquire LLM data 113A pertaining to substation 11-1A (e.g., CPS components 12A1-12AP), MC components 16B1-16BJ may be configured to acquire LLM data 113B pertaining to substation 11-1B (e.g., CPS components 12B1-12BQ), MC components 16S1-SD may be configured to acquire LLM data 113S pertaining to substation 11-1S (e.g., CPS components 12S1-12SL), and so on.

The LLM system 110 may be configured to implement a distributed monitoring (DM) function 111, the DM function 111 comprising a plurality of LLM functions 112. In the FIG. 2A example, the LLM system 110 is configured to implement S LLM functions 112A-112S configured to monitor substations 11-1A-11-1S, respectively. As disclosed herein, implementing the LLM functions 112A-112S may comprise determining LLPS data 114A-114S for respective substations 11-1A-11-1S of the PS 10-1 by use of LLM data 113A-113S acquired from the respective substations 11-1A-11-1S.

In the FIG. 2A example, the LLM data 113 may comprise high-performance monitoring data. As used herein, high-performance monitoring (HPM) data may comprise and/or refer to real-time, time-synchronized data. HPM data may comprise and/or refer to a phasor measurement unit (PMU) such as a synchrophasor or the like. As used herein, PMU may comprise and/or refer to phasor quantities measured with respect to a time reference, such as Universal Time Constant (UTC) or the like. PMU may be acquired by a PMU device having a signal receiver configured to synchronize an internal clock of the PMU device to a time reference, e.g., a global positioning system (GPS) signal receiver configured to synchronize the PMU clock to the UTC reference. The HPM data may comprise and/or refer to time-stamped PMU quantities for voltage, current, power flow and/or the like. Alternatively, or in addition, HPM data may comprise and/or refer to measurement data having a high temporal resolution or acquisition rate, e.g., about 10 to 120 times per second (or higher). By contrast, lower-performance measurement data, such as measurement data acquired by a SCADA system may have a lower acquisition or sample rate, e.g., about every 1 to 10 seconds, about 10 to 1200 times slower than HPM data. For example, a PMU device may be configured to capture HPM data comprising the voltage on a bus and the current between the bus and an incident bus. The HPM data acquired by the PMU device may comprise 40 samples per period of a 50 Hz signal, which may enable determination of the amplitude and angle of the 50 Hz signal on the bus of the PMU device (and/or the incident bus). HPM data may also refer to measurement data that is transmitted via a high-performance network. As used herein, a high-performance (HP) network may comprise and/or refer to any suitable network and/or network protocol configured to preserve resolution, acquisition rate, timing, time-synchronization, and/or other characteristics of HPM data, including, but not limited to: IEEE 1344, IEEE C37.118, IEEE C37.118.1a-2014, IEEE C37.118-2005, Open Platform Communications (OPC), IEC 61850, a Phasor network, and/or the like. In some implementations, network 19 of the CPS 10 may comprise and/or be coupled to one or more HP networks.

In some implementations, the LLM data 113 may further comprise status data. As used herein, status data may comprise and/or refer to information pertaining to the status of CPS component(s) 12 of a substation 11-1, which may correspond to, inter alia, aspects of the topology of the substation 11-1. The status data acquired by the LLM system 110 may include, but is not limited to: switch position, tap position, relay status, protective relay data (e.g., protective relay status, such as tripped, nominal, or the like), CB status (e.g., open or closed), and/or the like.

The LLM system 110 may be further configured to generate LLPS data 114A-114S for the substations 11-1A-11-1S based, at least on part, on HPM data acquired therefrom. As disclosed herein, the LLPS data 114 may comprise LLSE 115 for respective substations 11. The LLSE 115 may comprise HP state estimates. As used herein, a HP state estimate (or HP physical state estimate) may comprise and/or refer to a state estimate that comprises, incorporates, and/or is derived from HPM data. LLM system 110 may be configured to generate a plurality of HP state estimates, each configured to model the physical state of a respective substation 11-1. In the FIG. 2A example, the LLM system 110 is configured to generate LLPS data 114 comprising LLSE 115A-115S, the LLSE 115A-115S comprising HP state estimates for substations 11-1A-11-1S, respectively.

The ULM system 120 may be configured to utilize the HP state estimates determined for substations 11-1A-11-1S to, inter alia, implement an ULM function 122, as disclosed herein. The ULM function 122 may be configured to cover the PS 10-1, e.g., cover substations 11-1A-11-1S, interconnections 18 between substations 11-1A-11-1S, and so on. The ULM function 122 may comprise generating PSM data 123 for the CPS 10. The PSM data 123 may comprise ULPS data 124, which may be configured to characterize any suitable aspect of the physical state and/or behavior of the PS 10-1. The ULPS data 124 may comprise and/or be derived from the LLPS data 114 generated by the LLM system 110. The ULM function 122 may comprise aggregating the LLPS data 114. In the FIG. 2A example, the ULM function 122 may comprise aggregating LLPS 114A-114S (and LLSE 115A-115S). The ULM function 122 may further comprise determining a physical state estimate for the PS 10-1 (e.g., a ULSE 125). The ULSE 125 may be derived from, inter alia, the LLSE 115 determined for respective substations 11 of the PS 10-1. For example, the ULSE 125 may be derived from the HP state estimates of LLSE 115A-115S determined for substations 11-1A-11-1S.

The PSM system 101 may further comprise an physical AD module, which may be configured to analyze the physical state of the PS 10-1 (as indicated by the PSM data 123) and, in response, generate PSH data 134, which may comprise a PSH label 135 configured to characterize the physical operating state, operating point, and/or behavior of the PS 10-1 in accordance with an AD CFG 131, as disclosed herein. The physical AD module may be configured to derive PSH data 134 from the PSM data 123. The physical AD module may be configured to translate PSM data 123 to PSH data 134 (and/or PSH labels 135) by any suitable technique or method, as disclosed herein. In some implementations, the physical AD module may comprise and/or be coupled to an AI/ML module 150 configured to predict PSH data 134 and/or PSH labels 135 for the PS 10-1 based on PSM data 123 determined for the PS 10-1, as illustrated in FIGS. 1B and 1C (AI/ML module 150 not shown in FIG. 2A to avoid obscuring details of the illustrated examples).

In some implementations, the monitoring system 100 may be further configured to provide information pertaining to the physical health of the PS 10-1 to other components of the CPS 10. For example, the monitoring system 100 may be configured to provide health data 134 to a mitigation module 140, as disclosed herein.

Aspects of the monitoring system 100 may comprise, be implemented and/or be embodied by computing resources 102. The computing resources 102 may comprise any suitable computing means, including, but not limited to: processing resources 102-1, memory resources 102-2, non-transitory (NT) storage resources 102-3, human-machine interface (HMI) resources 102-4, data interface resources 102-5, and so on.

The processing resources 102-1 may comprise any suitable processing means including, but not limited to: processing circuitry, logic circuitry, an integrated circuit (IC), a processor, a processing unit, a physical processor, a virtual processor (e.g., a virtual machine), an arithmetic-logic unit (ALU), a central processing unit (CPU), a general-purpose processor, a programmable logic device (PLD), a field programmable gate array (FPGA), an application-specific integrated circuit (ASIC), a System on Chip (SoC), virtual processing resources, and/or the like.

The memory resources 102-2 may comprise any suitable memory means including, but not limited to: volatile memory, non-volatile memory, random access memory (RAM), dynamic RAM (DRAM), synchronous DRAM (SDRAM), cache memory, or the like. The NT storage resources 102-3 may comprise any suitable non-transitory, persistent, and/or non-volatile storage means including, but not limited to: a non-transitory storage device, a persistent storage device, an internal storage device, an external storage device, a remote storage device, Network Attached Storage (NAS) resources, a magnetic disk drive, a hard disk drive (HDD), a solid-state storage device (SSD), a Flash memory device, and/or the like.

The HMI resources 102-4 may comprise any suitable means for human-machine interaction including, but not limited to: input devices, output devices, input/output (I/O) devices, visual output devices, display devices, monitors, touch screens, a keyboard, gesture input devices, a mouse, a haptic feedback device, an audio output device, a neural interface device, and/or the like.

The data interface resources 102-5 may comprise any suitable data communication and/or interface means including, but not limited to: a communication interface, a I/O interface, a device interface, a network interface, an electronic communication network interface, an interconnect, and/or the like. The data interface 102-5 may be configured to communicatively and/or operatively couple the physical AD module to the PS 10-1 and/or components 12 thereof, such as MC components 16 (e.g., IED), and/or the like. The data interface resources 102-5 may be configured for electronic communication one or more networks, e.g., network 19. The network 19 may comprise any suitable electronic communication means, including, but not limited to one or more of an Internet Protocol (IP) network, a wireless network, a Local Area Network (LAN), a Wide Area Network (WAN), a Virtual Private Network (VPN), a wireless network (e.g., IEEE 802.11a-n wireless network, Bluetooth®network, Near-Field Communication (NFC) network, and/or the like), a public switched telephone network (PSTN), a mobile network (e.g., a network configured to implement one or more technical standards or communication methods for mobile data communication, such as Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), High Speed Uplink Packet Access (HSUPA), Long Term Evolution (LTE), LTE-A (Long Term Evolution-Advanced), and/or the like), an embedded network, a control network, a process control network, a sensor network, an actuator network, a SCADA network, a Distributed Network Protocol (DNP3) network, an International Electrotechnical Commission 60870 (IEC 60870) network, an Experimental Physics and Industrial Control System (EPICS), a combination of networks, a Phasor network (e.g., an IEEE C37.118 network), a plurality of networks, a plurality of separate networks, a plurality of communicatively and/or operatively coupled networks, and/or the like.

The computing resources 102 may be implemented and/or embodied by one or more devices. Aspects of the computing resources 102 may be implemented by hardware, such as an anomaly detection (AD) device 105. The AD device 105 may comprise, be embodied and/or be implemented by an electronic device 104. The electronic device 104 may comprise any suitable means for implementing computing resources 102, including, but not limited to: a computing device, a portable computing device, a tablet computer, a smart phone, a personal digital assistant, a terminal, and/or the like. In some implementations, the electronic device 104 may comprise and/or correspond to one or more component(s) 102 of the PS 10-1, e.g., an MC component 16 of the PS 10-1, such as an IED, a relay, a protective relay, an RTU, and/or the like.

FIG. 2C is a schematic block diagram of another example of a monitoring system 100 configured to, inter alia, monitor a CPS 10 comprising a PS 10-1. As disclosed herein, the monitoring system 100 may comprise a hierarchical, multi-level, distributed PSM system 101. The PSM system 101 may comprise a first-level monitoring system and a second level monitoring system. The first-level monitoring system may comprise an LLM system 110 configured to monitor respective substations 11-1A-11-1S of the PS 10-1. The second-level monitoring system may comprise an ULM system 120 configured to cover the PS 10-1 (e.g., monitor substations 11-1A-11-1S, substation interconnections 18, and so on).

The LLM system 110 may be configured to implement a plurality of LLM functions 112 concurrently. As used herein, concurrent implementation of a plurality of functions (e.g., a plurality of LLM functions 112) refers to implementation of the functions substantially concurrently, simultaneously, in parallel, during a same period, during overlapping periods, during a same time window, during overlapping time windows, using separate, independent components or modules, and/or the like. For example, concurrent implementation of the DM function 111 may comprise implementing the LLM functions 112A-112S by use of respective LLM modules 212A-212S. The LLM modules 212 may be separate and/or independent, e.g., may comprise, be implemented on and/or embodied by separate devices, computing resources 102, electronic devices 104, and/or the like.

As disclosed herein, implementing an LLM function 112 on a substation 11-1 may comprise acquiring LLM data 113 pertaining to the physical behavior, operating point, and/or state of the substation 11-1. The LLM data 113 may be acquired by use of MC components 16 of the substation 11-1. In the FIG. 2C example, the LLM function 112A may comprise acquiring LLM data 113A by use of MC components 16A1-16AE of substation 11-1A, the LLM function 112B may comprise acquiring LLM data 113B by use of MC components 16B1-16BJ of substation 11-1B, the LLM function 112S may comprise acquiring LLM data 113S by use of MC components 16S1-16SD of substation 11-1S, and so on. The LLM data 113 may comprise HPM data, as disclosed herein.

Implementing the LLM function 112 may further comprise estimating a physical state of the substation 11-1. More specifically, implementing the LLM function 112 may comprise determining a local, LLSE 115 for the substation 11-1, the LLSE 115 configured to estimate, characterize, model, and/or otherwise indicate the physical state of the substation 11-1 and/or respective substation components 12. As disclosed herein, the LLSE 115 for a substation 11-1 may comprise and/or be derived from HPM data. In other words, the LLSE 115A-115S may comprise HP state estimates for substations 11-1A-11-1S, respectively. In some implementations, the HPM data may comprise synchrophasor data and, as such, the LLSE 115 determined for the substation 11-1 may comprise synchrophasor quantities. For example, the LLSE 115 may comprise phasor quantities determined for respective nodes of the substation 11-1 (e.g., magnitude and phase angles for electrical quantities such as voltage, current, power flow, and/or the like).

As disclosed herein, the LLM system 110 may be configured to implement the LLM functions 112A-112S concurrently. In some implementations, the LLM system 110 may comprise a plurality of local or lower-level monitoring (LLM) modules 212, each configured to implement a respective LLM function 112. In other words, each LLM module 212 may be configured to monitor a respective substation 11-1 of the PS 10-1 (e.g., generate LLPS 114 for the respective substation 11-1). In the FIG. 2C example, the LLM system 110 comprises S LLM modules 212A-S configured to implement LLM functions 112A-S on substations 11-1A-S.

Implementation of an LLM function 112 may comprise, inter alia, the LLM module 212 a) acquiring LLM data 113 from the substation 11-1 and b) determining an LLSE 115 for the substation 11-1 based, at least in part, on the acquired LLM data 113. As disclosed herein, the LLM data 113 may comprise HPM data, such as phasor measurements of voltage, current, and/or other physical quantities at respective nodes of the substation 11-1. The LLSE 115 may further comprise information pertaining to the topology of the substation 11-1. The LLM data 113 may, for example, indicate the status of respective relays, CB, switches, and/or other components 102 of the substation 11-1. In some implementations, the LLPS data 114 determined for respective substations 11 may further comprise LL anomaly detection (LLAD) data 215. The LLAD data 215 may comprise any suitable information pertaining to potential physical anomalies identified within a substation 11-1, e.g., LLAD data 215A-215S comprising anomaly data pertaining to substations 11-1A-11-1S, respectively. For example, the LLAD data 215 may comprise information determined while, inter alia, generating LLSE 115 for the substation 11-1, such as topology errors, data errors, and so on, as disclosed in further detail herein.

The LLM system 110 may be further configured to provide the LLPS data 114A-114S determined for the substations 11-1A-11-1S to one or more endpoints. The LLM system 110 may be configured to provide the LLPS data 114A-114S (and/or LLPS data 114 determined for designated substations 11) to specified component(s) 12 of the PS 10-1, such as a terminal, RTU, HMI, the ULM system 120, the mitigation module 140, and/or the like. The LLPS data 114 may be communicated via an HP network, as disclosed herein.

The ULM system 120 may be configured to implement an ULM function 122 by use of the LLPS data 114 generated by the LLM system 110. The ULM function 122 may comprise determining PSM data 123 for the PS 10-1, the PSM data 123 comprising a ULSE 125 configured to estimate, model, characterize, and/or otherwise indicate the physical state of the PS 10-1, as disclosed herein.

The PSM system 100 may further comprise an physical AD module configured to generate health data 134 for the PS 10-1 based, at least in part, on the PSM data 123. The health data 134 may be configured to quantify a degree to which operation of the PS 10-1 is indicative of component fault(s), cyber-attack, compromise, and/or the like (e.g., may comprise a PSH label 135). The PSM system 100 may provide PSH data 134 to other components of the PS 10-1, such as a mitigation module 140, as disclosed herein.

As disclosed herein, the LLPS data 114 determined for respective substations 11 may comprise LLSE 115 for the substations 11. The LLM function 112 may comprise implementation of a state estimation (SE) algorithm by, inter alia, the LLM module 212, e.g., LL modules 212A-212S configured to determine LLSE 115 for substations 11-1A-11-1S, respectively. The SE algorithm may be configured to determine the most likely state of the substation 11-1 given the LLM data 113 acquired from the substation 11-1. In implementations comprising an electrical power system, such as the PS 10-1, the LLSE 115 may comprise a set of complex voltages at respective nodes of the substation 11-1, as follows:

$${x}_{i} = {[ {θ}_{1} {θ}_{2} … {θ}_{N} \vert {V}_{1} \vert \vert {V}_{2} \vert … \vert {V}_{N} \vert ]}^{T} or {x}_{i} = [ \begin{matrix}θ \\ V\end{matrix} ] \qquad Eq . 2$$

In Eq. 2, xᵢ is the LLSE 115 determined for a substation 11-1-i comprising N nodes at a particular instant in time, θ₁ . . . θ_{N} are phase angles at respective nodes of the substation 11-1-i, and |V₁| . . . |V_{N}| are voltage magnitudes at the respective nodes. The nodes may correspond to buses or the like. In some implementations, the phase angle θ₁ at bus 1 may be taken as a reference and set to zero such that phase angles θ₂ . . . θ_{N} are relative and/or normalized with respect to θ₁. The LLSE 115 of the Eq. 2 example may, therefore, comprise V state variables, where V=2N−1. Alternatively, or in addition, the LL HP 115 may comprise phasor quantities, such as PMU. In these implementations, a reference phase angle measurement may not be required and, as such, the LLSE 115 may comprise 2N state variables. Other quantities pertaining to the substation 11-1 may be derived from the LLSE 115, such as power flow, voltage at all points, and so on.

The LLM module 212 may be configured to reduce the uncertainty inherent in the LLM data 113 acquired from the substation 11-1. In some situations, the HP measurements acquired from a substation 11-1 may be prone to uncertainty due to, inter alia, communication failures, communication delay, jitter, sensor error, synchronization error, and/or the like. The HP measurements of the LLM data 113 may, therefore, be inconsistent with one another. For example, one or more HP measurements may be contradictory or, in other words, violate physical constraints 15 of the substation 11-1. As such, there may not exist any state that fits the raw HPM data acquired from the substation 11-1. In other words, there may exist an error or residual within a state of the substation 11-1 comprising the raw HPM data. The LLSE 115 determined by the LLM module 212 may comprise revised measurements that conform with the physical constraints 15 of the substation 11-1 as well as other, raw HPM data.

The LLM module 212 may be configured to implement any suitable state estimation algorithm and/or technique, including but not limited to static state estimation, rule-based state estimation, generalized state estimation, and/or the like. In some implementations, the LLM module 212 may implement a deterministic approach to state estimation, such as load flow (LF) analysis, that involves a minimal set of measurements. Alternatively, or in addition, the LLM module 212 may utilize a stochastic approach incorporating additional, redundant HPM data; the LLM module 212 may exploit such redundancy to filter the raw measurement data for random noise and error.

As disclosed in further detail herein, the LLM module 212 may be configured to determine an optimal LLSE 115. As used herein, an “optimal” state estimate (e.g., LLSE 115) refers to a state estimate having an optimal error or residual as quantified according to determined optimization criteria, e.g., optimization criteria configured to minimize the state estimate residual or error between the HPM data and the resulting state estimate per the physical constraints 15 of the substation 11-1.

In some implementations, the LLM function 212 implemented by the LLM module 212 may further comprise generating LLAD data 215. The LLAD data 215 may comprise information identifying potential anomalies pertaining to the physical state of the substation 11-1. As disclosed in further detail herein, the LLM module 212 may determine aspects of the LLAD data 215 while generating the LLSE 115 for the substation.

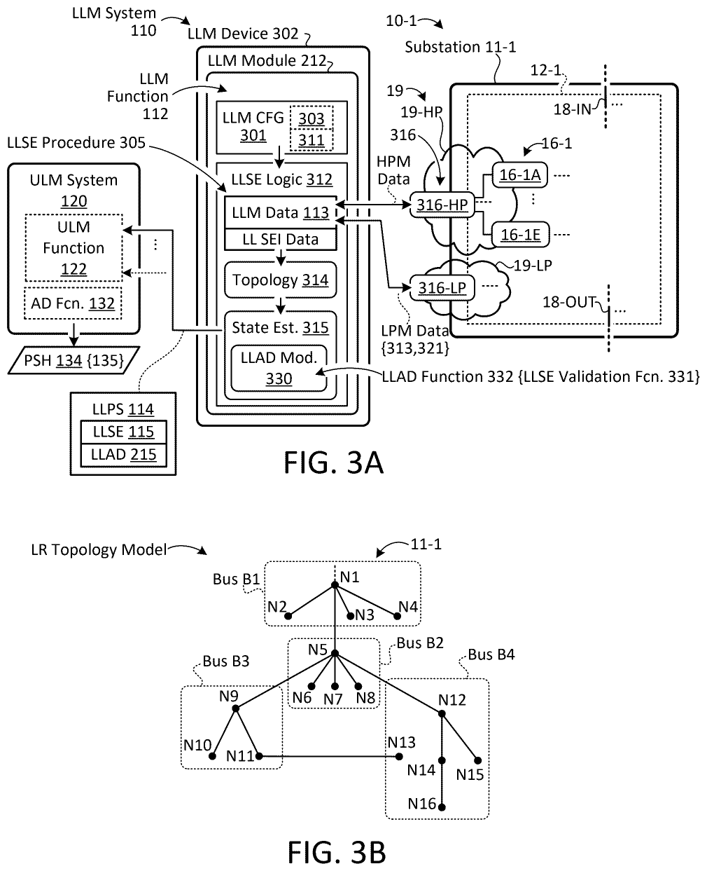

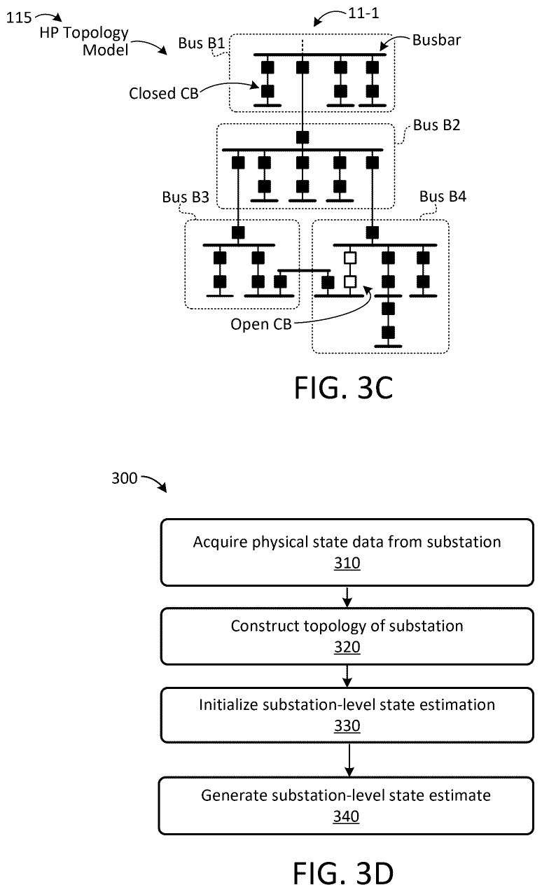

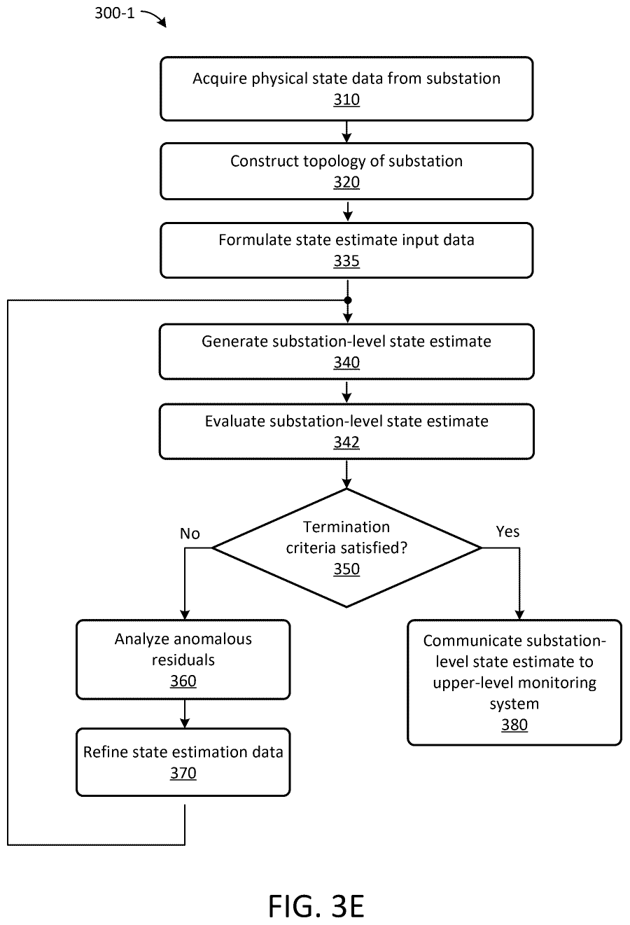

FIG. 3A is a schematic block diagram illustrating an example of an LLM module 212 of a monitoring system 100, as disclosed herein. The LLM module 212 may be configured to monitor a substation 11-1 of a PS 10-1. The LLM module 212 may be configured for operation on a processor of a computing device. In the FIG. 3A example, the LLM module 212 may be implemented on and/or embodied by computing resources of an LLM device 302. The LLM device 302 may comprise an electronic device, such as an MC component 16-1 of the substation 11-1, an IED, a terminal, a computing device, and/or the like. Alternatively, or in addition, aspects of the LLM module 212 may be implemented on and/or embodied by computing resources 102 of the monitoring system 100 (e.g., AD device 105), as disclosed herein.

The LLM module 212 may be configured to monitor a substation 11-1 of a PS 10-1. The substation 11-1 may comprise any suitable components 12-1, as disclosed herein. The substation 11-1 may be coupled to one or more other substations 11 of the PS 10-1 by interconnections 18. In the FIG. 3A example, the substation 11-1 may be coupled to one or more EH/VH substations 11-1 by incoming interconnections 18-IN and may be coupled to one or more distribution substations 11-1 (and/or loads) by output going interconnections 18-OUT (e.g., outgoing feeders). The substation 11-1 may further comprise one or more MC components 16-1, e.g., MC components 16-1A through 16-1E.

As disclosed herein, the LLM module 212 may utilize MC components 16-1 of the substation 11-1 to, inter alia, acquire LLM data 113 pertaining to the physical state of the substation 11-1. The MC components 16 may include CT, VT, metering equipment, protective relay, and/or the like, as disclosed herein. In some implementations, the MC components 16 may be configured to acquire LLM data 113 and transmit the LLM data 113 to the LLM module 212, e.g., push LLM data 113 to the LLM module 212. Alternatively, or in addition, the LLM module 212 may be adapted to configure selected MC components 16 to acquire suitable LLM data 113 pertaining to the substation 11-1 and/or request LLM data 113 from the MC components 16, e.g., configure the MC components 16 to acquire data suitable for state-estimation based anomaly detection and pull LLM data 113 therefrom. The LLM data 113 may comprise HPM data, such as real-time, time-synchronized phasor quantities, as disclosed herein. The LLM data 113 may be acquired at a high temporal resolution, e.g., between about 10 to 120 measurements per second (or higher).

In the FIG. 3A example, the substation 11-1 comprises MC components 16-1 through 16-E, each configured to acquire respective HPM data at respective locations within the substation 11-1 (e.g., at respective nodes). The HP MC components 16-1 through 16-E may comprise any suitable means for acquiring HPM data, as disclosed herein, such as PMU, IED, synchrophasor measurement devices, voltage phasor measurement devices, current phasor measurement devices, power phasor measurement devices, and/or the like. The HP MC components 16-1 through 16-E may implement any suitable type of time synchronization, including, but not limited to: global positioning system (GPS) time synchronization, the IEEE 1588 precision time protocol, and/or the like.

In some embodiments, the MC components 16-1 may be communicatively and/or operatively coupled to the LLM module 212 through high-performance (HP) network resources 19-HP of the network 19. As disclosed herein, HP network resources 19-HP may comprise and/or refer to electronic communication resources be configured to implement communication protocol(s) and/or standard(s) suitable for the communication of HPM data, which may include, but are not limited to: IEEE 1344, IEEE C37.118, IEEE C37.118.1a-2014, IEEE C37.118-2005, OPC, IEC 61850, and/or the like. In some examples, the LLM module 212 may be communicatively and/or operatively coupled to one or more of the MC components 16-1A through 16-1E by or through HP network resources 19-HP, such as an HP interface device 316-HP, such as a concentrator, PDC, IED, or the like.

Although examples of LLM data 113 comprising HPM data acquired over and/or by use of HP network resources 19-HP are described herein, the disclosure is not limited in this regard and could be adapted to acquire, retrieve, read, and/or other capture LLM 113 using any suitable communication means, e.g., the LLM module 212 may be configured to acquire any suitable type of LLM data 113 from any suitable type of device, network, and/or the like. In some embodiments, the LLM module 212 may utilize LP network resources 19-LP to acquire LLM data 113 pertaining to the current, real-time status and/or configuration of the substation and/or respective substation components 12-1, such as dynamic topology data 313, substation configuration data, and/or the like. In some implementations, the LLM module 212 may be configured to acquire such data from one or more substation components 12-1. Alternatively, or in addition, the LLM module 112 may be configured to acquire aspects of such LLM data 113 by use of an LP interface device 316-LP, such as a SCADA device, SCADA control device, modbus data concentrator, or the like.

As disclosed herein, the LLM module 212 may utilize the LLM data 113 acquired from the substation 11-1 to implement an LLM function 112. Aspects of the LLM function 112 may be implemented by processing logic of the LLM module 212, e.g., by LL state estimation (LLSE) logic 312. The LLSE logic 312 may be configured to estimate the physical state of the substation 11-1. More specifically, the LLSE logic 312 may be configured to implement aspects of a substation or LL state estimation (LLSE) procedure 305. The LLSE procedure 305 may comprise topology processing, observability, state estimation, bad data, topology error processing, and/or anomaly detection functions, as disclosed in further detail herein. In some implementations, the LLM module 212 may be configured to implement aspects of the LLSE procedure 305 by use of a topology processor 314 and a state estimator 315. The topology processor 314 and/or state estimator 315 may be implemented and/or embodied by LLSE logic 312 of the LLM module 212 (and/or other computing resources of the LLM device 302).

The LLM module 112 may further comprise and/or be coupled to LLM configuration data (LLM CFG 301). The LLM CFG 301 may comprise information pertaining to implementation of the LLM function 112. As disclosed in further detail herein, the LLM CFG 301 may comprise information pertaining to the architecture and/or topology of the substation 11-1 (e.g., static topology data 303), operator-specified configuration data (e.g., a substation CFG 311), and so on. The LLM CFG 301 may comprise and/or be embodied by NT storage resources, such as NT storage of the LLM module 212 (and/or LLM device 302), NT storage resources 102-3 of the monitoring system 100 (e.g., NT storage resources 102-3), NT storage resources of the PS 10-1, and/or the like.

In some implementations, the LLM CFG 301 may further comprise substation configuration data (substation CFG 311). The substation CFG 311 may comprise verified and/or authenticated operator-specified configuration data pertaining to the substation 11-1 and/or specified substation components 12-1. In other words, the substation CFG 311 may define an expected, nominal, or validated configuration of the substation 11-1. The substation CFG 311 may comprise any suitable configuration information, including but not limited to: CB settings, transformer tap settings or ratios, switch settings, relay trip parameters, and/or the like. The validation CFG 311 may, therefore, define an expected or nominal configuration of the substation 11-1 (and/or components 12-1 thereof). As disclosed in further detail herein, deviation from the validation CFG 311 may trigger detection of a physical anomaly, e.g., may indicate attack and/or compromise of one or more substation components 12-1.

As disclosed herein, the LLM module 212 may be configured to implement aspects of an LLM function 112. The LLM function 112 may comprise generating LLPS data 114 configured to characterize the physical state of the substation 11-1. The LLPS data 114 may, for example, comprise a substation-level state estimate (LLSE 115). The LLSE 115 configured to model and/or estimate the physical state of the substation 11-1 (and/or components 12-1 thereof), as disclosed herein.

The LLSE 115 may be generated in accordance with an LLSE procedure 305. Aspects of the LLSE procedure 305 may be implemented by LLSE logic 312 of the LLM module 212. For example, the LLSE logic 312 may comprise, implement, and/or embody a topology processor 314 (or substation-level, LL topology processor 314) and a state estimator 315 (or substation-level, LL state estimator 315). The LLSE procedure 305 implemented by the LLM module 212 may comprise any suitable state estimation technique and/or algorithm. In some implementations, the LLSE procedure 305 may comprise: a) constructing an internal, substation-level topology from, inter alia, CB states acquired from the substation 11-1 (and/or Y_{bus} matrix representation, as disclosed in further detail herein), b) acquiring HP measurement data from the substation 11-1, e.g., acquiring LLM data 113 comprising PMU phasor measurements at respective locations or nodes within the substation 11-1, c) deriving power injection and flows from the acquired HP measurement data, including virtual or pseudo measurements such as zero power injections where needed, d) formulating LL state estimation input (LL SEI) data per the LLSE procedure 305 implemented by the LLM 212 (e.g., deriving LL SEI data from the HPM data, such as power injection and flows, virtual measurements, measured voltage magnitudes, and/or the like), e) generating an LLSE 115 for the substation 11-1 in accordance with the LLSE procedure 305, e.g., executing a weighted least squares estimation on a linear regression model, and f) validating the LLSE 115.

In some implementations, the LLM module 212 may comprise and/or be coupled to an LL anomaly detection (LLAD) module 330. As disclosed in further detail herein, the LLAD module 330 may be configured to implement aspects of an LLAD function 332 configured to detect and/or analyze anomalies pertaining to the physical state of the substation 11-1 (and/or the LLSE 115 determined for the substation 11-1). LLAD function 332 may comprise an LLSE validation procedure 331 configured to, inter alia, validate and/or refine the LLSE 115. The LLSE validation procedure 331 may comprise: a) determining residuals of the LLSE 115, e.g., quantifying error associated with respective measurements of the LLSE 115, b) identifying anomalous residuals, e.g., residuals or other errors that exceed a predefined anomalous residual (AR) threshold and/or satisfy other criteria, c) performing a root cause analysis of the anomalous residuals, and d) refining the LLSE 115 if needed, e.g., refining the LL SEI data used to generate the LLSE 115 based on the root cause analysis and recalculating the LLSE by use of the refined data. In some implementations, the LLSE 115 may be validated and/or refined in accordance with the LLSE procedure 305 implemented by the LLM module 212. For example, the LLM module 212 may be configured to iteratively validate and/or refine the LLSE 115 in accordance with the GSE algorithm implemented by the state estimator 315.

The LLM module 212 may be further configured to communicate the resulting LLPS data 114 (and corresponding LLSE 115) determined for the substation 11-1 to the ULM system 120. The ULM system 120 may utilize LLPS data 114 determined for respective substations 11-1 to implement aspects of a ULM function 122, as disclosed herein. The ULM function 122 may comprise leveraging the LLSE 115 determined for respective substations 11-1 to efficiently generate a ULSE 125 configured to characterize the physical state of the PS 10-1 as a whole, e.g., characterize the physical state of respective substations 11-1, substation interconnections 18 (e.g., lines), and so on. The ULM function 122 may further comprise evaluating the physical health of the PS 10-1 based, at least in part, on the ULSE 125. The ULM function 122 may comprise an AD function 132, as disclosed herein. Aspects of the AD function 132 may be implemented by a physical AD module in accordance with an AD CFG 131. In some implementations, the physical AD module may implement aspects of the AD function 132 by use of an AI/ML module 150, as disclosed herein. The AD function 132 may comprise generating PSH data 134 in response the PSE data 123 generated for the PSE 10-1, the PSH data 134 configured to characterize the physical behavior and/or state of the PS 10-1, as disclosed herein (e.g., by use of one or more physical health metrics, a PSH label 135, and/or the like).

As disclosed herein, the LLSE procedure 305 may comprise constructing a topology of the substation 11-1, e.g., constructing a substation-level, or LL topology. The LL topology of the LLSE 115 may be configured to model and/or represent aspects of the network topology of the substation 11-1 at a specified instant in time. The topology processor 314 may be configured to derive the topology of the substation 11-1 from LL topology data pertaining to the substation 11-1. The LL topology data may comprise static topology data 303 and real-time, dynamic topology data 313. The static topology data 303 may define possible configurations of the substation 11-1 whereas the dynamic topology data 313 may indicate a current state of the substation 11-1 (and/or components 12-1 thereof). In other words, the static topology data 303 may comprise static information pertaining to the architecture, arrangement, and/or configuration of the substation 11-1 and/or components 12-1 thereof, and the dynamic topology data 313 may comprise information pertaining to a current, real-time, measured status and/or state of the substation 11-1 and/or components 12-1 thereof. The static topology data 303 may include but is not limited to: a listing of components 12-1 comprising the substation 11-1 (e.g., busbars, buses, branches, interconnections 18, CB, shunt capacitors, generators, transformers, MC components 16, and the like), possible connections between substation components 12-1 (and/or other substations 11-1), static configuration data for respective components 12-1 (e.g., possible tap settings for respective substation transformers), and so on. Aspects of the static topology data 303 may be maintained within the LLM CFG 301 of the LLM module 212 and/or other NT storage, e.g., NT storage resources of the substation 11-1, NT storage resources of the PS 10-1, NT storage resources 102-3 of the monitoring system 100, and/or the like.

The LLM module 212 may be configured to acquire dynamic topology data 313 from the substation 11-1. As used herein, dynamic topology data 313 may comprise and/or refer to any suitable information pertaining to the current physical state, status, and/or topology of the substation 11-1 (and/or respective substation components 12-1), including but not limited to: substation status data, component-level status data, CB status data (e.g., “open” or “closed” status for respective CB), switch status data, branch status data, relay status data, IED status data, transformer status data, transformer settings, transformer tap settings, relay settings, and/or the like.

The LLM module 212 may be configured to acquire dynamic topology data 313 pertaining to the substation by any suitable means. By way of non-limiting example, the LLM module 212 may be configured to acquire LLM data 113 by use of HP network resources 19-HP, e.g., aspects of the dynamic topology data 313 may comprise HPM data, as disclosed herein. Alternatively, or in addition, the LLM module 212 may be configured to acquire aspects of the dynamic topology data 313 by use of LP network resources 19-LP, as illustrated in FIG. 3A. The LLM module 212 may be configured to acquire dynamic topology data 313 directly from one or more substation components 12-1. In other words, the LLM module 212 may be configured to read dynamic topology data 313 from respective CB, switches, protective relays, transformers, MC components 16-1, and/or other substation components 12-1. Alternatively, or in addition, the LLM module 212 may be configured to acquire dynamic topology data 313 by use of other types of network devices, such as an HP network interface 316-HP, LP network interface 316-LP, or the like.

The LLM module 212 may be configured to construct a topology of the substation 11-1 based, at least in part, on static topology data 303 and dynamic topology data 313 pertaining to the substation 11-1. The LLM module 212 may be configured to construct the substation topology by use of LLSE logic 312 and/or a topology processor 314.

The topology processor 314 may be configured to derive a topology of the substation 11-1 from dynamic topology data 313 indicating the state of respective CB (and/or other topological substation components 12, such as switches, relays, and/or the like). In some implementations, the topology processor 314 may be configured to collapse the LL topology data 313 into a network model comprising a collection of nodes (e.g., buses). The buses of the network model may be interconnected in accordance with the acquired LL topology data 313, e.g., transformer locations, CB status, and so on. As disclosed in further detail herein, the topology processor 314 may be configured to produce a node-breaker topology model of the substation 11-1 suitable for generalized state estimation.

FIGS. 3B and 3C illustrate examples of network topology models; FIG. 3B illustrates an example of a lower-resolution level (LR) topology model and FIG. 3C illustrates an example of an LLSE 115 comprising a more detailed high-resolution or high-performance (HP) topology model.

FIG. 3B illustrates an example of an UL topology determined for the substation 11-1. The UL topology may comprise a more compact and computationally efficient representation of the substation topology as compared to the HP topology of FIG. 3C. The UL topology may comprise a bus-branch network model configured to represent the topology of the substation 11-1 as a set of abstract nodes N1-N16 organized within respective buses 1-4 (e.g., without explicitly modeling and/or representing the state of respective substation components 12-1, such as CB).

The HP topology model illustrated in FIG. 3B may comprise a node-breaker network model of the substation 11-1. The HP topology model of the LLSE 115 may be configured to estimate the real-time state of respective components 12 of the substation 11-1 (e.g., respective CB). In FIG. 3C, closed CB are shown with black fill and open CB are unfilled (or with white fill).

As illustrated in FIG. 3C, the HP topology model may comprise more detail pertaining to the physical state of the substation 11-1 than the UL topology model of FIG. 3B. For example, the HP topology model may indicate the state of respective CB (and/or other substation components 12-1). Moreover, the HP topology model may support additional measurement data points as compared to the UL topology model. For example, the HP topology model may be capable of representing redundant voltage measurements corresponding to respective CB (and/or other components 12-1), which may enable more robust and accurate bad data and/or topology error processing as compared to lower-resolution topology models.

Due to these and other factors, HP topology models may impose higher overhead than other lower-resolution topology models, such as UL topology models. HP topology models may be more computationally complex to construct, have a larger memory footprint, and/or require more LLM data 113 than other types of topology models. As such, it may not be practical to construct an HP topology model that covers the full extent of the PS 10-1, particularly not at the high refresh rates of the HPM data disclosed herein (e.g., about 10 to 120 times per second). In contrast to the ULSE 125 produced by the ULM system 120, the LLSE 115 generated by respective LLM modules 212 of the LLM system 110 may cover limited sub-sections of the PS 10-1, e.g., respective substations 11-1 of the PS 10-1. Moreover, the DM function 111 implemented by the LLM system 110 may be configured to distribute the computational and communication overhead involved in generating the LLSE 115 for respective substations 11-1 across multiple devices, e.g., across multiple LLM modules 212 and/or substation components 12-1. The distributed, multi-tiered architecture of the PSM system 101 may, therefore, enable the LLM system 110 to generate LLSE 115 comprising detailed HP topology models derived from and/or populated by redundant HPM data. The LLSE 115 generated by the LLM system 110 may, therefore, comprise highly detailed state representations of respective substations 11-1. Moreover, the use of HP topology models capable of supporting higher data densities (e.g., increased data redundancy) may improve the performance of substation-level LLSE anomaly processing, such as bad data processing, topology error processing, and so on, as disclosed in further detail herein. As such, the LLSE 115 generated by respective LLM modules 212 may comprise preprocessed, validated, and/or refined physical state data for respective substations 11-1 that can be leveraged by the ULM system 125 to accurately and efficiently model the physical state of the PS 10-1.

Referring to FIG. 3A, the LLM module 212 may be configured to estimate the physical state of the substation 11-1 (e.g., generate the LLSE 115) in accordance with a specified LLSE procedure 305. The LLSE procedure 305 may comprise any suitable technique and/or algorithm. Aspects of the LLSE procedure 305 may be implemented by a state estimator 315 (or LL state estimator 315) of the LLM module 212. The LL state estimator 315 may comprise state estimation processing logic, e.g., logic and/or processing resources. The LL state estimator 315 may be implemented and/or embodied by LLSE logic 312 or other computing resources of the LLM module 212.

The LLSE procedure 305 may comprise generating LLSE 115 in accordance with any suitable state estimation or technique. In some implementations, the LLSE procedure 305 comprises generalized state estimation, as disclosed in further detail herein (e.g., weighted least squares estimation on a linear regression model). Alternatively, or in addition, the LLSE procedure 305 may comprise a static and/or rule-based state estimation algorithm, which may comprise: a) receiving LLM data 113 from the substation 11-1, the LLM data 313 comprising dynamic topology data 313 (and/or static topology data 303), as disclosed herein, b) performing a telemetry analysis of the acquired LLT data 313, c) constructing a HP topology model of the substation 11-1 (e.g., a node-branch model based on telemetered component status data, such as CB status data and the like), and d) allocating measurements of the LLM data 113 to the bus-branch model.

The telemetry analysis may be implemented in accordance with any suitable algorithm and/or technique, including but not limited to rule-based telemetry analysis, KCL at respective nodes, and/or the like. In some embodiments, the telemetry analysis may be configured to identify errors, such as zero power flow on disconnected lines or the like. In some implementations, the LLM module 212 may comprise and/or implement aspects of a topology processor configured to construct topology models of the substation 11-1. The topology processor may be implemented and/or embodied by the LLSE logic 312 and/or other computing resources of the LLM module 212. The topology processor may be configured to construct an HP topology model of the substation 11-1 based on the LL topology data 313 disclosed herein. For example, the topology processor may be configured to determine the current topology of the substation by, inter alia, applying the dynamic topology data 313 to the static topology of the substation 11-1, e.g., as defined by the static topology data 303.

The LLM module 212 may be further configured to allocate measurements of the LLM data 113 to the HP topology model determined for the substation 11-1. The LLSE logic 312 may be configured to allocate and/or refine the measurement data by any suitable algorithm or technique. For example, the LLSE logic 312 may implement an active power injection algorithm in which the active power injections of the nodes comprising respective buses within a bus-branch topology model (e.g., nodes connected through closed CB) may be summed to determine an active power injection measurement of the buses. Power flow measurements of zero-impedance branches may be allocated to branches of the bus-branch model based on CB status data. In the examples illustrated in FIGS. 3B and 3C, the LLSE logic 312 may be configured to analyze power flow on nodes N1-N4 of bus B1, nodes N5-N8 of bus B2, nodes N9-N11 of bus B3, nodes N12-N15 of bus B4, and so on. In some implementations, the LLSE logic 312 may be further configured to merge and/or aggregate HPM data to reduce computational and/or communication overhead. For example, voltage measurements for bus bars and corresponding substation bays may be merged into respective bus-branch measurements, e.g., through a weighted average or other suitable technique.

The LLSE logic 312 may be further configured to detect and/or correct state estimation errors, such as topology errors. For example, if one or more CB statues are incorrect, the LLSE logic 312 may produce an incorrect network model, leading to a biased state estimation (e.g., biased LLSE 115). Since CB status are not included in many rule-based SE approaches, the LLSE logic 312 may attempt to indirectly infer topology errors from their impact on residuals. The LLSE logic 312 may be configured to identify anomalies pertaining to any suitable type of topology error, including but not limited to: telemetry error, inclusion error (e.g., the inclusion of a disconnected branch or other substation component 12-1 in the topology model of the LLSE 115), exclusion error (e.g., exclusion of a connected branch or other substation component 12-1 from the topology model), split error (e.g., modeling a section of the substation 11-1 as several buses in the topology model when the section should be modeled as a single bus), merge error (e.g., modeling a group of substation components 12-1 as a single bus when the group should be modeled as a plurality buses separated by open CB), and/or the like.

The LLSE logic 312 may identify potential topology errors through analysis of the residual of the LLSE 215. As disclosed herein, the residual may quantity error within a state estimate (e.g., LLSE 215), such as error between bus voltage measurements. For example, the residual may quantify error between voltages determined for the nodes and/or other components 12-1 on a common bus, e.g., a difference between voltage phasors for nodes N1-N4 of bus B1, nodes N5-N8 of bus B2, nodes N9-N11 of bus B3, nodes N12-N15 of bus B4 in the FIG. 3B example. The LLSE logic 312 may, for example, identify buses that are incident to suspect HPM data (e.g., buses exhibiting residuals that exceed a threshold). The LLSE logic 312 may then evaluate different measurement combinations to identify an optimal LLSE 115, e.g., an LLSE 115 having a lowest residual and/or highest performance index. In a first non-limiting example, the LLSE logic 312 may repeat the rule-based state estimation algorithm for different possible combinations of CB status to identify the LLSE 115 having the lowest residual. In a second non-limiting example, LLSE logic 312 may implement a hypothesis testing approach in which residuals from different specific topology errors are estimated and compared with actual residuals. In a third non-limiting example, the LLSE logic 312 may utilize the values of the state and power flows determined in earlier time instants to identify potential errors, e.g., identify unexpected and/or invalid deviations in physical state likely to be anomalous.

The LLSE logic 312 may be configured to include information pertaining to potential anomalies identified during generation of the LLSE 115 within the LLAD data 315, which may include but is not limited to: the residual of the LLSE 115, topology errors, buses having residuals that exceed a threshold, measurement errors, and/or the like.

By way of non-limiting example, in static and/or rule-based embodiments, the LL state estimator 315 may implement weighted least squares (WLS) estimation in which the topology of the substation 11-1 (and/or PS 10-1) is modeled using, inter alia, a bus admittance matrix representation (Y_{bus}). The LLSE logic 312 may be configured to model the HPM data acquired from the substation 11-1 as follows:

$$z [ \begin{matrix}{z}_{1} \\ {z}_{2} \\ … \\ {z}_{M}\end{matrix} ] = [ \begin{matrix}{h}_{1} ( {x}_{1} , {x}_{2} … , {x}_{N} ) \\ {h}_{2} ( {x}_{1} , {x}_{2} … , {x}_{N} ) \\ … \\ {h}_{M} ( {x}_{1} , {x}_{2} … , {x}_{N} )\end{matrix} ] + [ \begin{matrix}{e}_{1} \\ {e}_{2} \\ … \\ {e}_{M}\end{matrix} ] = h ( x ) + e \qquad Eq . 3$$

In Eq. 3, z is the measurement vector (M×1), e.g., raw measurement data acquired from the substation 11-1 (LLM data 113) such as power flows or the like, h(x) is the measurement function vector (M×1), e.g., the expected measurements according to the physical constraints 15 such as power flow equations for a given state x, and e is the measurement error or residual vector (M×1), which may be modeled as normally distributed noise. Given a set of LLM data 113, the LLSE logic 312 may determine an LLSE 115 by finding a state estimate having a minimal residual, e.g., an LLSE 115 that minimizes a scalar sum of squared residuals per Eq. 4 below:

$$J ( x ) = {\sum }_{∀ j} [ {w}_{j} {( {z}_{j} - {h}_{j} ( x ) )}^{2} ] = {\sum }_{∀ j} [ {w}_{j} - {r}_{j}^{2} ] \qquad Eq . 4$$

In Eq. 4, j is the index of a measurement in the measurement vector z, rⱼ=zⱼ−hⱼ(x) is the residual of measurement j (e.g., deviation between measurement zⱼ and the estimated measurement hⱼ(x) of the LLSE 115), and wⱼ is the weight of measurement j, which may be used to prioritize minimization of residuals rⱼ of reliable, low-error HPM data. The LLSE logic 212 may solve the WLS formulation in vector form as follows, where W is a diagonal weighting matrix:

$$J ( x ) = {[ z - h ( x ) ]}^{T} W [ z - h ( x ) ] \qquad Eq . 5$$

Determining the most likely state may comprise weight of the individual measurements as the inverse the following diagonal covariance matrix, as illustrated in Eq. 6 below:

$$W = {R}^{- 1} = diag ( \frac{1}{{σ}_{i}^{2}} ) = diag ( {w}_{i} ) \qquad Eq . 6$$

The LLSE logic 312 may determine an optimal LLSE 115 for the substation 11-1 by, inter alia, solving Eq. 6 using a suitable method, such as linear regression, Gauss-Newton or the like. The LLSE logic 312 may iteratively evaluate potential estimations of the state x until the residual vector r=z−h(x) satisfies a threshold. The LLSE logic 312 may be configured to linearize the non-linear vector h(x) using an (M×N) Jacobian with respect to the state vector x. Iterative updates for respective iterations k may be determined according to Eq. 7 below:

$$Δ {x}_{k} = {[ {H}_{k}^{T} W {H}_{k} ]}^{- 1} {H}_{k}^{T} W [ z - {h}_{k} ] \qquad Eq . 7$$

State estimates for subsequent iterations k+1 may be determined as follows:

$${x}_{k + 1} = {x}_{k} + Δ {x}_{k} \qquad Eq . 8$$

As disclosed above, the LLSE logic 212 may continue the iterations until a state estimate xₖ that yields a Δxₖ that satisfies a threshold is identified, or other termination criteria are satisfied, e.g., LLSE 115 for the time-step t (\hat{x}ₜ) may be \hat{x}ₜ=xₖ. The corresponding state covariance matrix may be expressed as follows:

$${\sum }_{t} = Cov ( {\hat{x}}_{t} ) = {[ {H}_{k}^{T} W {H}_{k} ]}^{- 1} \qquad Eq . 9$$

In some implementations, the LLM module 212 may be configured to incorporate HPM data such as PMU into the LLSE 115 determined for the substation 11-1. In some implementations, PMU may be included in the measurement and estimate vector(s) of Eq. 3, e.g., z₁ . . . z_{M} and h₁(x₁, x₂ . . . , x_{N}). Alternatively, or in addition, the LLSE logic 212 may be configured to incorporate PMU in a two-stage approach, wherein 1) the first stage comprises implementation of a WLS or other SE algorithm to determine a first state estimate denoted \hat{x}⁽¹⁾ having a covariance matrix denoted Σ⁽¹⁾ per Eq. 9 and 2) the second stage comprises determining a linear SE using the PMU and results from the first stage as virtual or pseudo measurements, e.g., \hat{x}⁽¹⁾ weighted per [Σ⁽¹⁾]⁻¹. Linearization may be achieved by using a rectangular voltage representation of the state vector, e.g., resulting in linearization of the PMU measurement functions z₁ . . . z_{M}. These linear characteristics may enable the linear SE to be non-iterative, reducing computational overhead.

Referring to the FIG. 2C example, the substations 11-1A-11-1S may be observable by HPM data and, as such, the LLM system 110 (and the LLM modules 112) may be configured to determine LLSE 115 for respective substations without the need for an iterative first stage, e.g., without iterative computation of a first stage state estimate \hat{x}⁽¹⁾. In other words, the substations 11-1A-11-1S may comprise MC components 16 capable of acquiring HPM data sufficient for determining LLSE 115A-115S for the substations 11-1A-11-1S, e.g., per SE observability analysis. For example, the substations 11-1A-11-1S may be covered by PMU devices configured to acquire HPM data comprising a) phase voltage quantities on about every third bus and b) current quantities on connecting branches. In these implementations, the LL SE logic 214 may be configured to produce LLSE 115 per the second stage described above, without the need to iteratively determine a first stage state estimate \hat{x}⁽¹⁾. The LLM system 110 may be further configured to determine LLSE 115A-115S at a high update rate; the LL SE logic 214S-214S may be configured to determine LLSE 115A-115S having an update rate corresponding to the acquisition rate of the HPM data, e.g., about 10 to 120 times per second, as disclosed herein.

Although specific examples of techniques and algorithms for determining LLSE 115 are described herein, the disclosure is not limited in this regard and could be adapted to utilize any suitable technique and/or algorithm, e.g., any suitable LLSE procedure 305. For example, in some implementations the LLM system 110 may be configured to implement a state estimation algorithm that incorporates dynamic topology data 313 acquired from the substations 11 (e.g., incorporates real-time CB status and the like). As illustrated in FIG. 3A, the LLM module 212 may be configured to acquire HPM data 113, which may comprise HP measurements of topological elements of the substation 11-1, such as CB, switches, relays, and so on. The LLM module 212 may be configured to incorporate such dynamic topology data 313 into the algorithm used to generate the LLSE 115 for the substation 11-1. The LLSE procedure 305 implemented by the LLM module 212 may, for example, comprise a generalized state estimation (GSE) methodology in which dynamic topology data 313 acquired from the substation 11-1 are taken as stochastic measurements (and/or parameters of lines, transformers, etc.) from which the LLSE 115 may be derived.

In GSE implementations, generating LLSE 115 for the substation 11-1 may comprise the LLM module 212 (and/or LLSE logic 312), inter alia: a) generating a HP topology of the substation 11-1, e.g., node-breaker network model as illustrated in FIG. 3C, b) formulating state estimation input (SEI) data, and c) applying a GSE algorithm to the resulting node-breaker model and SEI data. As disclosed herein, in GSE implementations, CB status data and/or other dynamic topology data 313 acquired from the substation 11-1 may be treated as stochastic measurements. Therefore, under GSE approaches, the LLSE 115 may not only reduce uncertainty with respect to physical state data (e.g., voltages at respective nodes) but may also reduce uncertainty with respect to substation topology.

As disclosed herein, in GSE implementations the LLM module 212 may be configured to incorporate topology data 313 (e.g., CB status data) into measurement vectors for the substation 11-1, e.g., . . . , z₁ . . . z_{M}. In a zero-impedance branch (CB “closed” status), power flow may be determined according to the Kirchhoff current law. The state vector (x) determined for the substation 11-1 may be configured to estimate power flow in accordance with the CB status information as follows:

$${x}_{i} = [ \begin{matrix}θ \\ v \\ p \\ q\end{matrix} ] \qquad Eq . 10$$

As in Eq. 2 and 3 above, xᵢ is the LLSE 115 determined for a substation 11-1-i at a particular instant in time. Eq. 10 may be augmented to include active power flow (pₖₗ) and reactive power flow (qₖₗ) vectors of length NCB (the number of CB within the substation 11-1-i).

The GSE algorithm implemented by the LLM module 212 may be further configured to incorporate topology constraints. For example, the voltage drop between nodes connected by closed CB may be modeled as zero and, as such, phase voltage differences between such nodes may be constrained to be 0, as follows:

$${v}_{k} - {v}_{l} = 0 , {θ}_{k} - {θ}_{l} = 0 \qquad Eq . 11$$

Eq. 11 corresponds to a constraint that the voltage and/or phase differential between nodes k and 1 connected by a closed CB is zero. By contrast, open CB may be modeled as having infinite impedance, such that active and reactive power flow through open CB can be constrained as follows:

$${p}_{kl} = 0 , {q}_{kl} = 0 \qquad Eq . 12$$

In the constraint of Eq. 12, nodes k and l are coupled by an open CB and, as such, the power flow therebetween is zero. The constraints of Eq. 11 and 12 may be included in the LLSE 115 as pseudo-measurements. Although particular examples of topology constraints are described herein, the disclosure is not limited in regard and could be adapted to incorporate topology measurements and/or constraints using any suitable technique. For example, one or more constraints may be omitted. Alternatively, or in addition, the constraints may be expressed in different, more general forms, as follows:

$${CB}_{kl} == open ? ( {p}_{kl} ( {θ}_{k} - {θ}_{l} ) = 0 : {q}_{kl} ( {v}_{k} - {v}_{l} ) = 0 \qquad Eq . 13$$

The generalized constraint of Eq. 13 may be configured to implement a zero-power-flow constraint when the CB coupling buses k and l has an “open” status and zero-phase-voltage constraint when the status of the CB is “closed.”

The LLM module 212 may be configured to solve the GSE algorithm through any suitable approach or technique. LLM module 312 may implement a WLS approach in which equality constraints are treated as virtual measurements (e.g., per Eq. 11-13) that may be strictly enforced. The virtual measurements may be configured to model zero-injection buses, external networks, CB status, and so on.

In a first non-limiting example, the LLM module 312 may be configured to solve GSE formulations through a robust estimation method, such as orthogonal factorization or the like. As disclosed above, the measurement functions h(x) of the GSE may be linearized using a Jacobian with respect to the state vector x. In the orthogonal factorization method, the Jacobian may be multiplied by a square of the measurement weights, as follows:

$$\tilde{H} ( x ) = {W}^{1 / 2} H ( x ) \qquad Eq . 14$$

To reduce ill-conditioning, the Jacobian may be decomposed into an orthogonal matrix and an upper triangular matrix U, per Eq. 15 below:

$$\tilde{H} = QR = [ {Q}_{1} {Q}_{2} ] [ \begin{matrix}U \\ 0\end{matrix} ] = {Q}_{1} U \qquad Eq . 15$$

For the linear case, being the pre-multiplied measurement vector, the normal equation (Eq. 7) may be formed by combining (and simplifying) Eq. 14 and Eq. 15 as follows:

$$U Δ x = {Q}_{1} \tilde{r} ( x ) \qquad Eq . 16$$

An optimal LLSE 115 may be determined by iteratively a two-stage equation, as follows:

$$\begin{matrix}{y}_{1} = {Q}_{1} \tilde{r} ( x ) \\ U Δ \hat{x} = {y}_{1}\end{matrix} \qquad Eq . 17$$

Alternatively, or in addition, in a second non-limiting example, the LLM module 312 may be configured to handle the GSE equality constraints using constrained optimization. The GSE equality constraints may be transferred from the measurement vector z to an equality vector c, as follows:

$$\begin{matrix}min J ( x ) = \frac{1}{2} {r}^{′} Wr \\ subject to c ( x ) = 0\end{matrix} \qquad Eq . 18$$

The LLM module 212 may determine a solution to Eq. 18 using any suitable technique. For example, the LLM module 212 may solve Eq. 18 by applying Karush-Kuhn-Tucker conditions to a Lagrangian formulation of Eq. 18, as follows:

$$[ \begin{matrix}{H}^{T} WH & {C}^{T} \\ C & 0\end{matrix} ] [ \begin{matrix}Δ x \\ - λ\end{matrix} ] = [ \begin{matrix}{H}^{T} W Δ {z}^{k} \\ - c ( {x}^{k} )\end{matrix} ] \qquad Eq . 18$$

In Eq. 19, C is the Jacobian matrix of the equality constraints and A is the vector of Lagrange multipliers, which may express costs associated with enforcing constraints.

In some implementations, the LLM module 212 may utilize the Lagrange multipliers λ of the resulting LLSE 115 to, inter alia, identify potential anomalies, e.g., along with normalized residuals. For example, the multiplier values λ may quantify a degree to which equality constraints (and/or the underlying topology data 313) conform with LLM data 113 acquired from the substation 11-1 (e.g., measurements of the LLSE 115). Low multiplier values λ may be indicative of low residual error (topology data that conforms with other LLM data 113) whereas higher multiplier values λ may be indicative of topology data 313 that are inconsistent with other LLM data 113. As disclosed in further detail herein, the LLM logic 214 may apply methods for bad data (BD) analysis to the Lagrange multiplier values λ of the LLSE 115, e.g., along with normalized residuals or the like. The multiplier values λ may be included in the LLAD data 315 determined for the substation 11-1, as disclosed herein.

Referring back to FIG. 2C, the LLM system 110 may be configured to determine a plurality of first, tier 1, or low-level state estimates (e.g., LLSE 115), each configured to cover a respective section or substation 11-1 of the PS 10-1. As disclosed herein, the LLSE 115 for respective substations 11-1 may be determined concurrently, e.g., by respective LLM modules 212. Generating an LLSE 115 for a substation 11-1 may comprise a) constructing an HP topology model from, inter alia, dynamic topology data 313 retrieved from the substation 11-1, e.g., CB states, b) determining SEI data for the LL state estimator 315, and c) executing the state estimation algorithm to determine an LLSE 115 for the substation 11-1. The SEI data may comprise any suitable data for the LLSE procedure 305 implemented by the LLM module 212. In GSE implementations, the SEI data may comprise power injection and power flow quantities derived from PMU phasor measurements acquired from the substation 11-1 (e.g., LLM data 113), virtual measurements, such as zero power injections (if needed) derived from the LLM data 113, measured voltage magnitudes at respective nodes of the HP topology, and so on.

In some implementations, the LLM system 110 may be configured to generate LLSE 115 for respective substations 11-1 according to the method 300 illustrated by the flow diagram of FIG. 3D. The flow diagram illustrating method 300 includes steps, operations, or blocks 310 through 340. Aspects of the method 300 (and/or methods of the other flow diagrams herein) may be implemented by hardware components or devices, such as a computing device 104, AD device 105, LLM device 302, and/or the like. Alternatively, aspects of the method 300 (and/or other methods disclosed herein) may be implemented by components, modules, and/or computing resources 102, such as processing resources 102-1, memory resources 102-2, and/or the like. Aspects of the method 300 (and/or other methods disclosed herein) may be implemented and/or embodied by computer-readable instructions stored on a NT storage medium.

FIG. 3D is a flow diagram illustrating an example of a method 300 for monitoring a substation 11-1, e.g., implementing an LLM function 112 pertaining to the substation 11-1. Step 310 may comprise acquiring physical state data from the substation 11-1. Step 310 may comprise acquiring LLM data 113 pertaining to the substation 11-1, as disclosed herein. The LLM data 113 may be acquired from one or more substation components 12-1, MC components 16-1, network interface devices (e.g., HP network interface 316-HP and/or LP network interface 316-LP), and/or the like.

The LLM data 113 acquired at 310 may comprise information pertaining to the current, real-time topology of the substation 11-1, such as dynamic topology data 313. The dynamic topology data 313 may comprise LPM data acquired by use of LP network resources 19-LP of the CPS 10. Alternatively, or in addition, aspects of the dynamic topology data 313 may be acquired by use of HP network resources 19-HP (e.g., may comprise HPM data, as disclosed herein).

Step 310 may further comprise acquiring HPM data pertaining to the substation 11-1, such as PMU phasor quantities, synchrophasors, and/or the like. The HPM data may be acquired by use of HP network resources 19-HP of the CPS 10, as disclosed herein.

Step 320 may comprise constructing a topology of the substation 11-1 based, at least in part, on the LLM data 113 acquired at 310 (e.g., by use of dynamic topology data 313, as disclosed herein). The LLM module 212 may be configured to construct the topology by, inter alia, applying the dynamic topology data 313 acquired at 310 to static topology data 303 of the substation 11-1. The LLM module 212 may construct the topology model by use of a topology processor 314, as disclosed herein. The LLM module 212 may retrieve the static topology data 303 from computer-readable storage (e.g., may retrieve the static topology data 303 from an LLM CFG 301, NT storage resources, and/or the like). At 320, the LLM module 212 may be configured to construct a HP topology model suitable for GSE, such as a node-breaker network model as illustrated in FIG. 3C. The topology model may comprise a bus admittance matrix representation (Y_{bus}) of the substation 11-1, e.g., a Y_{bus} matrix representation as illustrated in Eq. 3 and Eq. 10.

Step 330 may comprise initializing substation-level state estimation of the substation 11-1. Step 330 may comprise initializing a state estimation algorithm and/or substation-level state estimator 315 (LL state estimator 315). The initializing may comprise formulating LL SEI data suitable for the state estimation algorithm implemented by the LL state estimator 315 (and/or LLSE procedure 305), as disclosed herein. In some implementations, step 330 may comprise acquiring HP measurement data (LLM data 113) pertaining to the substation 11-1. The LLM data 113 may comprise PMU phasor measurements acquired at respective locations within the substation 11-1, e.g., at respective nodes, buses, lines, substation components 12-1, interconnections 18, and/or the like per the topology of the substation 11-1. In some implementations, the LLM module 212 may acquire aspects of the HPM data at and/or during step 310 of the method 300. In other words, in some implementations, at least a portion of the LLM data 113 used to generate the LL SEI data at 330 may be acquired at 310. Alternatively, or in addition, the LLM module 212 may be configured to acquire at least a portion of the LLM data 113 used to formulate the SEI data at step 330 (e.g., may acquire one or more phasor measurements in a separate monitoring and/or data acquisition operation).

The initializing of step 330 may comprise deriving LL SEI data from LLM data 113 acquired from the substation 11-1 (e.g., PMU phasor measurements); the initializing of step 330 may comprise determining power injection and flow quantities (e.g., power flow on substation interconnections 18, such as power inflow on interconnection 18-IN, power outflow on interconnection 18-OUT, and so on), voltage magnitude measurements (e.g., voltage phase and/or magnitude at respective locations within the HP topology model of the substation 11-1, including redundant measurements), and so on. Generating the LL SEI data may further comprise calculating pseudo or virtual measurements, such as zero power injections (as needed), and the like. The initializing at 330 may further comprise inputting the LL SEI data generated at 330 (e.g., the power injections, flows, and other HP measurement data, such as voltage magnitude quantities) into a state estimation algorithm and/or LL state estimator 315, as disclosed herein.

Step 340 may comprise generating a substation-level state estimate (e.g., generating an LLSE 115 for the substation 11-1). The LLSE 115 may be generated in accordance with the LLSE procedure 305 implemented by the LLM module 212 and/or LL state estimator 315 as initialized at 330. In some implementations, generating the LLSE 115 may comprise implementing aspects of a GSE algorithm, comprising executing a WLS estimation on a linear regression model, as disclosed herein (e.g., per Eq. 5 through Eq. 9 and/or Eq. 10 through 19 for GSE implementations).

In some implementations, step 340 may further comprise validating the LLSE 115. Validating the LLSE 115 may comprise determining and/or evaluating residuals of the LLSE 115. As disclosed herein, the residuals of a state estimate may be configured to, inter alia, identify errors associated with respective aspects of the state estimate, e.g., respective voltage measurements, CB statues, or the like. For example, in GSE implementations, step 340 may comprise determining Lagrange multipliers λ of the LLSE 115 in accordance with Eq. 19. As disclosed herein, the Lagrange multipliers λ may quantify a degree to which equality constraints (and/or the underlying topology model) conform with the LLM data 113 acquired from the substation 11-1. The Lagrange multipliers λ associated with respective measurements of the LLSE 115 may, therefore, indicate a residual error associated with the respective measurements, e.g., the multiplier λ values may quantify and/or be proportional to residual error.

Validating the LLSE 115 at 340 may comprise implementation of an LLSE validation procedure 331. As disclosed herein, the LLSE validation procedure 331 may comprise a) identifying residuals of the LLSE 115 that exceed an AR threshold, b) determining a root cause of the anomalous residuals, c) modifying the LLM data 113 used to generate the LLSE 115 in accordance with the determined root cause of the anomalous residuals (if possible), and c) recalculating the LLSE 115 using the modified LLM data 113.

Step 340 may further comprise communicating the LLSE 115 determined for the substation 11-1 to the ULM system 120, which may utilize the LLSE 115 to implement an ULM function 122 covering the PS 10-1, as disclosed herein.

In some implementations, the LLM module 212 may be configured to implement an iterative procedure for generating substation-level state estimates (e.g., LLSE 115). The LLM module 212 may, for example, implement an iterative procedure as illustrated in FIG. 3E.

FIG. 3E is a flow diagram illustrating another example of a method 300-1 for monitoring a CPS 10 and, in particular, generating LLSE 115 for respective substations 11-1. As disclosed in further detail herein, the method 300-1 may be configured to iteratively generate and/or refine the LLSE 115 until one or more LLSE termination criteria are satisfied. The LLSE termination criteria may comprise an error metric, such as an AR threshold, a quality metric (e.g., a performance index threshold), an iteration limit, or the like. For example, the LLM module 212 may be configured to iteratively generate and refine the LLSE 115 for the substation 11-1 until residual error(s) of the LLSE 115 satisfy one or more thresholds. The LLSE termination criteria and/or other configuration data pertaining to the LLSE procedure 305 (e.g., AR thresholds, quality thresholds, and/or the like) may be maintained by or within the LLAD module 330 and/or suitable NT storage resources, such as the LLM CFG 301 or the like, as disclosed herein.

Step 310 of the method 300-1 may comprise acquiring LLM data 113 from the substation 11-1, step 320 may comprise constructing a topology of the substation 11-1, and step 335 may comprise formulating state estimate input data (LL SEI data) for execution of an LLSE procedure 305. The LL SEI data may comprise and/or be derived from LLM data 113 acquired at 310 (and/or topology constructed at step 320). Step 340 may comprise generating a substation-level state estimate, e.g., an LLSE 115, as disclosed herein.

Step 342 may comprise evaluating the LLSE 115 generated at 340. The LLSE 115 may be evaluated in in accordance with an LLSE validation procedure 331. The evaluating may comprise determining residuals of the LLSE 115 (and/or respective aspects or measurements of the LLSE 115). The residuals may be determined in accordance with the LLSE procedure 305 and/or LLSE algorithm used to generate the LLSE 115. For example, in GSE implementations, the residuals may comprise and/or be derived from Lagrange multipliers λ associated with respective state quantities. Alternatively, or in addition, the evaluating of step 342 may comprise determining a utility or performance metric (e.g., performance index) of the LLSE 115.

Step 350 may comprise determining whether the LLSE 115 generated at 340 (and evaluated at step 342) satisfies one or more LLSE termination criteria of the LLSE validation procedure 331. As disclosed herein, the LLSE termination criteria may correspond to a quality metric, such as residual error, performance index, or the like. In some implementations, the LLSE termination criteria may comprise one or more residual thresholds, e.g., an AR threshold, quality threshold, and/or the like. Determining whether the LLSE termination criteria is satisfied may, therefore, comprise comparing residuals of the LLSE 115 to threshold(s) of the LLSE validation procedure 331 (and/or LLAD module 330). If the LLSE 115 satisfies the LLSE termination criteria, the flow may continue at step 380; otherwise, the flow may continue at step 360.

Step 360 may comprise analyzing residuals of the of the LLSE 115, e.g., implementing aspects of the LLSE validation LLSE validation procedure 331, as disclosed herein. Step 360 may comprise a) identifying anomalous residuals of the LLSE 115, e.g., residuals that exceed an AR threshold, and b) analyzing the anomalous residuals. Step 360 may comprise a root cause analysis procedure configured to determine the source of the anomaly and/or correct the anomaly. Step 360 may comprise determining whether respective anomalous residuals were caused by measurement anomalies (e.g., bad or invalid HPM data), topology anomalies (e.g., bad or invalid dynamic topology data 313, such as an incorrect CB status), load/generation anomalies (e.g., a change to the power inflow or outflow of the substation 11-1), and/or the like. The analysis of step 360 may further comprise correcting and/or revising the state data from which the LLSE 115 was derived. Step 360 comprise any suitable root cause and/or anomaly analysis technique or algorithm including, but not limited to: BD processing, topology error processing (e.g., topology analysis configured to detect and/or mitigate inclusion error, exclusion error, split error, merging error, and/or the like), pre-filtering plausibility checking, normalized residual testing, BD identification, bad status identification, chi-squared testing, hypothesis testing, constraint analysis, and/or the like. Residual analysis operations involving evaluation and/or recalculation of aspects of the LLSE 115 may be implemented by use of the state estimator 315, as disclosed herein.

In some implementations, step 360 may further comprise flagging and/or recording information pertaining to the identified anomalous residuals of the LLSE 115. In some implementations, the LLAD validation procedure 331 may comprise recording data pertaining to respective identified anomalous residuals within one or more of the LLPS data 114, LLSE 115, and/or LLAD data 315 generated by the LLM module 212. Step 360 may comprise recording any suitable information pertaining to the identified anomalous residuals, including but not limited to: root causes determined for the anomalous residuals, measurement and/or topology data associated with the anomalous residuals, substation components 12-1 associated with the anomalous residuals (e.g., identify substation component(s) 12-1 that provided invalid measurement and/or dynamic topology data 313 to the LLM module 212), modifications made to the LLM data 113 responsive to the anomalous residuals, and/or the like.

Step 370 may comprise refining and/or modifying the state estimation data used to generate the LLSE 115 (e.g., the LLM data 113 acquired at 310 and/or 332). The refining of step 370 may be configured to, inter alia, mitigate the impact of the identified anomalous residuals. The modifications of step 370 may be based, inter alia, on the results of the analysis of step 360, e.g., based on the root cause analysis performed on respective anomalous residuals. Step 370 may comprise any suitable modification to the LLM data 113, including but not limited to: correcting (or excluding) dynamic topology data 313 acquired from the substation 11-1 from the state analysis (e.g., correcting the states of specified CB and/or other components 12-1 of the substation 11-1), correcting (or excluding) HPM data associated with the anomalous residuals (e.g., excluding or correcting PMU phasor measurements, voltage magnitudes, power injections, power flows, and/or the like), and so on. In some implementations, step 370 may further comprise refining the state estimate input data (LL SEI data) and/or recalculating the LL SEI data using the refined LLM data 313 generated at 370.

The refined LLM data 113 (and/or corresponding LL SEI data) may be utilized in a next iteration of the method 300-1. As illustrated in FIG. 3E, in response refining the state estimation data at 370, the flow may continue back at step 440 where the revised data may be used to recalculate the substation-level state estimate (e.g., LLSE 115) at 340. The resulting LLSE 115 may be evaluated at 342 and 350, as disclosed herein. If the recalculated LLSE 115 fails to satisfy the LLSE termination criteria at 350, the flow may continue at 360-370 where anomalous residuals of the LLSE 115 may be analyzed and the LLM data 113 may be further refined, as disclosed herein. If, however, one or more of the LLSE termination criteria are satisfied at 350, the flow may continue at 380.

Step 380 may comprise communicating the substation-level state estimate determined at 310-370 (e.g., the LLSE 115) to an upper level monitoring system (e.g., the ULM system 120). Step 380 may comprise communicating LLPS data 114 comprising the LLSE 115 (and optional LLAD data 215) to the ULM system 120. The ULM system 120 may utilize the LLSE 115 to implement an ULM function 122 configured to cover the PS 10-1, as disclosed herein. In some implementations, step 380 may comprise recording information pertaining to anomalies detected within the LLSE 115, as disclosed herein. For example, step 380 may comprise analyzing residuals of the LLSE 115 and/or recording information pertaining to the residuals as in step 360. In some implementations, step 380 may comprise analyzing residuals that satisfy a threshold lower than the AR threshold.

In some implementations, step 380 may comprise returning the LLSE 115 generated in the most recent iteration of the method 300-1. Alternatively, or in addition, step 380 may comprise selecting an “optimal” LLSE 115 from a plurality of LLSE 115 generated during respective iterations of the method 300-1. As disclosed herein, the method 300-1 may comprise generating substation-level state data over a one or more iterations, each iteration resulting in a generation of a respective LLSE 115 (and/or respective LLM data 113). For example, implementation of method 300-1 over k iterations may comprise generating k LLSE 115, e.g., LLSE 115-1 through 115-k. In the foregoing example, step 380 may comprise selecting an “optimal” LLSE 115 from the k LLSE 115-1 through 115-k. The “optimal” LLSE 115 may be identified according to predetermined optimization criterion, e.g., lowest residuals, highest performance index, or the like.

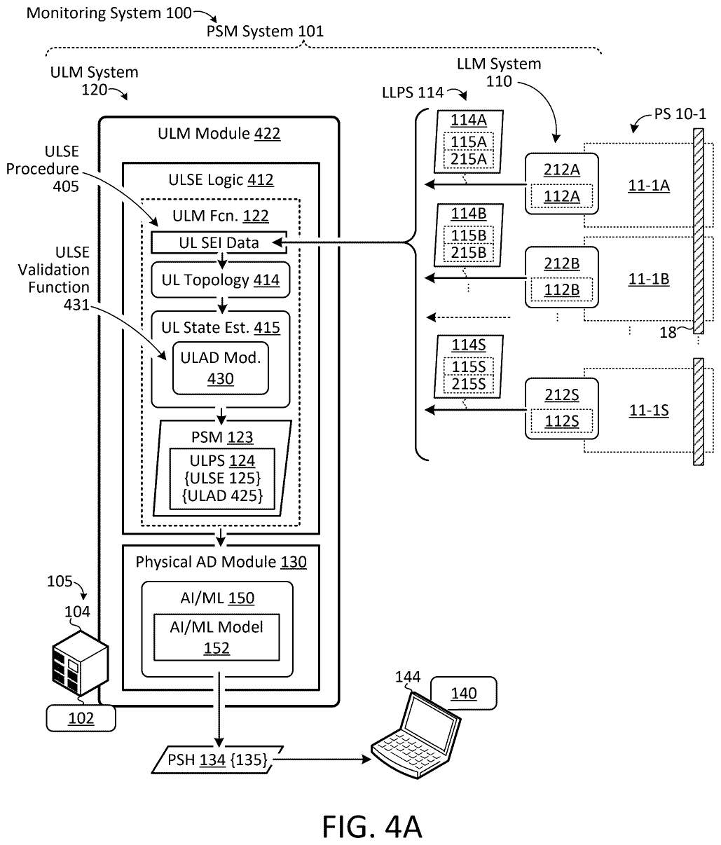

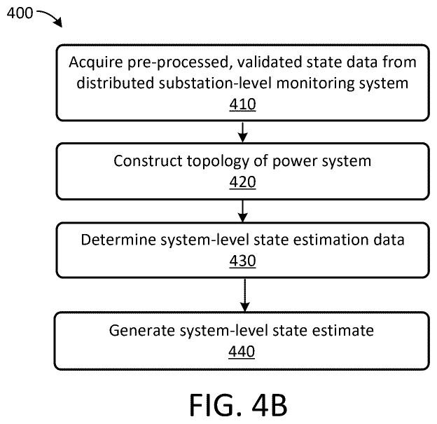

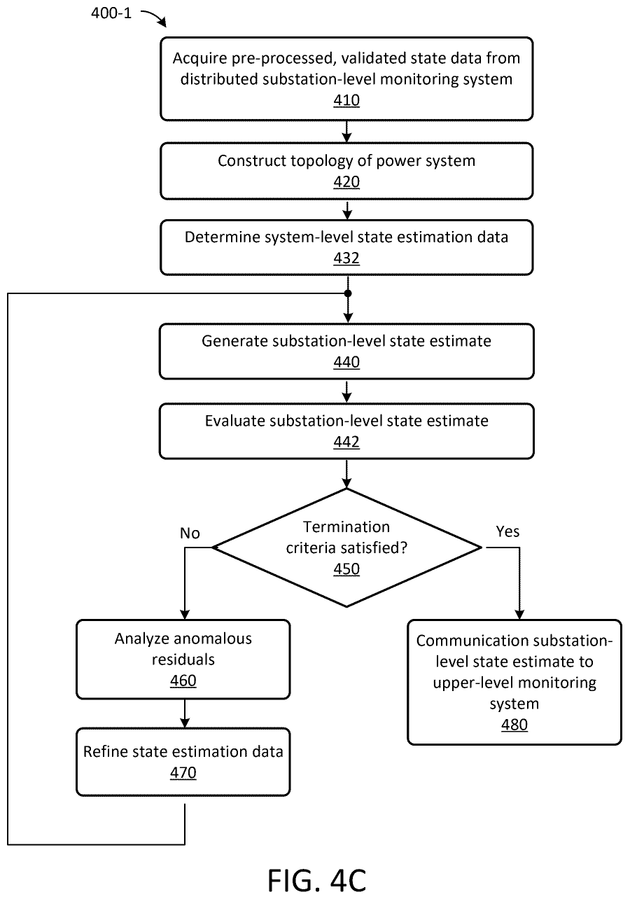

FIG. 4A is a schematic block diagram illustrating another example of a multi-tier, distributed PSM system 101. As illustrated in FIG. 4A, the LLM system 110 may be configured to distribute computation of LLPS data 114 (and corresponding LLSE 115) for respective substations 11-1 across a plurality of LLM modules 212. The LLM system 110 may be further configured to communicate the LLPS data 114 determined for respective substations 11-1 to the UML system 120. The LLPS data 114 may comprise validated LLM data 113 indicating the current physical state of substations 11-1A through 11-1S, respectively. As disclosed herein, the LLSE 115 of the LLPS data 114 may comprise detailed HP topology models indicating the status of respective substation components 12-1. The HP topology models may support inclusion of redundant measurement data, which may improve the efficacy of the LLAD procedures 307 implemented by the respective LLM modules 212, resulting in improved robustness and data accuracy. The LLPS data 114 may further comprise information pertaining to residuals identified within the LLSE 115, which may be used to assess the physical health of the PS 10-1, as disclosed in further detail herein.

The UML system 120 may comprise a UML module 422, which may be configured to implement aspects of a UML function 122. The UML function 122 may comprise, inter alia, determining a ULSE 125 configured to characterize the physical state of the PS 10-1 as a whole, e.g., cover substations 11-1A through 11-1S, substation interconnections 18, and so on.

The UML module 422 may comprise and/or be coupled to ULSE logic 412. The ULSE logic 412 may be configured to generate ULSE 125 by use of LLSE 115 determined for respective substations 11-1. The UML module 422 may be configured to generate the ULSE 125 in accordance with a ULSE procedure 405. The ULSE procedure 405 may comprise any suitable state estimation algorithm or technique, e.g., static state estimation, rule-based state estimation, GSE, and/or the like. In the FIG. 4A example, the ULSE procedure 405 may comprise GSE with WLS estimation on a linear regression model, as disclosed herein.

The ULSE logic 412 may comprise and/or embody an UL topology processor 414 and a UL state estimator 415. The UL topology processor 414 may be configured to derive a UL topology from, inter alia, the validated LLM data 113 of the LLSE 114A-114S, e.g., HP topology models determined for respective substations 11-1, dynamic topology data 312-2 acquired from respective substations 11-1, and so on. The UL topology processor 414 may be configured to model the topology of the PS 10-1 (e.g., substations 11-1A through 11-1S, substation interconnections 18, and so on). Accordingly, constructing UL topology may be more computationally complex and involve a larger amount of physical state data than the LL topology models constructed for respective substations 11-1. Therefore, in some implementations, the UL topology processor 414 may be configured to construct a UL topology comprising a less detailed LR topology model (e.g., a bus-branch network model as illustrated in FIG. 3B rather than the more detailed HP topology models constructed at the substation level).

The UL state estimator 415 may be configured to derive a ULSE 125 from pre-processed LLPS data 114A-114S generated by the distributed LLM system 110. As disclosed herein, LLSE 115 of the LLPS data 114 may comprise validated, refined, pre-processed physical state data (e.g., validated virtual or pseudo physical state data). For example, the physical state data pertaining to respective substations 11-1 (e.g., respective LLSE 115) may be validated and/or refined through LLAD procedures 307 implemented by LLM modules 212 of the respective substations 11-1. As disclosed herein, the LLSE validation function 311 may comprise identifying and mitigating the impact of anomalous residuals, e.g., correcting error caused by anomalous measurement and/or topology data. Accordingly, the ULSE 125 may be generated using refined physical state data rather than raw, unvalidated data, which may improve performance and computational efficiency.

As disclosed herein, the ULM module 422 may be configured to generate ULSE 125 in accordance with any suitable ULSE procedure 405, e.g., any suitable state estimation algorithm and/or technique. In the FIG. 4A example, the UML module 422 may be configured to generate ULSE 125 in accordance with a GSE algorithm comprising WLS estimation on a linear regression model, as disclosed herein. In some implementations, the UL state estimator 415 may comprise and/or be coupled to a UL anomaly detection (ULAD) module 430. As disclosed in further detail herein, the ULAD module 430 may be configured to implement aspects of ULSE validation function 431 configured to, inter alia, validate ULSE 125 generated by the ULM module 422. The ULAD validation function 431 may comprise any suitable means for validating and/or refining physical state data including, but not limited to: bad data (BD) processing, topology error processing, and/or the like.

In some implementations, the ULM module 422 may be configured to determine the system-level state estimates (ULSE 125) per method 400 illustrated in FIG. 4B. Step 410 may comprise acquiring pre-processed, validated state data from a plurality of distributed substation-level modules (e.g., LLM modules 212). Step 410 may comprise receiving LLPS data 114A-114S generated by LLM modules 212A-212S coupled to substations 11-1A through 11-1S, respectively. The LLPS data 114A-114S may comprise LLSE 115A-115S configured to model the physical state of respective substations 11-1A through 11-1S. The physical state data of the LLSE 115A-115S may be pre-processed and/or validated by respective LLM modules 212A-212S, as disclosed herein.

The pre-processed, validated state data acquired at step 410 may comprise detailed, HP topology models (e.g., node-breaker topology models) constructed according to pre-processed, validated dynamic topology data 313. Measurements allocated to the HP topology models may be pre-processed and/or validated during generation of the respective LLSE 115, e.g., through implementation of respective LLSE procedures 305 and/or corresponding LLAD procedures 307, as disclosed herein.

In some implementations, step 410 may comprise interrogating the LLM system 110 (e.g., pulling and/or requesting LLPS data 114 from respective LLM modules 212). Alternatively, or in addition, step 410 may comprise receiving LLPS data 114 pushed to the ULM system 120 by respective LLM modules 212.

Step 420 may comprise constructing a UL topology configured to model the PS 10-1. The UL topology may comprise an LR topology model, such as a bus-branch network model covering substations 11-1A through 11-1S, substation interconnections 18 (e.g., lines coupling respective substations 11-1), and so on. In some implementations, the UL topology may comprise a bus admittance matrix representation (Y_{bus}) of the PS 10-1, e.g., a Y_{bus} matrix representation as illustrated in Eq. 3 and Eq. 10.

Step 430 may comprise determining system-level state estimation data (e.g., UL SEI data). Step 430 may comprise generating UL SEI data suitable for the ULSE algorithm and/or ULSE procedure 405 implemented by the UL state estimator 415. Step 430 may comprise combining the LLPS data 114A-114S (LLSE 115A-115S) acquired from the distributed LLM modules 212 of the LLM system 110 at 410. Step 430 may further comprise deriving power injections at respective substations 11-1, power flows between substations 11-1, and so on.

Step 440 may comprise generating the ULSE 125 for the PS 10-1 utilizing the UL state estimation data collected at step 430. The ULSE 125 may be generated in accordance with the ULSE procedure 405 implemented by the ULM module 422. In the FIG. 4B example, the ULSE 125 may be generated through implementation of an iterative GSE algorithm with WLS estimation on a linear regression model, as disclosed herein.

In some implementations, step 440 may comprise validating the ULSE 125. Step 440 may comprise determining residuals of the ULSE 125 (e.g., Lagrange multipliers A), evaluating the residuals, and/or implementing an ULAD validation function 431. ULAD validation function 431 may be implemented in accordance with the ULSE algorithm and/or ULSE procedure 405 implemented by the UL state estimator 415. Aspects of the ULAD validation function 431 may be implemented by the ULAD module 430. ULAD validation function 431 may comprise a) identifying residuals of the ULSE 125 that exceed a UL anomalous residual (UL AR) threshold, b) analyzing the identified anomalous residuals, c) modifying the UL SEI data used to generate the ULSE 125 to mitigate the identified residuals (if possible), and d) recalculating the ULSE 125 using the modified UL SEI data. The root cause of respective anomalous residuals may be determined using any suitable anomaly and/or residual analysis means including, but not limited to root cause analysis, BD processing, topology error processing, and/or the like.

In some implementations, the ULM module 422 may be configured to implement an iterative procedure for generating system-level state estimates (e.g., ULSE 125). The ULM module 422 may, for example, implement an iterative procedure as illustrated in FIG. 4C.

FIG. 4C is a flow diagram illustrating another example of a method 400-1 for monitoring a CPS 10 and, in particular, generating ULSE 125 configured to characterize the physical state of a PS 10-1 comprising a plurality of substations 11-1. As disclosed in further detail herein, the method 400-1 may be configured to iteratively generate and/or refine the ULSE 115 in accordance with a ULAD procedure 407, e.g., until a termination criterion of the ULAD procedure 407 is satisfied. The termination criterion may comprise a quality metric, such as the ULAR threshold, a quality threshold lower than the AR threshold, a performance index threshold, an iteration limit, or the like. For example, the ULAD procedure 407 may be configured to iteratively generate and refine the ULSE 125 until residual error(s) thereof satisfy the termination criteria. The termination criteria and/or other configuration data pertaining to the ULAD procedure 307 such as ULAR thresholds, quality thresholds, and/or the like may be maintained by or within the ULAD module 417 and/or suitable NT storage resources, such as NT storage resources 102-2 of the AD device 105.

Step 410 of the method 40 may comprise acquiring pre-processed, validated data (LLPS data 114) from a distributed substation-level system (e.g., distributed LLM modules 212), step 420 may comprise constructing a topology of the PS 10-1, step 432 may comprise determining system-level state estimation data (e.g., deriving UL state estimation data from the pre-processed, validated state data acquired at 410), and step 440 may comprise generating a system-level state estimate covering the PS 10-1, e.g., a ULSE 125, as disclosed herein.

Step 442 may comprise evaluating the ULSE 125 generated at 440. The evaluating may comprise determining and/or evaluating residuals of the ULSE 125 (and/or respective aspects or measurements of the ULSE 125). The residuals may be determined in accordance with the ULSE procedure 405 and/or ULSE algorithm used to generate the ULSE 125. For example, in GSE implementations, the residuals may comprise and/or be derived from Lagrange multipliers A, as disclosed herein. Alternatively, or in addition, the evaluating of step 442 may comprise determining a utility or performance metric (e.g., performance index) of the ULSE 125.

Step 450 may comprise determining whether the ULSE 125 generated at 440 (and evaluated at 442) satisfies one or more ULSE termination criteria. As disclosed herein, the ULSE termination criteria may correspond to a quality metric, such as residual error, performance index, or the like. In some implementations, the ULSE termination criteria may comprise one or more residual thresholds, e.g., an ULAR threshold, quality threshold, and/or the like. Determining whether the ULSE termination criteria is satisfied may, therefore, comprise comparing residuals of the ULSE 125 to one or more threshold(s). If the ULSE 125 satisfies the termination criteria, the flow may continue at step 480; otherwise, the flow may continue at step 460.

Step 460 may comprise processing anomalous residuals of the ULSE 125. As disclosed herein, the processing may comprise a) identifying anomalous residuals of the ULSE 125, e.g., residuals that exceed an UL AR threshold, b) analyzing the identified residuals. Analyzing an anomalous residual of the ULSE 125 may comprise a) a root cause analysis configured to determine the source or root cause of the anomalous residual, and b) processing the anomalous residual in accordance with the determined root cause. The ULAP procedure may comprise and/or implement any suitable root cause and/or anomaly analysis technique or algorithm including, but not limited to: BD processing, topology error processing (e.g., topology analysis configured to detect and/or mitigate inclusion error, exclusion error, split error, merging error, and/or the like), pre-filtering plausibility checking, normalized residual testing, BD identification, bad status identification, chi-squared testing, hypothesis testing, constraint analysis, and/or the like.

In some implementations, step 460 may further comprise flagging and/or recording information pertaining to the identified anomalous residuals of the ULSE 125. Step 460 may comprise recording data pertaining to respective identified anomalous residuals within one or more of the PSM data 123, ULPS data 124, ULSE 125, and/or ULAD data 425. Step 460 may comprise recording any suitable information pertaining to respective residuals, including but not limited to: determined root causes, measurement and/or topology data associated with the anomalous residuals, substation components 12-1 associated with the anomalous residuals, modifications made to the UL state estimation data responsive to the anomalous residuals, and/or the like.

Step 470 may comprise refining and/or modifying the UL state estimation data in accordance with the analysis of step 460. Step 460 may comprise excluding (flagging) invalid UL SEI data. Alternatively, or in addition, step 460 may comprise modifying aspects of the UL SEI data to correct errors associated with the anomalous residuals analyzed at 460.

The refined UL state estimation data may be utilized in a next iteration of the method 400-1. As illustrated in FIG. 4C, in response to refining the UL state estimation data, the flow may continue at step 440 where a ULSE 125 for the PS 10-1 may be recalculated. The resulting ULSE 125 may be evaluated at 442 and 450, as disclosed herein. If the recalculated ULSE 125 fails to satisfy the ULSE termination criteria at 450, the flow may continue at 460-470 where anomalous residuals of the ULSE 125 may be analyzed and the UL state estimation data may be further refined, as disclosed herein. If, however, one or more of the ULSE termination criteria are satisfied at 450, the flow may continue at 480.

Step 480 may comprise providing the ULSE 125 to the physical AD module for assessment of the physical health of the PS 10-1, as disclosed in further detail herein. In some embodiments, step 480 may further comprise analyzing residuals and/or other error detected within the ULSE 125 as disclosed herein (e.g., as in step 460). In some implementations, step 480 may comprise selecting an “optimal” ULSE 125 from a group of i ULSE 125 generated during implementation of i iterations of the method 400-1. The “optimal” ULSE 125 may be selected from ULSE 125-1 through 125-i based on predetermined optimization criteria, such as a residual criterion (e.g., selection of ULSE 125 having lowest residual error), performance index, and/or the like.

The physical AD module 130 may receive the PSM data 123 and, in response, configure the AI/ML module 150 to generate health data 134 for the CPS 10, the health data 134 comprising one or more PSH label(s) 135. The physical AD module may be configured to instantiate and/or configure the AI/ML module 150 in accordance with the AI/ML CFG 151. Alternatively, or in addition, the AD CFG 151 may be incorporated into aspects of the hardware and/or software implementation of the AI/ML module 150 and/or AI/ML model 152, as disclosed herein. The physical AD module may couple the PSM data 123 to the AI/ML module 150. For example, the physical AD module may provide PSM data 123 to an input layer of an ANN of the AI/ML model 152. In some implementations, the physical AD module and/or AI/ML module 150 may be configured to extract AI/ML features from the PSM data 123. As disclosed herein, the AI/ML features may comprise aspects of the PSM data 123 determined (or learned) to distinguish anomalous physical states of the PS 10-1 from other, nominal physical states. The AI/ML features may comprise aspects of the ULSE 125 determined for the PS 10-1, ULAD data 425 flagged during generation of the ULSE 125, LLPS data 114 used to derive the ULSE 125, e.g., aspects of the LLSE 115 determined for one or more substations 11-1, LLAD data 215 flagged during generation of the LLSE 115, and/or the like.

Referring back to FIG. 4A, the physical AD module may utilize the PSM data 123 generated by the ULM module 422 to evaluate the physical health of the PS 10-1. The PSM data 123 may comprise ULPS data 124 configured to characterize the physical state of the PS 10-1. The PSM data 123 may, for example, comprise the ULSE 125 determined for the PS 10-1, as disclosed herein. The PSM data 123 may further comprise information pertaining to anomalies identified during generation of the ULSE 125 (e.g., ULAD data 425). The PSM data 123 may further comprise data used to derive the ULSE 125. The PSM data 123 may comprise aspects of the LLPS data 114 generated by the distributed LLM system 110, such as the pre-processed, validated state data used to generate the ULSE 125, LLSE 115 determined for respective substations 11-1 of the PS 10-1, LLAD data 215 pertaining to anomalies identified while generating the LLSE 115, and so on.

The physical AD module may receive the PSM data 123 and, in response, configure the AI/ML module 150 to generate health data 134 for the CPS 10, the health data 134 comprising one or more PSH label(s) 135. The physical AD module may be configured to instantiate and/or configure the AI/ML module 150 in accordance with a machine-learned AI/ML CFG 151. The AI/ML CFG 151 may be learned through any suitable AI/ML technique, including supervised AI/ML techniques, unsupervised AI/ML techniques, semi-supervised AI/ML techniques, and/or the like. In sone implementations, aspects of the AD CFG 151 may be incorporated into hardware and/or software configured to implement the AI/ML module 150 and/or AI/ML model 152, as disclosed herein.

The physical AD module may be configured to couple the PSM data 123 generated by the ULM module 422 to the AI/ML module 150. For example, the physical AD module may provide PSM data 123 to an input layer of an ANN of the AI/ML model 152. In some implementations, the physical AD module and/or AI/ML module 150 may be configured to extract AI/ML features from the PSM data 123. As disclosed herein, the AI/ML features may comprise aspects of the PSM data 123 determined (or learned) to distinguish anomalous physical states of the PS 10-1 from other, nominal physical states. The AI/ML features may comprise and/or be derived from any suitable aspect of the PSM data 123, including, but not limited to: the ULSE 125 determined for the PS 10-1 (e.g., the UL topology determined for the PS 10-1, measurements applied to the UL topology, power injections and/or flows at respective topology nodes, and/or the like), residuals of the ULSE 125, ULAD data 425 comprising information pertaining to anomalies identified during generation of the ULSE 125, aspects of the LLPS data 114 acquired by the distributed, multi-tier LLM system 110 (e.g., pre-processed, validate state estimation data used to generate the ULSE 125), one or more LLSE 115 determined for respective substations 11-1 of the PS 10-1, residuals of the one or more LLSE 115, LLAD data 215 comprising information pertaining to anomalies identified during generation of respective LLSE 115, and/or the like.

As disclosed herein, the AI/ML model 152 may be configured to generate PSH data 134 in response to the PSM data 123 (and/or AI/ML features extracted therefrom). The PSH data 134 may be configured to characterize the physical health of the PS 10-1. For example, the PSH data 134 may comprise a health metric configured to indicate a degree to which the ULSE 125 of the PS 10-1 corresponds to an anomalous physical state, e.g., may comprise a value between 0 and 1, wherein 0 represents nominal physical states and 1 represents anomalous physical states. Alternatively, or in addition, the PSH data 134 may comprise a PSH label 135 configured to classify the physical state of the PS 10-1, e.g., classify the physical state of the PS 10-1 as indicated by the PSM data 123 as nominal, anomalous, or the like.

In some implementations, the AI/ML model 152 may be further configured to generate PSH data 134 configured to identify the source and/or root cause of anomalous physical states. For example, the AI/ML model 152 may be configured to identify components 12 of the PS 10-1 associated with classification of the physical state of the PS 10-1 as anomalous.

The PSH data 134 generated by the physical AD module may be communicated to a mitigation module 140 of the CPS 10. The mitigation module 140 may be configured to implement one or more mitigation actions in response to the PSH data 134. The mitigation actions may, for example, comprise alerting an operator of the PS 10-1 of detection of an anomalous physical state by use of HMI resources 102-4 of the monitoring system 100.

Although particular examples of AI/ML techniques for physical anomaly detection are described herein, the disclosure is not limited in this regard and could be adapted to detect physical anomalies using any suitable approach.

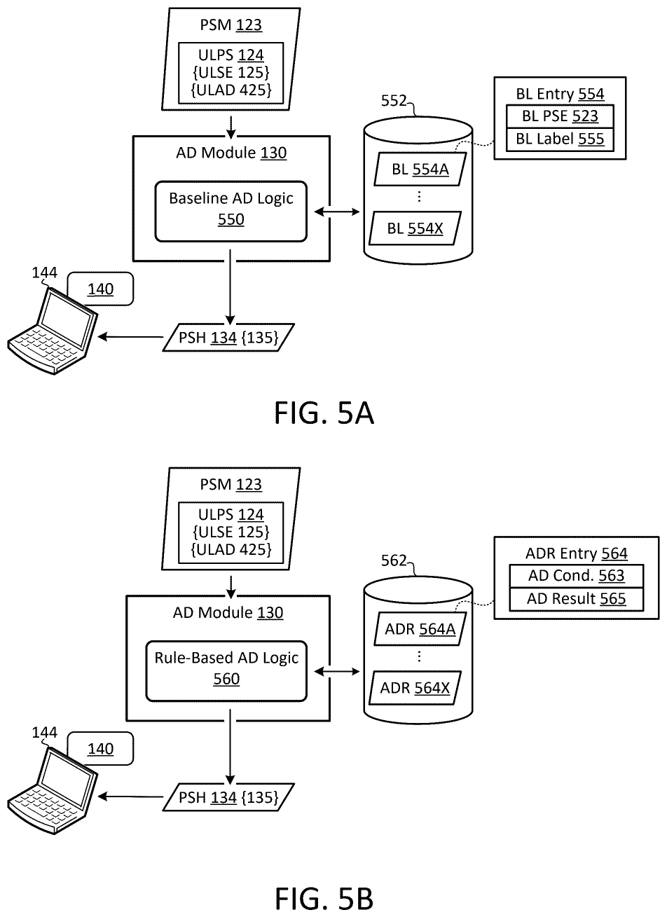

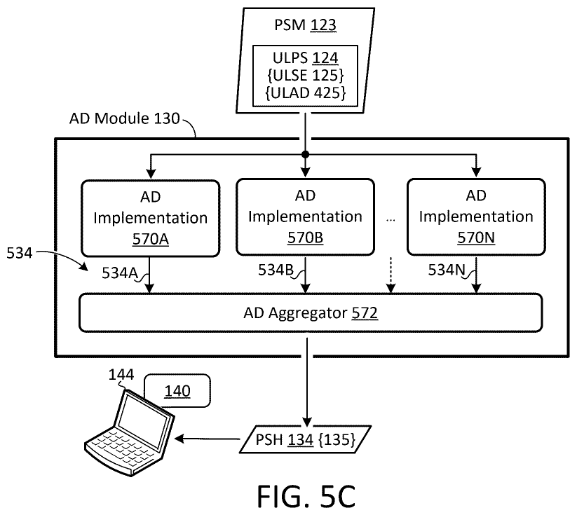

By way of non-limiting example, in some implementations, the physical AD module may be configured to implement aspects of a baseline anomaly detection procedure, as illustrated in FIG. 5A.

FIG. 5A is a schematic block diagram illustrating an example of an physical AD module configured to generate PSH data 134 configured to characterize the physical state of a CPS 10 (e.g., PS 10-1) in response to PSM data 123. The PSM data 123 may comprise a ULSE 125 and one or more LLSE 115 determined by a distributed, multi-tier PSM system 101, as disclosed herein. The physical AD module may comprise baseline (BL) AD logic 550. The BL AD logic 550 may comprise a baseline AD implementation. More specifically, the BL AD logic 550 may be configured to compare PSM data 123 determined for the CPS 10-1 to baseline (BL) entries 554 maintained within a datastore 552. The datastore 552 may comprise any suitable NT storage resource, such as NT storage resources 102-3 of the AD device 105 or the like.

Respective BL entries 554 may comprise baseline PSE (BL PSE) data 523 characteristic of a specified physical state and/or behavior of the CPS 10 and a corresponding baseline (BL) label 555 identifying the physical state. The BL PSE data 523 may be derived from a plurality of PSE data 123, e.g., PSE data 123 corresponding to the specified physical state acquired at different times, under different operating conditions, and/or the like. For example, the BL entry 554A may comprise BL PSE 523 comprising and/or derived from PSE data 123 corresponding to nominal physical behavior of the CPS 10. The BL PSE 523 of the BL entry 554A may comprise and/or be derived from PSE data 123 acquired during nominal operation of the CPS 10 under a range of different operating conditions, e.g., different load conditions, times of day, seasons, and/or the like. The BL label 555 of the BL entry 554A may specify that the BL PSE 523 is configured to characterize a nominal physical state of the CPS 10 (and/or identify the operation conditions associated with the BL PSE 523). By contrast, the BL entry 554X may be configured to characterize an anomalous physical state, such as failure or compromise of one or more components 12 of the CPS 10. The BL label 555 of the BL entry 554X may identify the anomalous physical state characterized thereby (e.g., identify the physical state as anomalous and/or identify the root cause of the anomalous behavior). The BL PSE 523 of the BLD entry 554X may comprise and/or be derived from PSM data 123 corresponding to the specified anomalous physical state (e.g., PSM data 123 acquired during operation of the CPS 10 during failure and/or compromise of the one or more components 12).

In some implementations, BL PSE data 523 of respective BL entries 554 may comprise and/or be derived from actual, observed PSE data 123 corresponding to known physical states and/or behaviors of the CPS 10. For example, BL entries 554 configured to represent respective nominal physical states may comprise BL PSE data 523 derived from historical PSE data 123 known to correspond to the respective nominal physical states. Conversely, BL entries 554 configured to represent respective types of anomalous physical states may comprise BL PSE data 523 derived from historical PSE data 123 known to correspond to operation of the CPS 10 under the respective types of anomalous physical states. Alternatively, or in addition, aspects of the BL PSE data 523 of one or more of the BL entries 554 may comprise and/or be derived from synthetic PSE data 123, e.g., PSE data 123 generated through simulation of the CPS 10 in specified physical states (e.g., nominal physical states, nominal physical states corresponding to high load conditions, anomalous physical states, anomalous physical states corresponding to attack and/or compromise of one or more CPS components 12, and/or the like). In other examples, synthetic PSE data 123 may be generated by injecting noise and/or invalid data indicative of anomalous operation into acquired PSE data 123. For example, BL PSE data 523 configured to represent an anomalous physical state corresponding to compromise of a particular MC component 16 may be generated by simulating the response of the CPS 10 to actual PSE data 123 modified to simulate compromise of the particular MC component 16. Although particular examples of techniques for generating BL PSE data 523 for respective BL entries 554 are described herein, the disclosure is not limited in this regard and could be adapted to utilize any suitable technique for characterizing respective baseline physical states and/or behaviors.

The evaluation logic 550 of the physical AD module may be configured to generate PSH data 134 in response to PSM data 123 generated by the distributed, multi-tier PSM system 101, disclosed herein. The PSH data 134 may be based on a distance determined between the PSM data 123 and BL PSM data 523 of respective BL entries 554 (a state distance). The state distances between the PSM data 523 and the respective BL entries 554 may indicate a degree to which the physical state of the CPS 10 (as indicated by the PSM data 123) is corresponds to the physical states characterized by the respective BL entries 554, e.g., per the BL labels 555 thereof. The estimation logic 550 may determine the state distances using any suitable technique or algorithm, including but not limited to: cumulative error, root mean square (RMS) error, distance between state estimates (e.g., a distance and/or residual between the ULSE 125 of the PSE data 123 and ULSE 125 of the BL PSE data 523, distances and/or residuals between respective LLSE 115 of the PSE data 123 and corresponding LLSE 115 of the BL PSE 523, and so on), and/or the like.

The evaluation logic 550 may be further configured to assign PSH data 134 to the CPS 10 in accordance with the state distances determined between the PSM data 123 and respective BL entries 554. In some implementations, the evaluation logic 550 may generate PSH data 134 corresponding to the BL label 555 of the BL entry 554 closest to the PSM data 123 (e.g., BL PSE data 523 having a lowest state distance to the PSM data 123). Alternatively, or in addition, the PSH data 134 may be based on a combination of BL labels 555 of the K nearest BL entries 554 to the PSM 123. The PSH data 134 may, for example, comprise a weighted combination of BL labels 555 of the K nearest BL entries 554, wherein weights assigned to respective BL labels 555 are inversely proportional to the state distances associated with the respective BL labels 555. The PSH data 134 may be communicated to a mitigation module 140 of the CPS 10, which may be configured to implement one or more mitigation actions in response to the PSH data 134. The mitigation actions may comprise alerting an operator of the CPS 10 of detection of an anomalous state by use of HMI resources 102-4 of the monitoring system 100.

FIG. 5B is a schematic block diagram illustrating an example of a rule-based physical AD module. In the FIG. 5B example, the physical AD module may comprise and/or be coupled to rule-based anomaly detection (AD) logic 560. The rule-based AD logic 560 comprise a rule-based AD implementation. More specifically, the rule-based AD logic 560 may be configured to generate PSH data 134 in response to PSH data 123 generated by the distributed, multi-tier PSM data 101 disclosed herein.

The rule-based AD logic 560 may comprise and/or be coupled to one or more anomaly detection rule (ADR) entries 564 configured to define respective anomaly detection rules, e.g., define conditions to trigger detection of an anomaly by the physical AD module. In the FIG. 5B example, the ADR entries 563 may be maintained in a datastore 562. The disclosure is not limited in this regard, however, and could be configured to specify and/or store ADR entries 564 within any suitable computer-readable format and/or storage medium.

The ADR entries 564 may define AD rules configured to, inter alia, trigger detection of specified physical anomalies. In the FIG. 5B example, the ADR entries 564 may comprise AD conditions 563 and corresponding AD results 565. The AD condition 563 of an ADR entry 564 may specify any suitable condition pertaining to the PSE data 123 determined for the CPS 10 and the AD result 565 may specify an anomaly detection action to implement in response to PSE data 123 determined to satisfy the AD condition 563. The AD result 565 may comprise any suitable action pertaining to the PSH data 134 generated by the physical AD module including, but not limited to: triggering detection of a physical anomaly, trigger detection of a specified type of physical anomaly, incrementally a modifying a PSH metric and/or PSH label 135 of the PSH data 134 (e.g., modifying the PSH data 134 to indicate that the PSM data 123 is incrementally more likely to be indicative of either nominal physical behavior or anomalous physical behavior), and/or the like.

As disclosed herein, the ADR entries 563 may define AD conditions pertaining to any suitable aspect of the PSM data 123. By way of non-limiting example, one or more of the ADR entries 564 may be configured to define acceptable ranges for specified measurements of the ULSE 125 (and/or LLSE 115 of a specified substation 11-1), such as acceptable ranges for voltage magnitudes at specified locations (e.g., nodes) within the PS 10-1, acceptable ranges for specified power injection and/or power flow quantities, and/or the like. The corresponding AD actions 563 may be configured to trigger anomaly detection in response to PSM data 123 (e.g., ULSE 124 and/or LLSE 115) comprising measurements determined to fall outside of the defined acceptable ranges.

By way of further non-limiting example, the ADR entries 564 comprise AD conditions configured to trigger anomaly detection based on metadata associated with the ULSE 125 and/or LLSE 115. For example, an ADR entry 564 may be configured to trigger detection of a physical state anomaly in response to PSE data 123 comprising a ULSE 125 and/or LLSE 115 having residuals that exceed a specified threshold. In other example, an ADR entry 564 may be configured to trigger anomaly detection based on anomaly detection information associated with the ULSE 125 and/or LLSE 115. For example, an ADR entry 564 may be configured to trigger detection of a physical anomaly pertaining to a specified component 12 of the PS 10-1 in response to PSE data 123 comprising ULAD data 525 (and/or LLAD data 215) indicating that the specified component 12 has generated invalid measurement data for a threshold time period (e.g., for N sample periods of the PSE data 123). The specified component 12 may be identified in the ULAD procedure 507 used to validate the ULSE 125 and/or LLAD procedure 307 used to validate respective LLSE 115, as disclosed herein.

Although particular examples of anomaly detection rules (e.g., AD conditions 563 and AD results 565) are described herein, the disclosure is not limited in this regard and could be adapted to implement any suitable type of anomaly detection rule and/or condition pertaining to any suitable aspect of the PSM data 123 determined by the distributed, multi-tier PSM system 101 disclosed herein.

FIG. 5C is a schematic block diagram of another example of an physical AD module. As disclosed herein, the physical AD module of the PSM system 101 may be configured to detect physical anomaly conditions and/or generate corresponding PSH data 134 in response to PSM data 123 (e.g., ULSE 125 configured to characterize the physical state of the PS 10-1 and/or LLSE 115 configured to characterize the physical state of respective substations 11-1). The physical AD module may detect physical anomalies and/or evaluate the physical health of the PS 10-1 in accordance with any suitable technique or methodology, including but not limited to: an AI/ML implementation, baseline AD detection, rule-based AD detection, and/or the like.

In the FIG. 5C example, the physical AD module may comprise a plurality of AD implementations 570, e.g., N AD implementations 570. The AD implementations 570A-570N may be configured to detect physical anomaly conditions in response to PSM data 123 generated by the distributed, multi-level PSM system 101 disclosed herein. In the FIG. 5C example, the AD implementation 570A may comprise an AI/ML module 150 comprising a trained AI/ML model 152 (e.g., may comprise an AI/ML AD implementation), the AD implementation 570B may comprise baseline AD logic 550 (e.g., may comprise a baseline AD implementation), the AD implementation 570N may comprise rule-based AD logic 560 (e.g., may comprise a rule-based AD implementation), and so on. The AD implementations 570A-N may be configured to assess the physical health of the PS 10-1 based on PSM data 123 acquired from the PS 10-1 by the distributed, multi-tier PSM system 101 disclosed herein. The AD implementations 570A-N may generate respective intermediate PSH data 534 in response to PSM data 123.

The physical AD module of the FIG. 5C example may further comprise an AD aggregator 572 which may be configured to derive PSH data 134 (and/or a PSH label 135) characterizing the physical state of the PS 10-1 from the intermediate PSH data 534 produced by the AD implementations 570A-570N. The AD aggregator 572 may be configured to combine the intermediate PSH data 534 by any suitable technique or methodology. In some implementations, the AD aggregator 572 may comprise OR logic configured to include anomaly detection information produced by respective AD implementations 570A-570N. Alternatively, or in addition, the AD aggregator 572 may be configured implement additive logic, e.g., add contributions to the likelihood that the PSM data 123 is indicative of a physical anomaly determined by respective AD implementations 570A-570N. In another non-limiting example, the AD aggregator 572 may be configured to average the intermediate PSH data 534A-534N. The PSH data 134 (and/or PSH label 135) determined for the PS 10-1 may be communicated within the CPS 10, e.g., may be communicated to a mitigation module 140, as disclosed herein.

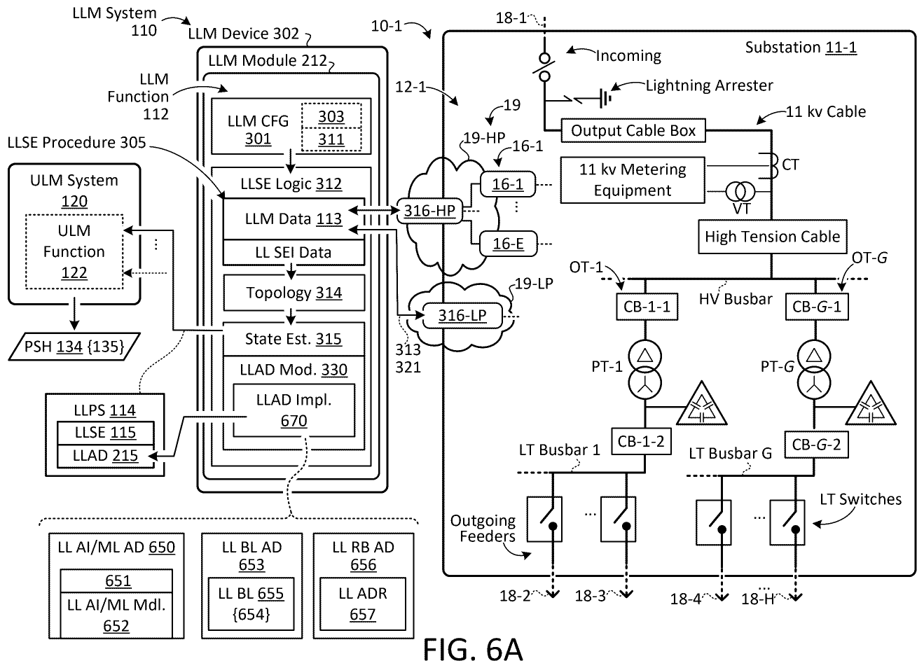

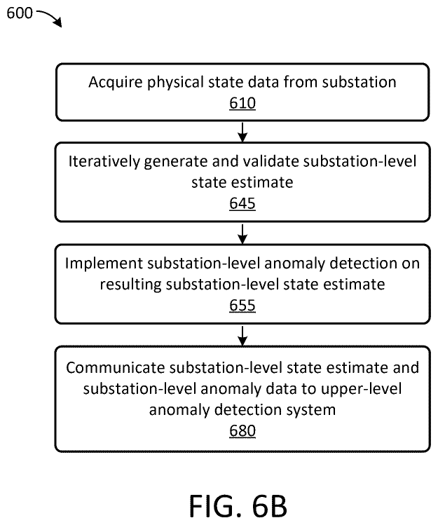

In some implementations, the distributed, multi-tiered PSM system 101 may be further configured to distribute aspects of the AD function 132. For example, the PSM system 101 may configure distributed LLM modules 113 to detect physical anomalies pertaining to respective substations 11-1. FIG. 6A is a schematic block diagram illustrating another example of an LLM module 212 of the LLM system 110 disclosed herein.

The LLM module 212 may be configured to monitor a substation 11-1, e.g., implement an LLM function 112 to, inter alia, generate LLSE 115 configured to characterize the physical state of the substation 11-1, as disclosed herein.

The substation 11-1 of the FIG. 6A example may comprise a distribution substation 11-1 depicted as a single line diagram in FIG. 6A. The substation 11-1 may comprise an incoming or power feeder connection 18-1 (via EHV or HV transmission lines, such as an 11 kilovolt (kv) lines), outgoing circuits (e.g., OT-1 through OT-G coupled to interconnections 18-2 through 18-H) comprising distribution or power transformers (PT) coupled a MV or low-tension (LT) busbar (e.g., LT busbar-1 through LT busbar-G) with outgoing feeder(s) coupled to other substations or switchgear through respective low-terminal switches, and so on. Lightning or surge arrester(s) may be connected phase to ground at the incoming line and/or at the terminals of respective PT and/or other components 12, such as a capacitor back, shunt reactor, generator, motor, and/or the like (not shown in FIG. 6A to avoid obscuring details of the illustrated examples). The substation 11-1 may further comprise CB connected between the incoming and each outgoing circuit (e.g., between the HV busbar and each of OT-1 through OT-G). In some implementations, an isolator may be provided on each side of respective CB (not shown in FIG. 3A to avoid obscuring details of the illustrated examples).

As disclosed herein, the LLM module 212 may be configured to acquire LLM data 113 pertaining to the substation 11-1. The LLM data 113 may be acquired from respective substation components 12-1, MC components 16-1 of the substation 11-1, and/or the like. In the FIG. 6A example, the MC components 16-1 of the substation 11-1 may include CT, VT, metering equipment (e.g., 11 kv metering equipment), protective relay, and so on. As illustrated in FIG. 6A, CT may be disposed either side of respective CB so that the resulting overlapping protection zones cover the respective CB.

The LLM module 212 may comprise an LLM CFG 301 which may comprise, inter alia, static topology data 303 pertaining to the substation 11-1, as disclosed herein. The LLM CFG 301 may further comprise a substation CFG 311. As disclosed herein, the substation CFG 311 may comprise verified and/or authenticated operator-specified configuration data pertaining to the physical state substation 11-1. In other words, the substation CFG 311 may define an expected, nominal, or validated configuration of the substation 11-1. The substation CFG 311 may specify any suitable information pertaining to the substation 11-1 and/or specified substation components 12-1. For example, the substation CFG 311 may comprise information pertaining to the configuration of selected substation components 12-1 (component configuration data, or component CFG), such as CB, switches, relays, transformers, and/or the like. The component configuration data (component CFG) may comprise any suitable operator-specified configuration information, such as component settings (e.g., transformer tap settings, switch settings, relay thresholds, and/or the like), component firmware version, and/or the like. In some implementations, the substation CFG 311 may comprise a signature and/or other data by which the configuration data thereof (and/or respective component CFG) may be authenticated, e.g., a cyclic redundancy check (CRC) code, hash code derived from configuration data of the substation component 12-1, and/or the like. The substation CFG 311 may define expected characteristics of the substation topology. Deviation from the substation CFG 311 may, therefore, be indicative of a physical anomaly condition, e.g., may be indicative of a failure, attack, and/or compromise of one or more substation components 12-1.

As disclosed herein, the substation CFG 311 may comprise configuration information pertaining to any suitable type of substation component 12-1. In the FIG. 6A example, the substation CFG 311 may comprise component CFG pertaining to respective CB of the substation 11-1, e.g., CB-1-1 through CB-G-2. The substation CFG 311 pertaining to the CB may specify trip criteria for respective CB (CB thresholds or the like), and so on. The substation CFG 311 may comprise information pertaining to other types of substation components 12-1. For example, the substation CFG 311 may comprise component CFG pertaining to the transformer component(s) 12-1; the substation CFG 311 may specify tap settings, a tap ratio, tap location(s), and/or other configuration parameters of respective transformers. The substation CFG 311 may further comprise component CFG data pertaining to flow control components 12-1, such as switches, branches, relays, bus couplers, and so on. By way of further non-limiting example, the substation CFG 311 may comprise component CFG data pertaining to bus coupler components 12-1 of the substation 11-1.

In some embodiments, the substation CFG 311 may further comprise information pertaining to MC components 16-1 of the substation 11-1. For example, the substation CFG 311 may comprise component CFG specifying the settings and/or configuration of respective PMU, IED, protective relays, PGP devices, and/or the like.

The LLM module 212 may be configured to monitor the substation 11-1 (e.g., implement aspects of a distributed LLM function 112), which may comprise generating LLSE 115 configured to model the physical state of the substation 11-1, as disclosed herein. Generating an LLSE 115 for the substation 11-1 may comprise a) acquiring dynamic topology data 313, b) constructing an HP topology model by use of the topology processor 314, e.g., combining the dynamic topology data 313 with static topology data 303 of the substation 11-1, c) determining LL SEI data, e.g., power injections, flows, virtual measurements, and so on, and d) deriving the LLSE 115 from the SEI data and topology model determined for the substation 11-1. The LLSE 115 may be generated in accordance with an LLSE procedure 305. For example, the LLM module 312 may be configured to generate LLSE 115 in accordance with a GSE algorithm comprising WLS estimation on a linear regression model. The LLSE 115 may be generated in accordance with method 300 and/or 300-1 disclosed herein.

The LLM module 212 may be further configured to validate the LLSE 115. The LLSE 115 may be validated in accordance with LLSE validation procedure 331, as disclosed herein. The LLSE validation procedure 331 may comprise a) determining residuals for the LLSE 115, b) identifying anomalous residuals, c) analyzing the identified residuals, e.g., determining the root cause of respective anomalous residuals, processing the residuals (BD processing, topology error processing, or the like), and d) revising the LL SEI data in accordance with the analysis for recalculation of the LLSE 115. The LLSE validation procedure 331 may further comprise recording information pertaining to the anomalous residuals, as disclosed herein.

The LLSE validation procedure 331 disclosed herein may be configured to detect and mitigate internal anomalies pertaining to the LLSE 115 itself. The LLAD module 330 may be further configured to detect and/or mitigate other types of anomalies. For example, the LLAD module 330 may be configured to identify anomalies pertaining to the physical state of the substation 11-1, as indicated by the LLSE 115.

In the FIG. 6A example, the LLM module 212 nay comprise an LLAD implementation 670. The LLAD implementation 670 may be configured to implement a substation-level physical AD function. More specifically, the LLAD implementation 670 may be configured to detect physical state anomalies pertaining to the substation 11-1 based, at least in part, on the LLSE 115 determined for the substation 11-1. The LLAD implementation 670 may be further configured to record information pertaining to detected physical anomalies (if any) within the LLPS data 114 returned to the ULM system 120. For example, the LLAD implementation 670 may generate LL PSH data and/or an LL PSH metric configured to quantify a degree to which the physical state of the substation 11-1 is indicative of a physical anomaly. The LLAD data 215 may further comprise information pertaining to the physical anomaly, e.g., may identify the source of the physical anomaly and/or the like.

In a first non-limiting example, the LLM module 212 may comprise an LL AI/ML AD implementation 650, which may comprise an LL AI/ML model 652 configured to detect anomalous physical states of the substation 11-1 (per a learned LL AI/ML CFG 651). The LL AI/ML model 652 may comprise and/or implement any suitable AI/ML algorithm and/or architecture, as disclosed herein. The LL AI/ML model 652 may be trained to distinguish anomalous physical states and/or behaviors of the substation 11-1 from nominal, non-anomalous physical states and/or behavior. The LL AI/ML model 652 may be configured to generate LLAD data 215 configured to characterize the physical health of the substation 11-1 in response to LLSE 115 generated by the LLM module 212.

In a second non-limiting example, the LLAD implementation 670 may comprise LL baseline anomaly detection (LL BL AD) logic 653. The LL BL AD logic 653 may comprise and/or be coupled to a datastore comprising LL BL entries 655, each corresponding to a respective class of physical behavior and/or state of the substation 11-1. As disclosed herein, the LL BL entries 655 may comprise BL LLPS data 654 characteristic of respective physical behaviors and/or states. The LL BL AD logic 653 may be configured to compare LLSE 115 generated by the LLM module 212 to the LL BL entries 655 and, in response, generate LLAD data 215 configured to indicate a degree to which the LLSE 115 is indicative of a physical anomaly, as disclosed herein.

In a third non-limiting example, the LLAD implementation 670 may comprise an LL rules-based anomaly detection (LL RB AD) implementation 656. The LL RB AD implementation 656 may comprise and/or be coupled to a datastore comprising entries 657 defining respective LL anomaly detection rules (LL ADR). The LL ADR entries 657 may define substation-level anomaly detection rules (e.g., may trigger anomaly detection based on specified conditions, as disclosed herein). The LL ADR entries 657 may be configured to trigger substation-level anomaly detection based on any suitable criteria or condition. For example, the LL ADR entries 657 may define acceptable ranges for specified aspects of the LLSE 115, such as acceptable ranges for voltage magnitudes at specified locations (e.g., nodes) within the substation 11-1, power injections and/or flows at specified nodes, and/or the like. The LL ADR entries 657 may be configured to trigger LL anomaly detection in response to LLSE 115 comprising measurements determined to fall outside of the acceptable ranges.

In another example, the LL ADR entries 657 may be configured to trigger anomaly detection based on, inter alia, evaluation of the substation CFG 311 defined for the substation 11-1 (and/or designated substation components 12-1). As disclosed herein, the substation CFG 311 may comprise validated and/or authenticated configuration data pertaining to the substation 11-1. In other words, the substation CFG 311 may define a valid or expected configuration of the substation 11-1 and/or designated components 12-1 thereof. The LLM module 212 may be configured to acquire LLM data 113 from the substation 11-1 corresponding to the substation CFG 311 (e.g., acquire measured CFG 321). The measured CFG 321 may be acquired by use of LP network resources 19-LP of the CPS 10 (e.g., SCADA network or the like). For example, aspects of the measured CFG 321 may be acquired concurrently with dynamic topology data 313, as disclosed herein. The LL AD entries 657 may define comparisons between aspects of the substation CFG 311 and corresponding aspects of the measured CFG 321. In other words, the LL RD AD entries 657 may define comparisons between the expected configuration of designated substation components 12-1 (as defined by the substation CFG 311) to the actual, acquired configuration of the designated substation components 12-1 (as indicated by the measured CFG 321). The LL RD AD logic 656 may trigger detection of a substation-level physical anomaly in response to identifying a mismatch or other inconsistency between the expected substation CFG 311 and the actual, measured CFG 321.

Information pertaining to LL anomalies detected by the LLAD module 330 (if any) may be recorded within the LLPS data 114 generated by the LLM module 114, e.g., may be recorded within the LLSE 115, LLAD data 215, and/or the like. In some implementations, the information may comprise information pertaining to the root cause of the detected anomalies. In a first non-limiting example, the LLAD module 330 may record information identifying components 12-1 associated measurements of the LLSE 115 resulting in anomaly detection by the LL AI/ML model 652 (e.g., based on root cause analysis of the LLSE 115). In a second non-limiting example, the LLAD module 330 may record information identifying components 12-1 and/or measurements of the LLSE 115 resulting in anomaly detection by the LL BL logic 653 (e.g., measurements in close proximity to measurements of anomalous LL BL entries 655). In a third non-limiting example, the LLAD module 330 may record information identifying components 12-1 associated with measurements outside of ranges specified by one or more LL ADR entries 657. In a fourth non-limiting example, the LLAD module 330 may record information identifying components 12-1 determined to have a configuration (measured CFG 321) determined to be inconsistent with the verified, expected configuration defined for the components 12-1 by the substation CFG 311 per one or more LL ADR entries 657. Although particular examples techniques for LL anomaly detection are described herein, the disclosure is not limited in this regard and could be adapted to incorporate any suitable substation-level anomaly detection scheme.

FIG. 6B is a flow diagram illustrating another example of a method 600 for monitoring a substation 11-1, as disclosed herein. Step 610 may comprise acquiring physical state data from the substation 11-1. The physical state data may comprise LLM 113, which may include but is not limited to: HPM data (e.g., PMU phasor measurements, synchrophasors, and/or the like), LPM data, dynamic topology data 313, measured CFG 321 pertaining to the substation 11-1 and/or designated substation components 12-1, and/or the like.

Step 645 may comprise iteratively generating and/or validating a substation-level state estimate. Step 645 may comprise constructing a substation topology (e.g., based on the dynamic topology data 313 acquired at 610), deriving LL SEI data from the acquired HPM data, generating the LLSE 115 (e.g., executing GSE with WLS estimation on a linear regression model), validating the LLSE 115, and refining the LL SEI data recalculating the LLSE 115 until one or more LLSE termination criteria are satisfied.

Step 655 may comprise implementing substation-level anomaly detection on the substation-level state estimate determined at 645 (e.g., the resulting LLSE 115). The LL anomaly detection may be implemented by any suitable substation-level anomaly detection implementation, including but not limited to an LL AI/ML AD implementation 650, LL BL AD logic 653, LL RB AD logic 656, and/or the like. The substation-level anomaly detection may comprise detecting anomalies pertaining to the physical state of the substation 11-1 (and/or designated substation components 12-1), as disclosed herein. The substation-level anomaly detection of step 655 may further comprise recording information pertaining to detected anomalies (if any) within LLAD data 215 associated with the LLSE.

Step 680 may comprise communicating the substation-level state estimate determined at step 645 and substation anomaly data (if any) to an upper-level anomaly detection system. Step 680 may comprise communicating LLAD data 215 (and/or corresponding LLSE 115) to the ULM system 120. As disclosed herein, the ULM system 120 may utilize the LLSE 115 and/or corresponding LLAD data 215 to implement aspects of an ULM function 122 configured to assess the physical health of the PS 10-1.

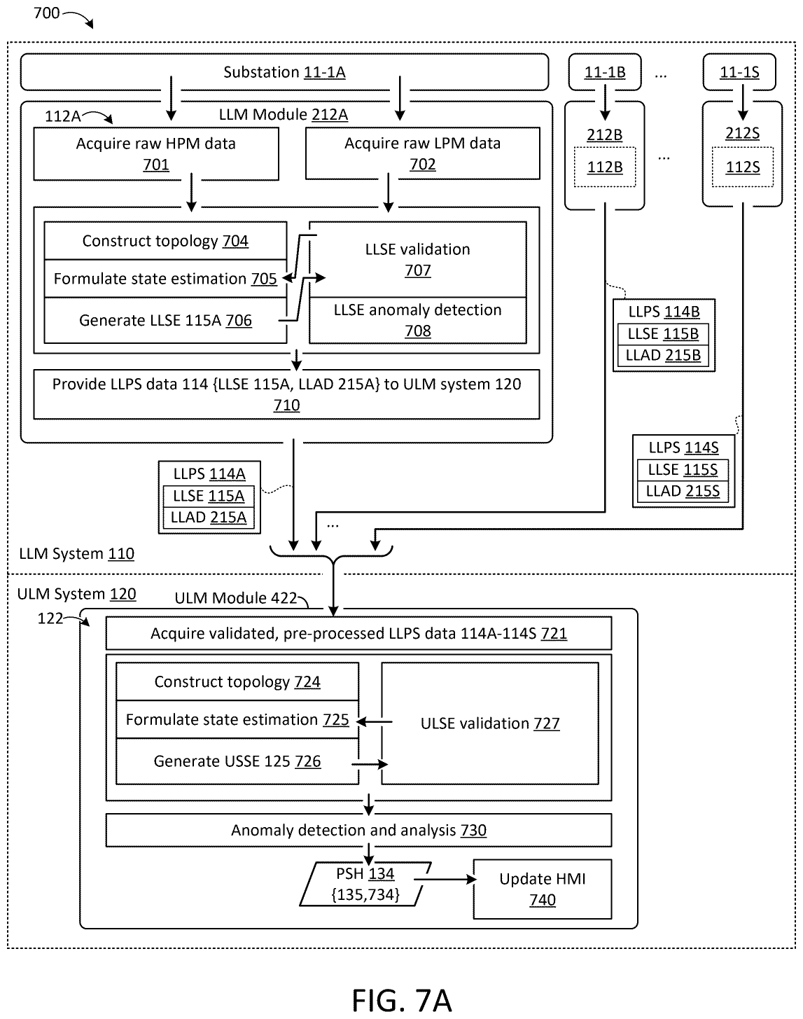

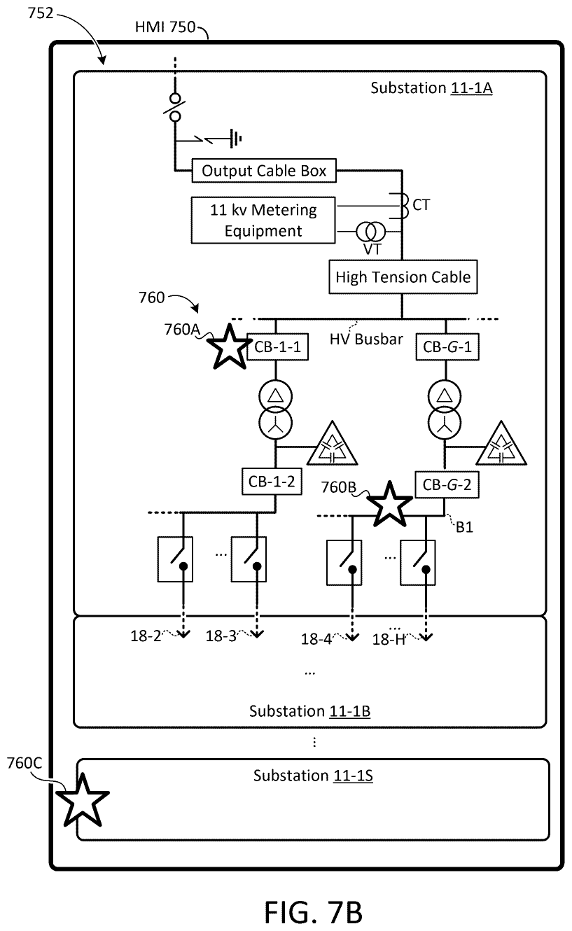

FIG. 7A is a functional block diagram illustrating an example of a distributed, multi-tier PSM system 101, as disclosed herein. The PSM system 101 may comprise an LLM system 110 and ULM system 120. The LLM system 110 may be configured to implement distributed LLM functions 112A-112S covering substations 11-1A through 11-1S of the PS 10-1. The LLM functions 112 may be implemented by distributed devices and/or LLM modules 212. The LLM functions 112 may comprise generating LLPS data 114 (and/or LLSE 115) configured to characterize the physical state of the substations 11-1. The LLM system 110 may be further configured to communicate the LLPS data 114 to the ULM system 120.

The ULM system 120 may be configured to generate PSM data 123 configured to characterize the physical state of the entire CPS 10, e.g., ULSE 125. The ULSE 125 may be derived from pre-processed, validated measurement data of the LLSE 115 determined for respective substations 11-1. The ULM system 120 may be further configured to evaluate the physical health of the CPS 10, which may comprise generating PSH data 134 configured to identify anomalies pertaining to the physical state and/or behavior of the CPS 10, as disclosed herein.

The LLM function 112A pertaining to substation 11-1A may comprise acquiring raw LLM data 113 pertaining to the substation 11-1A at 701 and 702. At 701, the LLM module 212A may be configured to acquire raw HPM data (e.g., PMU phasor measurements, synchrophasor measurements and/or the like) and at 702, the LLM module 212A may be configured to acquire LPM data (e.g., dynamic topology data 313, such as the state of respective CB and/or the like). In some implementations, the LLM module 212A may be configured to acquire the raw HPM data and/or raw LPM data concurrently.

The LLM function 112A may further comprise generating an LLSE 115A for the substation 11-1A, which may comprise: a) constructing a topology of the substation 11-1A at 703, b) formulating state estimation of the substation 11-1A at 705, e.g., collecting and/or deriving LL SEI data from the LLM data 113 acquired at 701 and/or 702, c) generating an LLSE 115A for the substation 11-1A at 706, d) and validating the LLSE at 707. The LLSE validation of 707 may comprise an iterative procedure comprising evaluating residuals of the LLSE 115A and refining the LLSE 115A until an LLSE termination criterion is satisfied. Refining the LLSE 115 at 707 may comprise identifying anomalous residuals of the LLSE 115A, b) analyzing the identified anomalous residuals, c) modifying the LL SEI data (and/or underlying LLSE data 113S) used to generate the LLSE 115A per the analysis, and d) recalculating the LLSE 115A using the modified LL SEI data.

The LLM function 112A may further comprise LLSE anomaly detection at 708. The LLSE anomaly detection may comprise detecting physical anomalies pertaining to the substation 11-1 based, at least in part, on the LLSE 115A generated at 701-707. The LLSE anomaly detection may be implemented by one or more of an LL AI/ML AD implementation 650, LL BL AD logic 653, an LL RB AD implementation 656, and/or the like, as disclosed herein. The LLSE anomaly detection at 708 may further comprise recording information pertaining to substation-level anomalies (if any) within LLAD data 215A associated with the LLSE 115A.

The LLM module 212A may be further configured to provide LLPS data 114A comprising the LLSE 115A determined for the substation 11-1A and/or associated LLAD data 215A to the ULM system 120 at 710.

The ULM module 422 of the ULM system 120 may be configured to implement aspects of an ULM function 122 configured to cover the PS 10. The ULM function 122 may comprise acquiring LLPS data 114A-114S from respective substations 11-1 at 721, as disclosed herein. The ULM function 122 may further comprise leveraging the validated, pre-processed LLPS data 114A-114S to determine an ULSE 125 configured to characterize the physical state of the PS 10-1 as a whole The ULM module 422 may be configured to construct a topology of the PS 10-1 at 724, e.g., a UL topology. The UL topology may comprise an LR topology model, as disclosed herein. The ULM module 422 may be further configured to formulate UL SEI data for the upper-level state estimation at 725. The UL topology and UL SEI data may comprise and/or be derived from the LLPS data 114A-114S acquired at 721.

At 726, the ULM module 422 may be configured to generate a ULSE 125. The ULSE 125 may be generated in accordance with an ULSE procedure 405, e.g., GSE with WLS estimation on a linear regression model. At 727, the ULM module 422 may be configured to validate the ULSE 125. The validation may comprise iteratively refining the ULSE 125 as disclosed herein, e.g., evaluating residuals of the ULSE 125, analyzing the residuals, correcting UL SEI data per the residual analysis, recalculating the ULSE 125 by use of the corrected UL SEI data, and so on.

At 730, a physical AD module 130 of the ULM system 120 may utilize the ULSE 125 generated at 721-727 to assess the physical health of the PS 10-1. The physical AD module 130 may detect physical anomalies using any suitable technique and/or algorithm, including, but not limited to an AI/ML implementation (e.g., an AI/ML module 150 and/or trained AI/ML model 152), baseline AD logic 550, rule-based AD logic 560, and/or the like. The physical AD module 130 may be configured to generate PSH data 134 in response to the ULSE 125. The PSH data 134 may be configured to indicate a degree to which the physical state and/or behavior of the PS 10-1 (as indicated by the ULSE 125) is indicative of a physical anomaly. In some implementations, the PSH data 134 may comprise a physical health metric, e.g., a value between 0 and 1, where 0 indicates nominal physical state and 1 indicates detection of a physical anomaly. Alternatively, or in addition, the PSH data 134 may comprise a PSH label 135, as disclosed herein.

In some embodiments, the PSH data 134 may further comprise root cause data 734, which may comprise, inter alia, information pertaining to the source or root cause of respective physical anomalies (if any). For example, the root cause data 734 may comprise information pertaining to root cause analyses performed at respective substations 11-1, as disclosed herein. Alternatively, or in addition, the physical AD module 130 may be configured to implement aspects of root cause analysis. For example, in response to detecting a physical anomaly, the physical AD module 130 may be configured to identify aspects of the ULSE 125 that triggered the anomaly detection (e.g., measurements, topology data, or the like) and may identify components 12-1 of the PS 10-1 associated with the identified aspects within the root cause data 734.

The ULM system 120 may be configured to provide the PSH data 134 to one or more endpoints, such as a mitigation module 140 and/or the like, as disclosed herein. In some implementations, the ULM system 120 may be configured to provide information pertaining to the ULSE 125 and/or PSH data 134 on an HMI.

FIG. 7B is a schematic block diagram illustrating an example of a HMI comprising a visual representation of PSH data 134 determined by the distributed, multi-tier PSM system 101 disclosed herein. The HMI 750 may comprise a graphical representation 752 of aspects of the PS 10-1. For example, the graphical representation 725 may comprise a schematic diagram of the PS 10-1 and/or respective substations 11-1A through 11-1S. The HMI 750 may further comprise one or more visual anomaly indicators 760. The anomaly indicators 760 may be configured to visually represent detection of anomalies pertaining to the physical state of the PS 10-1. The anomaly indicators 760 may be placed at locations corresponding to the determined root causes of the underlying physical anomalies. For example, the anomaly indicator 762A may be configured to indicate detection of an anomaly pertaining to CB-1-1. The anomaly indicator 762A may show, for example, that the CB-1-1 reported status information determined to be invalid. The anomaly indicator 762A may comprise human-readable text and/or other information specifying the nature of the anomaly (not shown in FIG. 7B to avoid obscuring details of the illustrated examples). The anomaly indicator 762B may be configured to indicate that the voltage measurement on HV busbar B1 is invalid and/or outside of the acceptable range defined for the substation 11-1A. In some implementations, the source of an anomaly may not be known and/or an anomaly may impact a collection of components 12-1, such as a substation 11-1. FIG. 7B illustrates an example of an anomaly indicator 762C configured to represent an anomaly determined to impact one or more components 12-1 of substation 11-1S (and/or the substation 11-1S as a whole).

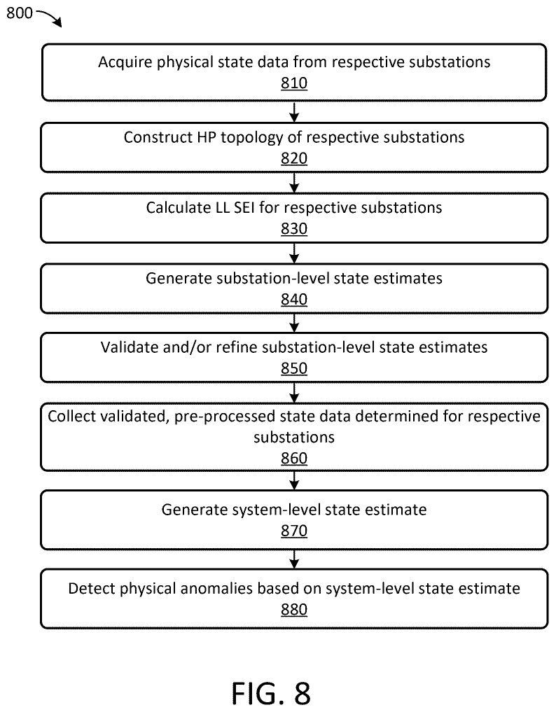

FIG. 8 is a flow diagram of a method 800 for monitoring the physical state of a CPS 10, such as a PS 10-1, as disclosed herein.

Step 810 may comprise acquiring physical state data to respective substations 11-1 of the PS 10-1. The physical state data may be acquired concurrently by respective LLM modules 212, as disclosed herein. The physical state data may comprise LPM data, HPM data, and/or the like. The LPM data may comprise information pertaining to the configuration of respective substations 11-1, e.g., may comprise data, static topology data 303, dynamic topology data 313, measured CFG 321, and/or the like The HPM data may comprise high-performance measurement data acquired at designated locations within respective substations 11-1, such as PMU phasor measurements, synchrophasors, voltage magnitudes, and/or the like.

Step 820 may comprise constructed HP topology models for respective substations 11-1. The HP topology models may comprise detailed node-breaker network models, as disclosed herein.

Step 830 may comprise calculating power data for respective substations 11-1, e.g., calculating respective LL SEI data comprising power injection and flows from the PMU phasor measurements of the HPM data acquired at 810.

Step 840 may comprise generating LLSE 115 configured to characterize the physical states of the respective substations 11-1, e.g., LLSE 115A-115S configured to characterize the physical states of substations 11-1A through 11-1S, respectively.

Step 850 may comprise validating the LLSE 115 generated for the respective substations. Step 850 may further comprise iteratively validating and/or refining the LLSE 115 until LLSE termination criterial is satisfied. The validating may comprise identifying anomalous residuals of the LLSE 115, analyzing the identified anomalous residuals (e.g., root cause analysis), correcting the physical state data (and/or LL SEI data) in accordance with the analysis, and recalculating the LLSE 115 using the corrected data, as disclosed herein.

In some implementations, step 850 may further comprise detecting anomalies pertaining to the physical states of respective substation 11-1, e.g., implementing substation-level anomaly detection on the resulting LLSE 115, as disclosed herein.

Step 860 may comprise collecting the validated, pre-processed state data determined for respective substations 11-1. The validated, pre-processed state data may be collected at an ULM module 422, as disclosed herein. The validated, pre-processed state data may comprise LLPS data 114A-114S comprising LLSE 115A-115S (and/or LLAD data 215A-215S) determined for respective substations 11-1A through 11-1S.

Step 870 may comprise generating a system-level state estimate (e.g., ULSE 125). Step 870 may comprise constructing a UL topology of the PS 10-1 and calculating corresponding UL SEI data, e.g., deriving power injections, power flows, and/or other quantities from the LLPS data 114 collected at 860. Step 870 may further comprise generating an ULSE 125 by use of the UL topology and UL SEI data. In some implementations, step 870 may further comprise iteratively validating and/or refining the ULSE 125, as disclosed herein.

Step 880 may comprise detecting physical anomalies based on the system-level state estimate generated at 870. Aspects of step 880 may be implemented by the physical AD module 130 disclosed herein. Step 880 may comprise generating PSH data 134 configured to quantify a physical health of the PS 10-1. The PSH data 134 may comprise a PSH label 135, root cause data 734, and/or the like, as disclosed herein. Step 880 may comprise providing the PSH data 134 to one or more endpoints, such as a mitigation module 140, HMI 750, and/or the like. The mitigation module 140 may be configured to alert and/or otherwise notify operators of the PS 10-1 in response to PSH data 134 indicating detection of one or more physical anomalies. Similarly, the HMI 750 may be configured to display visual anomaly indicators 760 corresponding to detected physical anomalies (if any).

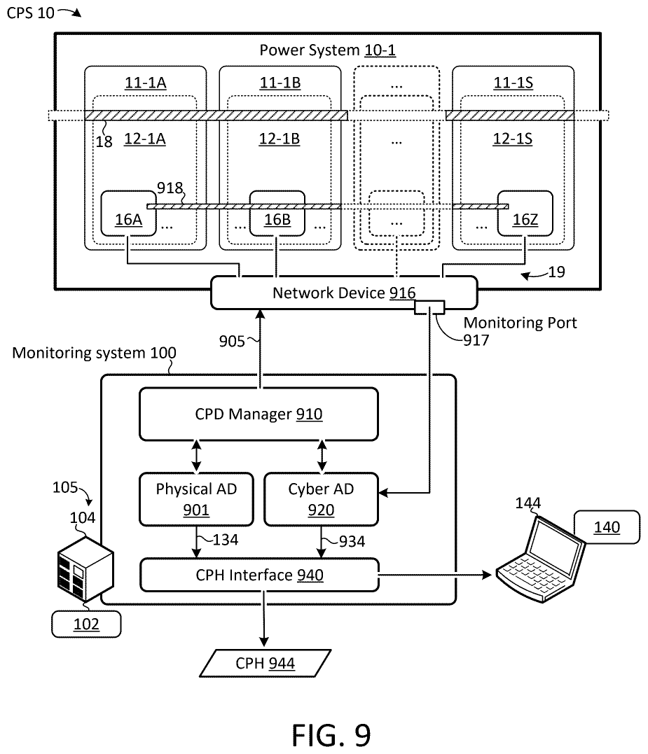

In some implementations, the monitoring system 100 disclosed herein may be further configured to monitor a cyber health of the CPS 10, e.g., along with monitoring the physical state of the CPS 10 as disclosed herein. In these implementations, the monitoring system 100 may comprise a holistic cyber-physical monitoring system 900 as illustrated in FIG. 9.

FIG. 9 is a schematic block diagram illustrating an example of a monitoring system 100 configured to monitor the cyber-physical state and/or cyber-physical health of a CPS 10. The CPS 10 may comprise any suitable cyber-physical system. The CPS 10 may comprise cyber-physical components 12 that, in some implementations, may correspond to and/or be organized or arranged within respective sub-systems or sections 11. In the FIG. 9 example, the CPS 10 may comprise a PS 10-1, as disclosed herein. The PS 10-1 may comprise components 12-1 that correspond to and/or are organized within respective substations 11-1, e.g., components 12-1A through 12-1S organized within substations 11-1A through 11-1S, respectively. Respective substations 11-1 of the PS 10-1 may be coupled to other substations 11-1 (and/or other CPS systems) by, inter alia, interconnections 18, e.g., lines and/or other suitable components 12.

As disclosed herein, the PS 10-1 may comprise MC components 16. MC components 16 of the PS 10-1 may be configured to acquire physical state data pertaining to the PS 10-1 and/or respective components 12-1 thereof. MC components 16 of the PS 10-1 may comprise field devices, which may include, but are not limited to: measurement devices (e.g., VT, CT, or the like), PMU, PDC, IED, and/or the like. MC components 16 of the PS 10-1 may be further configured to implement cyber functionality of the CPS 10. For example, MC components 16 of the PS 10-1 may be communicatively and/or operably coupled to an electronic communication network, e.g., network 19 and/or a HP network 319 (HP network 319 not shown in FIG. 9 to avoid obscuring details of the illustrated embodiments). The MC components 16 may be interconnected by, inter alia, network infrastructure 918 of the CPS 10. The network infrastructure 918 may comprise a network device 916, such as a switch or the like, as disclosed in further detail herein. In some implementations, one or more MC components 16 of the CPS 10 may be configured to implement and/or embody aspects of the network 19 and/or network infrastructure 918. For example, the MC components 16 may comprise cyber-components, which may include, but are not limited to: field devices, network infrastructure devices, switches, routers, network analyzers, switch port analyzers, and/or the like.

The monitoring system 100 may be communicatively and/or operably coupled to MC components 16 of the PS 10-1 through, inter alia, the network 19. In the FIG. 9 example, the monitoring system 100 may be communicatively and/or operably coupled to one or more MC components 16A-16Z by a network device 919. The network device 919 may comprise a switch, router, or other device configured to monitor communication between MC components 16 within the network 19. In other words, the network device 919 may be communicatively coupled to MC devices 16A-16Z through the network 19. For example, the network device 919 may be configured receive and/or process network messages (e.g., packets) communicated to and/or from respective MC devices 16A-16Z.

The monitoring system 100 may comprise a physical anomaly detection (AD) system 901 and a cyber AD system 920. The physical AD system 901 may be configured to monitor and/or assess the physical state of the CPS 10 and the cyber AD system 920 may be configured to monitor and/or assess the cyber state of the CPS 10.

In some implementations, the monitoring system 100 may further comprise and/or be coupled to a cyber-physical data (CPD) manager 910. The CPD manager 910 may be configured to manage cyber-physical state (CPS) data acquired and/or utilized by the monitoring system 100, e.g., data pertaining to and/or utilized by the physical AD system 901, cyber AD system 920, and so on. The CPD manager 910 may be configured to collect, store, and serve CPS data to the monitoring system 100 (and/or CPS 10). The CPD manager 910 may comprise a publisher/subscriber architecture, such as Kafka or the like. The CPD manager 910 may be scalable (e.g., be capable of handling large amounts of data and/or messages), support persistent, NT storage of CPD streams, maintain backup copies of CPD data, and so on. For example, the CPD manager 910 may be configured to store CPS data for offline analysis while different processes (e.g., the monitoring system 100) analyze the CPS data in real time.

Aspects of the monitoring system, physical AD system 901, cyber AD system 920, and/or CPD manager 910 may be implemented on and/or embodied by computing resources 102 of a device, such as a computing device 104 and/or AD device 105, as disclosed herein. Alternatively, or in addition, aspects of one or more of the AD system 901, cyber AD system, and/or CPD manager 910 may be implemented on and/or embodied by other computing resources of one or more other devices, e.g., on one or more separate and/or independent computing devices (not shown in FIG. 9 to avoid obscuring details of the illustrated examples).

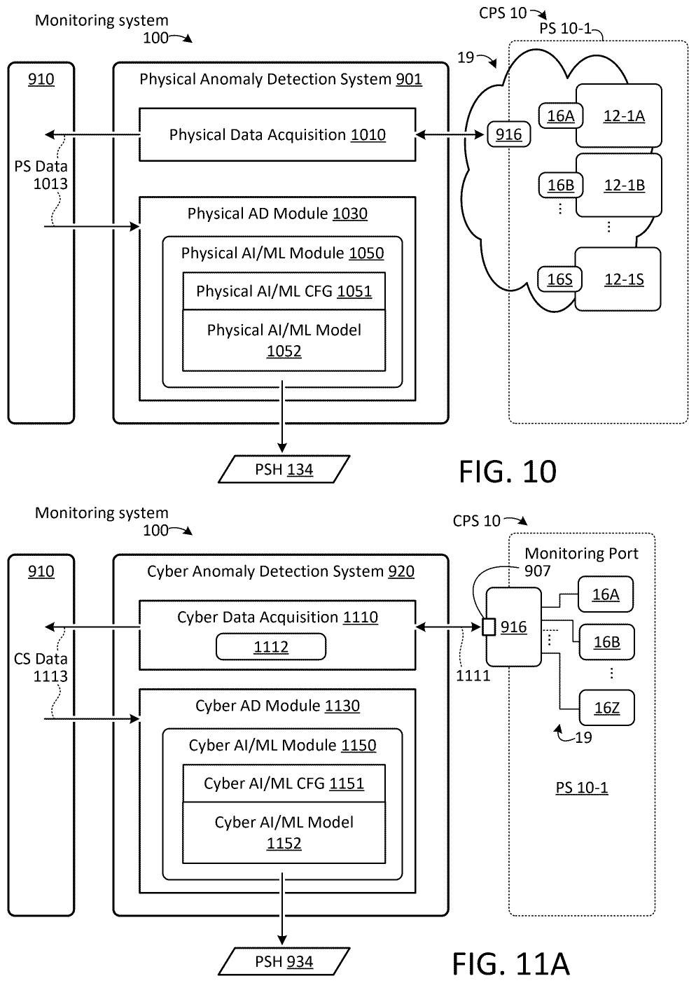

FIG. 10 is a schematic block diagram illustrating an example of a physical AD system 901. In some implementations, the physical AD system 901 may comprise a distributed, multi-tier PSM system 101, as disclosed herein. In the FIG. 9 example, the physical AD system 901 may comprise a physical data acquisition (PDA) module 1010 and physical AD module 1030.

The PDA module 1010 may be configured to, inter alia, acquire physical state (PS) data 1013 pertaining to the PS 10-1 and/or respective substations 11-1 thereof. The PDA module 1010 may be configured to retrieve PS data 1013 using industrial protocols, such as DNP3, SCADA, or the like. The PS data 1013 may comprise any suitable information pertaining to the physical state of the PS 10-1, respective substations 11-1, and/or components 12-1 thereof. The PS data 1013 may comprise voltage, current, power, and/or other physical state measurements acquired at specified locations within the PS 10-1, e.g., at specified nodes, buses, branches, components 12-1, and/or the like.

In some implementations, the PDA module 1010 may be configured to acquire aspects of the PS data 1013 from respective MC components 16A-16Z of the PS 10-1. For example, the PDA module 1010 may comprise a master device configured to collect PS data 1013 from outstations of the PS 10-1 (MC components 16A-16Z.) over DNP3 or other suitable industrial network protocol. Alternatively, or in addition, the PDA module 1010 may be configured to acquire aspects of the PS data 1013 from a SCADA system via TCP/IP encapsulation. By way of further non-limiting example, the PDA module 1010 may be configured to acquire aspects of the PS data 1013 by other means, such as through the network device 916. As disclosed herein, the network device 916 may be communicatively coupled to MC components 16A-16Z and/or may be configured to concentrate and/or consolidate communication of PS data 1013 acquired by the MC devices 16A-16Z. For example, the network device 916 comprise and/or be coupled to HP network resources 19-HP of the network 19, e.g., may comprise and/or be coupled to an HP interface device 316-HP, as illustrated in FIGS. 3A and 6 (HP network resources 19-HP, HP interface device 316-HP not shown in FIG. 10 to avoid obscuring details of the illustrated examples).

Alternatively, or in addition, in some examples, the PDA module 1010 may comprise and/or be coupled to a distributed LLM system 110, as disclosed herein. The LLM system 110 may be configured to acquire aspects of the PS data 1013. For example, the LLM system 110 may be configured to acquire PS data 1013 comprising LLPS data 114, the LLPS data 114 comprising LLSE 115 determined for respective substations 11-1 of the PS 10-1 (and/or the PS 10-1 as a whole).

In some implementations, the PDA module 1010 may be configured to provide PS data 1013 directly to the physical AD system 901, e.g., provide PS data 1013 directly to the physical AD module 1030. Alternatively, or in addition, the PDA module 1010 may be configured to publish the PS data 1013 to the CPD manager 910. The PS data 1013 may be published to a topic of channel, e.g., a Karka topic and the CPD manager 910 may be configured to provide the PS data 1013 to subscribers of the topic or channel. In the FIG. 10 example, the PDA module 1010 may be configured to publish PS data 1013 to a “physical state data” topic and the physical AD system 901 and/or physical AD module 1030 may be configured to receive the published PS data 1013 from the CDA manager 910, e.g., may subscribe to the “physical state data” channel.

The physical AD module 1030 may be configured to assess the physical health of the PS 10-1 based on PS data 1013 acquired from the PS 10-1 as disclosed herein. In the FIG. 10 example, the physical AD module 1030 may be configured to generate PSH data 134 in response to the PS data 1013, the PSH data 134 may comprise a physical health metric (Mp) configured to indicate a degree to which the PS data 1013 is indicative of a physical anomaly. The physical health metric (Mp) may comprise a value between 0 and 1, where 0 indicates nominal physical health and 1 indicates anomalous physical health (e.g., a physical fault, attack, compromise, or the like).

The physical AD module 1030 may evaluate the PS data 1013 by use of, inter alia, a physical AI/ML module 1050. The physical AI/ML module 1050 may comprise a physical AI/ML model 1052 configured in accordance with a physical AI/ML CFG 1051, as disclosed herein. The physical AI/ML model 1051 and/or corresponding AI/ML CFG 1051 may be learned, refined, and/or otherwise trained through unsupervised AI/ML techniques. The physical AI/ML model 1052 may be configured to identify PS data 1013 indicative of nominal physical behavior and/or operation. The physical AI/ML model 1052 may be further configured to identify PS data 1013 that deviates from expected physical behavior.

The AI/ML model 1052 may comprise and/or implement any suitable AI/ML architecture or algorithm. In the FIG. 10 example, the physical AI/ML model 1052 may comprise and/or be configured to implement an unsupervised AI/ML architecture and/or algorithm, which may include, but is not limited to one or more of: a OCSVM, a LOF algorithm, an autoencoder, and/or the like.

In a first non-limiting example, the physical AI/ML model 1052 may comprise an OCSVM AI/ML implementation. The OCSVM AI/ML implementation (e.g., physical AI/ML model 1052) may be trained using nominal behavior such that unseen behavior is identified as an anomaly (e.g., failure, attack, compromise, or the like). The OCSVM AI/ML implementation may be configured to learn a decision boundary of a single class, e.g., may be an extension of a support vector machine (SVM) or the like. The OCSVM AI/ML implementation of the physical AI/ML model 1052 may be configured for anomaly detection by, inter alia training the OCSVM AI/ML implementation to learn a decision boundary of a nominal behavior class (e.g., PS data 1013 corresponding to nominal physical behaviors or states of the PS 10-1). The trained OCSVM AI/ML implementation of the physical AI/ML model 1052 may detect anomaly conditions in response to PS data 1013 that deviates from the learned nominal physical behavior and/or states.

In a second non-limiting example, the physical AI/ML model 1052 may comprise an AI/ML implementation of an LOF algorithm. The LOF algorithm is a clustering-based unsupervised anomaly detection algorithm that computes a local density deviation of a given data point with respect to its neighbors. Accordingly, in LOF AI/ML implementations, the physical AI/ML model 1052 may be configured to map PS data 1013 to datapoints within a name or state space of the LOF algorithm. The LOF AI/ML implementation of the physical AI/ML model 1052 may be trained to identify outliers or anomalies as data points (PS data 1013) having a significantly lower density compared to its neighbor data points.

In a third non-limiting example, the physical AI/ML model 1052 may comprise an AI/ML implementation of an autoencoder. Autoencoders are a widely used neural network architecture having the capability to learn encodings of input data (e.g., PS data 1013). The AI/ML autoencoder implementation of the physical AI/ML model 1052 may comprise an encoder and decoder. The encoder may be configured to convert input data (e.g., PS data 1013) into an abstract representation and the decoder may be configured to reconstruct the abstract representations. The autoencoder AI/ML implementation of the physical AI/ML model 1052 may be trained to identify anomalous physical behavior and/or states of the PS 10-1 based on differences between input PS data 1013 and the reconstructed data produced by the AI/ML autoencoder implementation of the physical AI/ML model 1052.

As disclosed herein, physical AD module 1030 may be configured to generate PSH data 134 in response to PS data 1013 acquired from the PS 10-1. The PSH data 134 may be generated by, inter alia, the physical AI/ML model 1052 disclosed herein The physical AI/ML model 1052 may comprise an AI/ML implementation of one or more of an OCSVM, LOF, autoencoder, and/or the like. In some implementations, the physical AD module 1030 may be further configured to implement data normalization to a zero mean in embodiments wherein the physical AI/ML model 1052 comprises an autoencoder AI/ML implementation.

As disclosed herein, the physical AI/ML model 1052 may be trained through one or more unsupervised AI/ML training procedures. The physical AI/ML model 1052 may be trained by use of training PS data 1013 recorded during nominal operation of the CPS 10 (and/or PS 10-1). The physical AI/ML model 1052 may, therefore, be trained to detect physical anomaly conditions in response to PS data 1013 that deviates from nominal physical behavior and/or states of the CPS 10.

Referring back to FIG. 9, the monitoring system 100 may further comprise a cyber AD system 920. As disclosed in further detail herein, the cyber AD system 920 may be configured to detect anomalies pertaining to cyber aspects of the CPS 10, e.g., anomalies pertaining to the behavior and/or state of the network 19. The cyber AD system 920 may be configured to generate cyber-state health (CSH) data 934 configured to indicate and/or quantify a cyber health of the CPS 10. The CSH data 934 may comprise a cyber health metric (M_{c}) between 0 and 1, wherein 0 represents nominal cyber behavior and/or state and 1 indicates a cyber anomaly, e.g., cyber attack, cyber component failure, compromise, and/or the like.

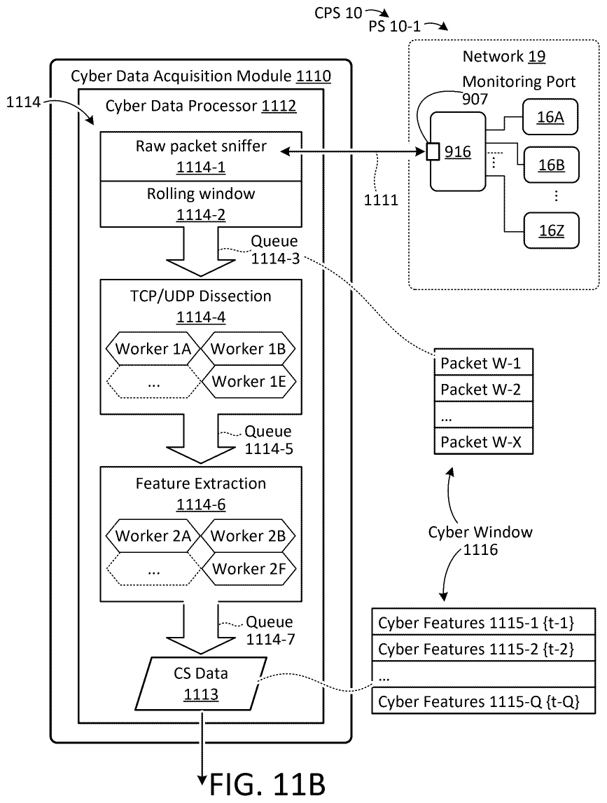

FIG. 11A is a schematic block diagram illustrating an example of a cyber AD system 920. The cyber AD system 920 may comprise a cyber data acquisition (CDA) module 1110 and cyber AD module 1130.

The CDA module 110 may comprise a cyber-sensor configured to collect and/or analyzer data communicated on the network 19, e.g., packet data. The CDA module 110 may be communicatively and/or operatively coupled to the network 19. In the examples illustrated in FIG. 9 and FIG. 11A, the Cyber AD system 920 may be coupled to the network 19 via a network device 916. The network device 916 may comprise a switch or the like.

The CDA module 1110 may be configured to acquire cyber-state (CS) data 1113 pertaining to the CPS 10 and/or network 19 thereof. Acquiring the CS data 1113 may comprise capturing and analyzing packet data in real-time. The CDA module 1110 may, for example, be configured to monitor communication between devices in the network 19, e.g., monitor communication between components 12-1, such as MC components 16A-16Z or the like. In some implementations, the CDA module 1110 may be communicatively and/or operatively coupled to a monitoring port 917 of the network device 916. The monitoring port 917 may be configured to provide access to data communicated through the network device 916. For example, the network device 916 may be configured to mirror incoming and outgoing communication that passes through the network device 916 on the monitoring port 917. The monitoring port 917 may comprise a switch port analyzer (SPAN port) or the like. The CDA module 1110 may capture and/or analyze network traffic, such as network packets. The CDA module 1110 may comprise and/or implement any suitable network monitoring and or analysis means. In simple implementations, the CDA module 1110 may utilize one or more network capture and/or analysis tools, such as Scapy or the like.

The CDA module 1110 may comprise and/or be coupled to a cyber data processor 1112. The cyber data processor 1112 may be configured to process cyber data captured by the CDA module 1110 through a multi-processing pipeline 1114, as illustrated in FIG. 11B.

FIG. 11B illustrates an example of a cyber data processor 1112 of the CDA module 1110. As disclosed herein, the cyber data processor 1112 may be configured to capture and/or process raw network data 1111 from the CPS 10, e.g., network 19. The raw network data 1111 may comprise captured packets and/or other types of network communication data.

The cyber data processor 1112 may comprise a raw packet sniffer 1114-1 which may be configured to capture raw network data 1111 from the network 19. The raw packet sniffer 1114-1 may be coupled to a monitoring port 917 of the network device 916, as disclosed herein.

The raw network data 1111 may be processed and/or analyzed with respect to and/or within respective capture windows (Wt), which may correspond to respective time periods, e.g., one second. The raw network data 1111 captured during respective cyber windows (Wt) 1116 may be maintained in a queue 1114-3 for further, window-based processing. The raw network data 1111 within a cyber window 1116 may comprise a packets captured during the window (Wt), e.g., packets W-1 through W-X.

The raw network data 1111 of respective capture windows 1116 may be further processed by a transmission control protocol/user datagram protocol (TCP/UDP) dissection module 1114-4. The TCP/UDP dissection module 1114-4 may be configured to extract data pertaining to cyber features from respective windows of raw network data 1111, e.g., collect cyber feature data from respective windows of raw network data 1111. As disclosed in further detail herein, the cyber features may comprise packet-level features, window-level features, and/or the like. The cyber features may be configured to characterize the cyber state of the CPS 10 and/or network 19. In some implementations, aspects of the TCP/UDP dissection may be performed in parallel by, inter alia, a plurality of workers, e.g., TCP/UDP dissection workers 1A through 1E, as illustrated in FIG. 11B.

The cyber feature data derived from respective windows of raw network data 1111 by the TCP/UDP dissection module may be maintained within queue 1114-5 for further processing by the feature extraction module 1114-6. The feature extraction module 1114-6 may be configured to extract and/or derive cyber features from the cyber feature data. The cyber features may comprise packet-level features, window-level features, and/or the like. The cyber features may be configured to characterize aspects of the cyber behavior and/or state of the CPS 10. The feature extraction module 1114-6 may be configured to generate any suitable cyber features pertaining to any suitable aspect of the raw network data 1111 including, but not limited to, the cyber features listed in Table 1 below.

TABLE 1

| Feature | Feature description |
|---|---|
| Packet_rate | Number of packets within a window |
| Num_src_IP | Number of different source IP addresses |
| Num_dst_IP | Number of different destination IP addresses |
| Num_src_port | Number of different source ports |
| Num_dst_port | Number of different destination ports |
| Min_data_length | The minimum data length of packets |
| Max_data_length | The maximum data length of packets |
| Avg_data_length | The average data length of packets |
| Min_win | The minimum window size of packets |
| Max_win | The maximum window size of packets |
| Avg_win | The average window size of packets |
| Min_time_intv | The minimum time gap between packets |
| Max_time_intv | The maximum time gap between packets |
| Avg_time_intv | The average time gap between packets |
| Min_pkt_src | The minimum number of packets per single |
| | source IP |
| Max_pkt_src | The maximum number of packets per single |
| | source IP |
| Avg_pkt_src | The average number of packets per single |
| | source IP |
| Min_pkt_dst | The minimum number of packets per single |
| | destination IP |
| Max_pkt_dst | The maximum number of packets per single |
| | destination IP |
| Min_ttl | The minimum time to live value of packets |
| Max_ttl | The maximum time to live value of packets |
| Avg_ttl | The average time to live value of packets |
| Num_byt | Number of bytes transmitted by packets |
| Same_src_dst | Number of packets with src IP = dst IP |
| Same_ports | Number of packets with src port = dst port |
| Same_src_src_port | Number of unique of src IP and src port |
| | combinations |
| Same_src_dst_port | Number of unique of src IP and dst port |
| | combinations |
| Same_dst_src_port | Number of unique of dst IP and src port |
| | combinations |
| Same_dst_dst_port | Number of unique of dst IP and dst port |
| | combinations |
| Same_IP_port | Number of packets with src IP = dst IP and |
| | src port == dst port |
| Num_urg | Number of urgent packets |
| Num_syn | Number of sync packets |
| Num_arp | Number of arp packets |

The cyber features 1115 extracted and/or derived by the CDA module 1110 may be maintained within queue 1114-7 and the resulting sets of cyber features 1115 determined for respective cyber windows 1116 may be output as CS data 1113. In other words, the CS data 1113 may comprise respective sets of cyber features 1115, each set of cyber features 1115 corresponding to (e.g., extracted and/or derived from) a respective cyber window 1116 having a respective capture time (Wt). In the FIG. 11B example, the CS data 1113 comprises cyber features 1115-1 through 1115-T corresponding to capture times t-1 through t-Q, respectively.

In some implementation, the CDA module 1110 may be configured to implement a partial packet inspection scheme. For example, the TCP dissection module 1114-4 and/or feature extraction module 1114-6 may be configured to operate on designated portions of respective packets, e.g., packet headers, which may reduce the overhead involved in capturing the CS data 1113 (and/or enable to CDA module 1110 to monitor streams comprising large amounts of data). Alternatively, or in addition, in some implementations, the CDA module 1110 may be configured to store additional cyber data pertaining to respective cyber windows 1116, e.g., may store PCAP data and/or other packet data. The additional cyber data may be used for root cause analysis, as disclosed in further detail herein.

Referring back to FIG. 11A, in some implementations, the CDA module 1110 may be configured to provide the CS data 1113 acquired from the CPS 10 directly to the cyber AD system 920 (and/or cyber AD module 1130). Alternatively, or in addition, the CDA module 1110 may be configured to publish the CS data 1113 to the CPD manager 910, as disclosed herein. For example, the CDA module 1110 may be configured to publish the cyber data 1113 to a “cyber state data” topic or channel of the CPD manager 910. The cyber AD system 920 and/or cyber AD module 1130 may be configured to retrieve CD data 1113 from the CPD manager 910, e.g., may subscribe to the “cyber state data” topic or channel.

The cyber AD module 1130 may be configured to assess the anomalies pertaining to the cyber state of the CPS 10 and/or network 19. The cyber AD module 1130 may, for example, be configured to assess the cyber health of the PS 10-1 based on CS data 1113 acquired from the PS 10-1 as disclosed herein. In the FIG. 11A example, the cyber AD module 1130 may be configured to generate CSH data 934 in response to the CS data 1113, the CSH data 134 may comprise a cyber health metric (Mc) configured to indicate a degree to which the CS data 1113 is indicative of a cyber anomaly. The cyber health metric (Mc) may comprise a value between 0 and 1, where 0 indicates nominal cyber health and 1 indicates anomalous cyber health (e.g., a cyber fault, attack, compromise, or the like).

The cyber AD module 1130 may evaluate the CS data 1113 by use of, inter alia, a cyber AI/ML module 1150. The cyber AI/ML module 1150 may comprise a cyber AI/ML model 1152 configured in accordance with a cyber AI/ML CFG 1151, as disclosed herein. The cyber AI/ML model 1151 and/or corresponding AI/ML CFG 1151 may be learned, refined, and/or otherwise trained through unsupervised AI/ML techniques. The cyber AI/ML model 1052 may be configured to identify CS data 1113 indicative of nominal cyber behavior and/or operation. The cyber AI/ML model 1152 may be further configured to identify CS data 1113 that deviates from expected cyber behavior.

The cyber AI/ML model 1152 may comprise and/or implement any suitable AI/ML architecture or algorithm. In the FIG. 11A example, the cyber AI/ML model 1152 may comprise and/or be configured to implement an unsupervised AI/ML architecture and/or algorithm, which may include, but is not limited to one or more of: an OCSVM, an LOF algorithm, an autoencoder, and/or the like, as disclosed herein.

In a first non-limiting example, the cyber AI/ML model 1152 may comprise an OCSVM AI/ML implementation. The cyber OCSVM AI/ML implementation (e.g., cyber AI/ML model 1052) may be trained using nominal cyber behavior such that unseen cyber behavior is identified as an anomaly (e.g., failure, attack, compromise, or the like). The OCSVM AI/ML implementation of the cyber AI/ML model 1152 may be configured for anomaly detection by, inter alia training the OCSVM AI/ML implementation to learn a decision boundary of a nominal cyber behavior class (e.g., CS data 1113 and/or cyber features 1115 corresponding to nominal cyber behaviors or states of the CPS 10). The trained OCSVM AI/ML implementation of the cyber AI/ML model 1152 may detect cyber anomaly conditions in response to CS data 1113 and/or cyber features 1115 that deviate from the learned nominal cyber behavior and/or states.

In a second non-limiting example, the cyber AI/ML model 1152 may comprise an AI/ML implementation of a LOF algorithm. In LOF AI/ML implementations, the cyber AI/ML model 1052 may be configured to map CS data 1113 (and/or cyber features 1115) to datapoints within a name or state space of the LOF algorithm. The LOF AI/ML implementation of the cyber AI/ML model 1152 may be trained to identify outliers or anomalies as CS data 1113 (and/or cyber features 1115) that have a significantly lower density compared to its neighbor data points.

In a third non-limiting example, the cyber AI/ML model 1152 may comprise an AI/ML implementation of an autoencoder. The AI/ML autoencoder implementation of the cyber AI/ML model 1152 may comprise an encoder and decoder. The encoder may be configured to convert input data (e.g., CS data 1113 and/or cyber features 1115) into an abstract representation and the decoder may be configured to reconstruct the abstract representations. The AI/ML implementation of autoencoder of the cyber AI/ML model 1152 may be trained to identify anomalous cyber behavior and/or states of the CPS 10 based on differences between input CS data 1113 (and/or respective cyber features 1115) and the reconstructed data produced by the AI/ML autoencoder implementation of the cyber AI/ML model 1152.

As disclosed herein, cyber AD module 1030 may be configured to generate CSH data 934 in response to CS data 1113 acquired from the CPS 10 (e.g., network 19). The CSH data 934 may be generated by, inter alia, the cyber AI/ML model 1052 disclosed herein. The cyber AI/ML model 1052 may comprise an AI/ML implementation of one or more of an OCSVM, LOF, autoencoder, and/or the like. In some implementations, the cyber AD module 1130 may be further configured to implement data normalization to a zero mean in embodiments wherein the AI/ML model 1052 comprises an autoencoder AI/ML implementation.

As disclosed herein, the cyber AI/ML model 1152 may be trained through one or more unsupervised AI/ML training procedures. The cyber AI/ML model 1152 may be trained by use of training CS data 1113 recorded during nominal operation of the CPS 10 (and/or PS 10-1). The cyber AI/ML mode 1152 may, therefore, be trained to detect cyber anomaly conditions in response to CS data 1113 (and/or cyber features 1115) that deviate from nominal cyber behavior and/or states of the CPS 10.

Referring back to FIG. 9, the outputs physical AD system 901 and cyber AD system 920 may be used to construct a metric configured to indicate and/or quantity the cyber-physical health of the CPS 10, e.g., a CPH metric 944. The CPH metric 944 may comprise intuitive data that can be easily interpreted by operators of the CPS 10. For example, the CPH metric 944 may comprise a tuple comprising a cyber health metric (M_{C}) and physical health metric (M_{P}), e.g., a tuple (M_{C}, M_{P}), as illustrated in Eq, 20, where Mcps represents the CPS metric 944 disclosed herein:

$${M}_{CPS} = ( {M}_{c} , {M}_{P} ) \qquad Ep . 20$$

As disclosed herein, the cyber health metric (M_{C}) may comprise a quantity between 0 and 1, with 0 indicating nominal cyber behavior and 1 indicating an anomaly and the physical health metric (M_{P}) may comprise a similar value between 0 and 1, as disclosed herein. The CPH metric 944 may, therefore, provide a simple, easy to digest, holistic view of the cyber and physical state of the CPS 10.

In some implementations, the cyber AD module 1130 of the cyber AD system 920 may determine the cyber health metric (M_{C}) of the CSH data 924 as follows:

$${M}_{C} = σ ( {k}_{C} ( {A}_{C}^{T} {w}_{c} ) + {b}_{c} ) \qquad Eq . 21$$

In Eq. 21, A_{c} is a vector comprising outputs (e.g., CPH data 934) of the cyber AD system 920 for a window of the last T seconds, we comprises weights configured to perform a weighted average of the elements of A_{c}, hence the elements of we may be between 0 and 1 (and may sub to 1), and σ is a sigmoid function per the example illustrated in Eq. 22:

$$σ ( x ) = \frac{1}{1 + {exp}^{- x}} \qquad Eq . 22$$

The sigmoid function may be configured to ensure that the output of the cyber AD system 920 (e.g., cyber health metric (M_{C}) of the CSH data 934) is constrained to a range between 0 and 1. The k_{c}, b_{c} and w_{c} parameters of Eq. 21 may be configured to control the sensitivity and activation position of the sigmoid function.

The physical health metric (M_{P}) of the PSH data 134 may be computing using a similar approach, per Eq. 23 below:

$${M}_{P} = σ ( {k}_{P} ( {A}_{P}^{T} {w}_{P} ) + {b}_{P} ) \qquad Eq . 23$$

As illustrated above, the physical health metric (M_{P}) may be calculated in accordance with a vector A_{P} is comprising outputs (e.g., PSH data 130) of the physical AD system 901 corresponding to the outputs A_{C} of the cyber AD system 920 (e.g., over the last T seconds). The Eq. 23 may be further configured to incorporate separate tuning parameters b_{P}, k_{P}, and/or w_{P}

In some implementations, the tuning parameters of Eq, 21 and 23 may be obtained by minimizing the cross entropy between the output metrics (M_{C}, M_{P}) and a set of labeled tuning data. The tuning parameters may include weights (w_{C}, w_{P}), sigmoid sensitivity parameters (k_{C}, k), sigmoid shift parameters (b_{C}, b_{P}), and so on. The minimization may be performed using any suitable technique, e.g., stochastic gradient descent (SGD) or the like. In some implementations, the tuning may further incorporate a softmax to ensure that weights (w_{C}, w_{P}) meet the constraints of a weighted average, e.g., sum to 1. This may result, for example, in weights calculated as follows:

$$\begin{matrix}{w}_{C} = Softmax ( {\hat{w}}_{c} ) \\ {w}_{P} = Softmax ( {\hat{w}}_{P} )\end{matrix} \qquad Eq . 24$$

In Eq. 24, (\vec{w}_{c}, ŵ_{P}) are a set of free parameters that can be directly optimized through SGD or other suitable optimization algorithm.

As disclosed herein, the physical AD module 901 may be configured to determine the root cause of physical anomalies pertaining to the CPS 10. The physical AD module 901 may identify components 12-1 (and/or substations 11-1) associated with anomalous residuals and/or other physical anomalies, e.g., physical anomalies detected by at respective substations 11-1, AI/ML model 152, BL AD logic 550, rule-based AD logic 560, and/or the like.

In some implementations, the cyber AD module 920 may be further configured determine the root cause of respective cyber anomalies. For example, the cyber AD module 920 may be configured to identify cyber features 1115 indicative of different types of cyber attacks, such as denial of service, data injection, malicious login attempts, and/or the like. The cyber AD module 920 may be configured to determine the root cause of such attacks by use of packet data associated with the cyber features 1115, such as PCAP data maintained within the CPD manager 910, as disclosed herein.

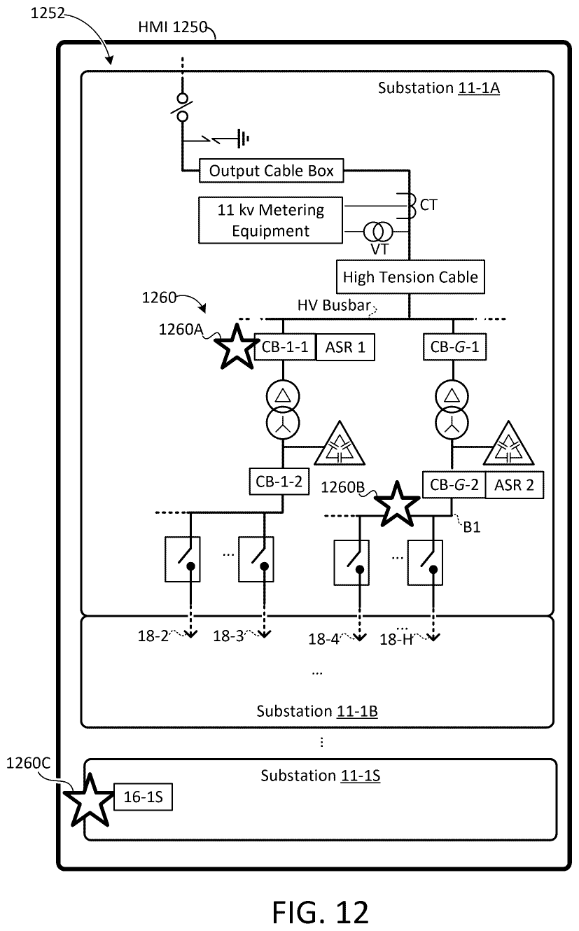

FIG. 12 illustrates an example of a visualization of cyber-physical anomaly data. The HMI 1250 may comprise a graphical representation 1252 of the PS 10-1 and/or respective substations 11-1. The HMI 1250 may further comprise cyber physical anomaly (CPA) indicators 1260. The CPA indicators 1260 may identify the CPA anomalies detected within the PS 10-1. The CPA 1260A may indicate detection of a physical anomaly pertaining to CB-1-1 and/or cyber anomaly pertaining to ASR 1. The CPA 1260B may indicate a physical anomaly pertaining to the voltage measurement on bus B1 and/or cyber anomaly pertaining to the cyber devices used to communicate such measurements. The CPA 1260C may indicate a cyber and/or physical anomaly pertaining to substation 11-1S, e.g., a physical anomaly pertaining to a plurality of substation components 12-1, a cyber anomaly pertaining to an MC component 16-1S of the substation 11-1S, and/or the like.

This disclosure has been made with reference to various exemplary embodiments. However, those skilled in the art will recognize that changes and modifications may be made to the exemplary embodiments without departing from the scope of the present disclosure. For example, various operational steps, as well as components for carrying out operational steps, may be implemented in alternate ways depending upon the particular application or in consideration of any number of cost functions associated with the operation of the system, e.g., one or more of the steps may be deleted, modified, or combined with other steps.

Additionally, as will be appreciated by one of ordinary skill in the art, principles of the present disclosure may be reflected in a computer program product on a computer-readable storage medium having computer-readable program code means embodied in the storage medium. Any tangible, non-transitory computer-readable storage medium may be utilized, including magnetic storage devices (hard disks, floppy disks, and the like), optical storage devices (CD-ROMs, DVDs, Blu-Ray discs, and the like), flash memory, and/or the like. These computer program instructions may be loaded onto a general-purpose computer, special purpose computer, or other programmable data processing apparatus to produce a machine, such that the instructions that execute on the computer or other programmable data processing apparatus create means for implementing the functions specified. These computer program instructions may also be stored in a computer-readable memory that can direct a computer or other programmable data processing apparatus to function in a particular manner, such that the instructions stored in the computer-readable memory produce an article of manufacture, including implementing means that implement the function specified. The computer program instructions may also be loaded onto a computer or other programmable data processing apparatus to cause a series of operational steps to be performed on the computer or other programmable apparatus to produce a computer-implemented process, such that the instructions that execute on the computer or other programmable apparatus provide steps for implementing the functions specified.

While the principles of this disclosure have been shown in various embodiments, many modifications of structure, arrangements, proportions, elements, materials, and components, which are particularly adapted for a specific environment and operating requirements, may be used without departing from the principles and scope of this disclosure. These and other changes or modifications are intended to be included within the scope of the present disclosure.

The foregoing specification has been described with reference to various embodiments. However, one of ordinary skill in the art will appreciate that various modifications and changes can be made without departing from the scope of the present disclosure. Accordingly, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, a required, or an essential feature or element. As used herein, the terms “comprises,” “comprising,” and any other variation thereof, are intended to cover a non-exclusive inclusion, such that a process, a method, an article, or an apparatus that comprises a list of elements does not include only those elements but may include other elements not expressly listed or inherent to such process, method, system, article, or apparatus. Also, as used herein, the terms “coupled,” “coupling,” and any other variation thereof are intended to cover a physical connection, an electrical connection, a magnetic connection, an optical connection, a communicative connection, a functional connection, and/or any other connection.

Those having skill in the art will appreciate that many changes may be made to the details of the above-described embodiments without departing from the underlying principles of the invention. The scope of the present invention should, therefore, be determined only by the claims.

1. A system for monitoring a power system, comprising:
a processor;
a distributed state monitoring system configured to determine subsection state estimates for each of a plurality of subsections of the power system; and
an anomaly detector configured to detect anomalous behavior of the power system based, at least in part, on the substation-level state estimates determined for respective substations of the plurality of substations.

2. The system of claim 1, wherein the distributed state monitoring system comprises a first monitoring system configured to determine the substation-level state estimates for respective substations of the power system.

3. The system of claim 2, wherein the distributed first monitoring system comprises a plurality of substation-level modules, each substation-level module configured to determine a substation-level state estimate pertaining to a respective substation.

4. The system of claim 3, wherein the substation-level modules are configured to detect anomalies pertaining to residuals of the substation-level state estimates.

5. The system of claim 1, wherein the distributed state monitoring system comprises a system-level state monitor configured to determine a system-level state estimate for the power system based, at least in part, on the substation-level state estimates.

6. The system of claim 5, wherein system-level state monitor comprises a machine-learned model configured to generate physical health data configured to quantity a physical health of the power system in response to the system-level state estimate.

7. A method for monitoring a power system comprising a plurality of substations, comprising:
determining substation state estimates for respective substations of the power system, the substation state estimates determined for the respective substations comprising validated measurements pertaining to an operating state of the respective substations, wherein determining a substation state estimate for a substation comprises:
receiving measurement data pertaining to the substation from acquisition devices coupled to electrical components of the substation, and
implementing a substation state estimation function utilizing the measurement data to generate a set of validated measurements for the substation;
utilizing the substation state estimates determined for the respective subsections to determine a system-level state estimate for the power system; and
determining whether the power system is exhibiting anomalous behavior based, at least in part, on the determined system-level state estimate.

8. The method of claim 7, wherein the substation state estimation function further comprises validating state estimates determined for respective substations.

9. The method of claim 8, wherein the substation state estimation function further comprises determining a root cause of anomalous residuals of the substation state estimates.
